(19) United States
(12) Patent Application Publication
(10) Pub. No.: US 2026/0263936 A1
(43) Pub. Date: Sep. 10, 2026

(54) ONE OR MORE COMPUTER-READABLE STORAGE MEDIA, INFORMATION PROCESSING SYSTEM, AND COMPUTER-IMPLEMENTED METHOD

(71) Applicant: NINTENDO CO., LTD., Kyoto (JP)

(72) Inventors: Atsushi UENO, Kyoto (JP); Kento SAKAI, Kyoto (JP); Fukuhei HAMAZAKI, Kyoto (JP)

(21) Appl. No.: 19/544,160

(22) Filed: Feb. 19, 2026

(30) Foreign Application Priority Data
Mar. 6, 2025 (JP) 2025-035624

(51) Int. Cl. A63F 13/577; A63F 13/52

(52) U.S. Cl. CPC A63F 13/577; A63F 13/52

(57) ABSTRACT

An example of an information processing system updates, based on game processing, voxel data which is defined in a virtual space, and updates a voxel mesh which is a mesh corresponding to the voxel data, and vertex coordinates of which are determined based on at least the density included in the voxel data. In the game processing, when a player object in the virtual space is on the voxel mesh, the information processing system controls movement of the player object based on an operation input at a position on the voxel mesh. When a first event has occurred, the information processing system continuously sets a first voxel update range in the virtual space along a path according to the first event, and increases the density of each voxel corresponding to the first voxel update range.

### CROSS REFERENCE TO RELATED APPLICATION

This application claims priority to Japanese Patent Application No. 2025-035624, filed on Mar. 6, 2025, the entire contents of which are incorporated herein by reference.

### FIELD

The technique shown herein relates to one or more computer-readable media, an information processing system, and a computer-implemented method for generating an object in a virtual space by using voxel data.

### BACKGROUND AND SUMMARY

Conventionally, an object is managed using voxel data, and a mesh of the object is generated in a virtual space, based on the voxel data.

It is desired to provide a novel game using voxel data.

Therefore, the present application discloses one or more computer-readable media, an information processing system, and a computer-implemented method that execute a novel game using voxel data.

(1)

An example of one or more non-transitory computer-readable storage media having stored therein instructions that, when executed, cause one or more processors to execute information processing comprising: updating, based on game processing, voxel data which is defined in a virtual space and in which at least a density is set for each of a plurality of voxels, the density indicating a degree of occupation of a content in a space defined by the voxel; updating a voxel mesh which is a mesh corresponding to the voxel data, and vertex coordinates of which are determined based on at least the density included in the voxel data; and in the game processing, when a player object in the virtual space is on the voxel mesh, controlling movement of the player object based on an operation input at a position on the voxel mesh, and when a first event has occurred, continuously setting a first voxel update range in the virtual space along a path according to the first event, and increasing the density of each voxel corresponding to the first voxel update range.

According to the configuration of the above (1), the voxel mesh along the movement path is set according to the first event during the game, and the player object can move on the voxel mesh. Therefore, a novel game using voxel data can be provided.

(2)

In the configuration of the above (1), the first event may be an event in which a first object moves in the virtual space. The information processing may comprise, when the first event has occurred, setting the first voxel update range at a plurality of positions through which the first object has passed in the virtual space.

According to the configuration of the above (2), the voxel mesh can be set along the path through which the object has passed.

(3)

In the configuration of the above (2), the first object may be an enemy object in a game. The first event may be an event in which the enemy object moves in response to that a first action hits the enemy object, the first action being an attack action performed by the player object based on an operation input.

According to the configuration of the above (3), the voxel mesh can be set along the movement path of the enemy object that moves due to the attack action of the player object.

(4)

In the configuration of the above (2), the first event may be an event in which, within a first range in the virtual space, the player object is caused to perform a second action of throwing the first object, based on an operation input, thereby moving the first object.

According to the configuration of the above (4), the voxel mesh can be set along the movement path of the object that is thrown by the action of the player object.

(5)

In the configuration of the above (2), the first object may be the player object. The first event may be an event in which at least the player object performs a third action to move based on an operation input.

According to the configuration of the above (5), the voxel mesh can be set along the movement path of the player object.

(6)

In the configuration of the above (1), the information processing may comprise, when the first event has occurred, setting the first voxel update range along a first path from a first position to a second position in the virtual space.

According to the configuration of the above (6), the voxel mesh can be set along the path from the first position to the second position of the object.

(7)

In the configuration of the above (6), either the first position or the second position may be a position of the player object. The first voxel update range may be arranged, at the position of the player object, so that an upper surface of the first voxel update range is located at a height of a lower end of the player object.

According to the configuration of the above (7), the player object can easily enter the voxel mesh that is set according to the first event.

(8)

In the configuration of the above (7), the first event may be an event in which a second object thrown by a fourth action performed by the player object based on an operation input collides with the voxel mesh, and either the first position or the second position is a collision position of the object.

According to the configuration of the above (8), the voxel mesh extending toward the collision position of the object thrown by the player object can be set.

(9)

In the configuration of the above (8), the path may have a shape of a curve or a polyline in which slopes at the first position and the second position are gentler than a slope of a straight line connecting the first position and the second position.

According to the configuration of the above (9), the player object can easily get on and off the voxel mesh that is set according to the first event.

(10)

In the configuration of the any one of above (1) to (9), the voxel data may include at least first voxel data and second voxel data respectively defined in a first voxel space and a second voxel space that at least partially overlap each other in the virtual space. The information processing may comprise: increasing the density of each voxel corresponding to the first voxel update range in the first voxel data; and when a second event has occurred, setting a second voxel update range, and increasing or decreasing the density of each voxel corresponding to the second voxel update range in the second voxel data.

According to the configuration of the above (10), the voxel mesh that is set according to the first event and another voxel mesh can be individually deformed.

(11)

In the configuration of the above (10), the information processing may further comprise: moving or rotating the first voxel space defined in the virtual space; and updating the voxel mesh corresponding to the first voxel data.

According to the configuration of the above (11), the voxel mesh that is set according to the first event can be moved independently of another voxel mesh.

(12)

In the configuration of the above (10), the information processing may further comprise, in the game processing, decreasing the density of the voxel included in the first voxel data according to a third event.

According to the configuration of the above (12), the voxel mesh that is set according to the first event can be easily deleted without deleting another voxel mesh.

(13)

In the configuration of the any one of above (1) to (12), the information processing may comprise, when the first event has occurred, setting the first voxel update range after a first period has elapsed.

According to the configuration of the above (13), the risk of interference of the voxel mesh that is set according to the first event, with another object can be reduced.

(14)

In the configuration of the any one of above (1) to (13), the information processing may comprise, when the first event has occurred, setting the first voxel update range in a range obtained by excluding a range including the position of the player object.

According to the configuration of the above (14), the risk of interference of the voxel mesh that is set according to the first event, with the player object can be reduced.

(15)

In the configuration of the any one of above (1) to (14), the information processing may comprise setting the first voxel update range at a position where an edge of an upper surface of the first voxel update range coincides, at least partially, with an edge of an upper surface of the first voxel update range previously generated.

According to the configuration of the above (15), the voxel mesh that is set according to the first event has a shape with no steps or only minimal steps.

The present specification discloses examples of an information processing apparatus and an information processing system that execute the processes in the above (1) to (15). Furthermore, the present specification discloses an example of a computer-implemented method that executes the processes in the above (1) to (15) in the information processing system.

According to the storage media, the information processing system, the information processing apparatus, or the computer-implemented method, a novel game using voxel data can be provided.

These and other features, aspects, and advantages of the subject matter described herein will become more apparent from the following detailed description when taken in conjunction with the accompanying drawings.

### BRIEF DESCRIPTION OF THE DRAWINGS

FIG. 1 is a view showing an example where a non-limiting left controller and a non-limiting right controller are attached to a non-limiting main body apparatus;

FIG. 2 is a view showing an example where a non-limiting left controller and a non-limiting right controller are removed from a non-limiting main body apparatus;

FIG. 3 is a six-sided view showing an example of a non-limiting main body apparatus;

FIG. 4 is a six-sided view showing an example of a non-limiting left controller;

FIG. 5 is a six-sided view showing an example of a non-limiting right controller;

FIG. 6 is a block diagram showing an example of an internal configuration of a non-limiting main body apparatus;

FIG. 7 is a block diagram showing an example of an internal configuration of a non-limiting main body apparatus, a non-limiting left controller and a non-limiting right controller;

FIG. 8 is a view showing an example of a terrain object, which is a voxel object;

FIG. 9 is a view showing before and after the deletion of a portion of the terrain object shown in FIG. 8;

FIG. 10 is a view showing before and after the deletion of a portion of the terrain object shown in FIG. 8;

FIG. 11 is a view showing an example of voxel data;

FIG. 12 is a view showing an example of material data;

FIG. 13 is a view showing an example of a game space when an update event has occurred;

FIG. 14 is a view showing an example of an update range;

FIG. 15 is a view showing an example of a method for setting vertices;

FIG. 16 is a view showing an example of a method for determining a material of a vertex;

FIG. 17 is a view showing an example of vertex simplification;

FIG. 18 is a view showing an example of conditions regarding materials;

FIG. 19 is a view showing an example of a mesh generated based on vertices;

FIG. 20 is a view showing an example of division of a quadrangle forming a mesh into two triangles;

FIG. 21 is a view showing an example of a method for determining materials of polygons forming a display mesh;

FIG. 22 is a view showing an example of materials set for vertices of adjacent two polygons;

FIG. 23 is a view showing an example of application of textures to polygons;

FIG. 24 is a view showing an example of a method for determining materials of polygons forming a determination mesh;

FIG. 25 is a view showing an example of a game image representing a state in which a player character moves on a terrain object;

FIG. 26 is a view showing an example of a game image representing a state in which the player character pulls out a fragment object from the terrain object;

FIG. 27 is a view showing an example of a game image representing a state in which a fragment object is generated because the player character has destroyed the terrain object;

FIG. 28 is a view showing an example of a game image in a state where the player character can perform a throwing action;

FIG. 29 is a view showing an example of a game image after a change is added to the terrain object because a fragment object has come into contact with the terrain object shown in FIG. 28;

FIG. 30 is a view showing an example of a game image according to the first example;

FIG. 31 is a view showing an example of a game image in a state where the player character has thrown a fragment object by a throwing action from the state shown in FIG. 30;

FIG. 32 is a view showing an example of a game image in a state where the player character moves on a path object;

FIG. 33 is a view showing an example of a path object generation method according to the first example;

FIG. 34 is a view showing an example in which a part of a voxel update range overlaps with a prohibited area;

FIG. 35 is a view showing an example of states before and after movement of an object generation area in a game space;

FIG. 36 is a view showing an example of a game image in a state where the player character is performing a punching action on an enemy character;

FIG. 37 is a view showing an example of a game image in a state where the enemy character that has received the punching action is moving;

FIG. 38 is a view showing an example of a game image in a state where the player character moves on a path object;

FIG. 39 is a view showing an example of a path object generation method according to the second example;

FIG. 40 is a view showing an example of a game image according to the third example;

FIG. 41 is a view showing an example of a game image representing a player object performing a generation action;

FIG. 42 is a view showing an example of a voxel update range that is set at a point when one frame has elapsed from when a generation action was started;

FIG. 43 is a view showing an example of a voxel update range that is set at a point when two frames have elapsed from when a generation action was started;

FIG. 44 is a view showing an example of a voxel update range that is set after a certain time has elapsed from when a generation action was started;

FIG. 45 is a view showing an example of a game image after a path object was generated;

FIG. 46 is a view showing an example of a game image when a player object moves on a path object;

FIG. 47 is a view showing an example of a game image in a state where the player character is lifting a nut object;

FIG. 48 is a view showing an example of a game image in a state where the player character has thrown the nut object by a throwing action from the state shown in FIG. 47;

FIG. 49 is a view showing an example of a game image in a state where a path object is arranged from the state shown in FIG. 48;

FIG. 50 is a view showing an example of a game image in a state where a player character moves on a path object;

FIG. 51 is a view showing an example of a path for setting a path object;

FIG. 52 is a view showing an example of a voxel update range that is set in a certain frame when a path object is set;

FIG. 53 shows an example of various data used for information processing in a non-limiting game system;

FIG. 54 is a flowchart showing an example of a flow of game processing executed by the non-limiting game system;

FIG. 55 is a sub flowchart showing an example of a specific flow of a voxel update process in the first example;

FIG. 56 is a sub flowchart showing an example of a specific flow of a voxel update process in the second example;

FIG. 57 is a sub flowchart showing an example of a specific flow of a voxel update process in the third example; and

FIG. 58 is a sub flowchart showing an example of a specific flow of a voxel update process in the fourth example.

### DETAILED DESCRIPTION OF NON-LIMITING EXAMPLE EMBODIMENTS

### 1. Configuration of Game System

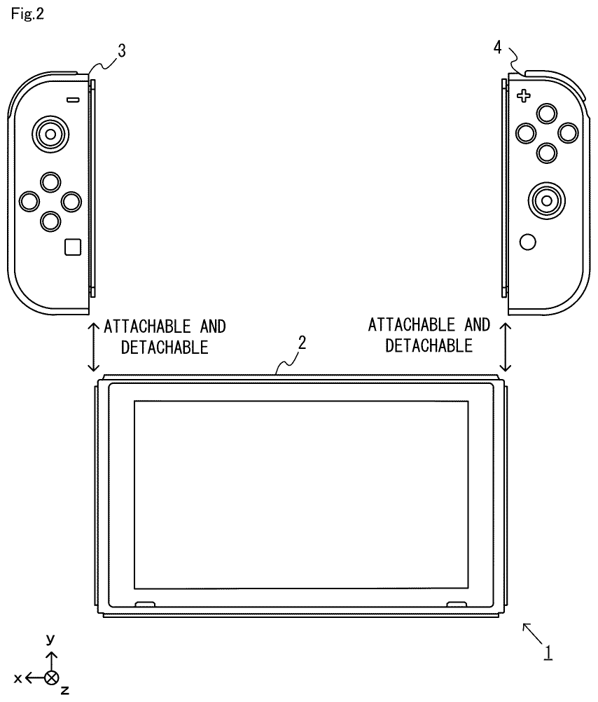

A game system according to an example of an exemplary embodiment is described below. An example of a game system 1 according to the exemplary embodiment includes a main body apparatus (an information processing apparatus; which functions as a game apparatus main body in the exemplary embodiment) 2, a left controller 3, and a right controller 4. Each of the left controller 3 and the right controller 4 is attachable to and detachable from the main body apparatus 2. That is, the game system 1 can be used as a unified apparatus obtained by attaching each of the left controller 3 and the right controller 4 to the main body apparatus 2. Further, in the game system 1, the main body apparatus 2, the left controller 3, and the right controller 4 can also be used as separate bodies (see FIG. 2). Hereinafter, first, the hardware configuration of the game system 1 according to the exemplary embodiment is described, and then, the control of the game system 1 according to the exemplary embodiment is described.

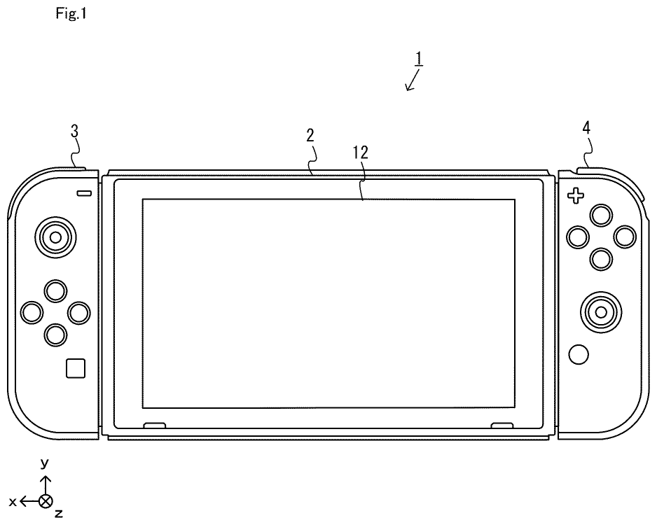

FIG. 1 is a diagram showing an example of the state in which the left controller 3 and the right controller 4 are attached to the main body apparatus 2. As shown in FIG. 1, each of the left controller 3 and the right controller 4 is attached to and unified with the main body apparatus 2. The main body apparatus 2 is an apparatus for performing various processes (e.g., game processing) in the game system 1. The main body apparatus 2 includes a display 12. Each of the left controller 3 and the right controller 4 is an apparatus including operation sections with which a user provides inputs.

FIG. 2 is a diagram showing an example of the state in which each of the left controller 3 and the right controller 4 is detached from the main body apparatus 2. As shown in FIGS. 1 and 2, the left controller 3 and the right controller 4 are attachable to and detachable from the main body apparatus 2. It should be noted that hereinafter, the left controller 3 and the right controller 4 will occasionally be referred to collectively as a “controller”.

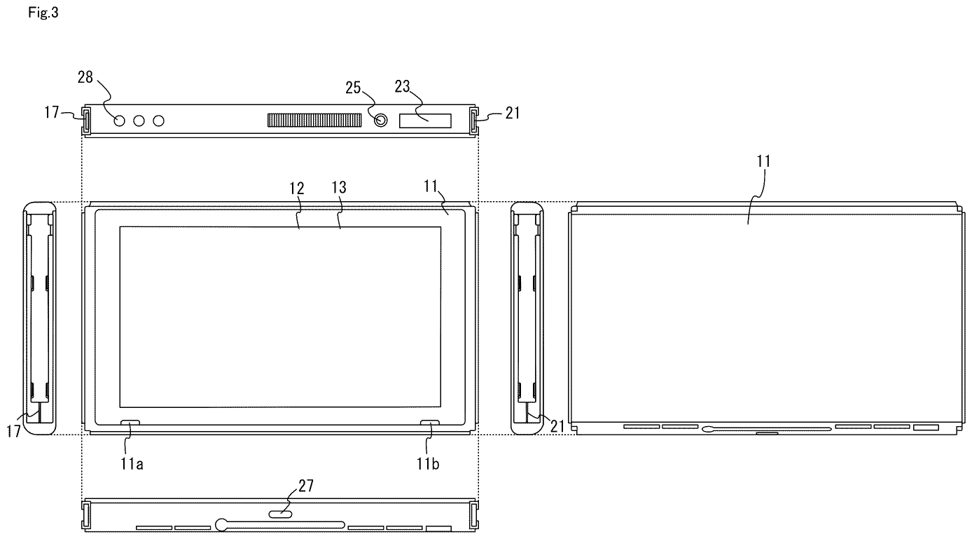

FIG. 3 is six orthogonal views showing an example of the main body apparatus 2. As shown in FIG. 3, the main body apparatus 2 includes an approximately plate-shaped housing 11. In the exemplary embodiment, a main surface (for example, a surface on a front side, such as a surface on which the display 12 is provided) of the housing 11 has a generally rectangular shape.

It should be noted that the shape and the size of the housing 11 are optional. As an example, the housing 11 may be of a portable size. Further, the main body apparatus 2 alone or the unified apparatus obtained by attaching the left controller 3 and the right controller 4 to the main body apparatus 2 may function as a mobile apparatus. The main body apparatus 2 or the unified apparatus may function as a handheld apparatus or a portable apparatus.

As shown in FIG. 3, the main body apparatus 2 includes the display 12, which is provided on the main surface of the housing 11. The display 12 displays an image generated by the main body apparatus 2. In the exemplary embodiment, the display 12 is a liquid crystal display device (LCD). The display 12, however, may be a display device of any type.

Further, the main body apparatus 2 includes a touch panel 13 on a screen of the display 12. In the exemplary embodiment, the touch panel 13 is of a type that allows a multi-touch input (e.g., a capacitive type). The touch panel 13, however, may be of any type. For example, the touch panel 13 may be of a type that allows a single-touch input (e.g., a resistive type).

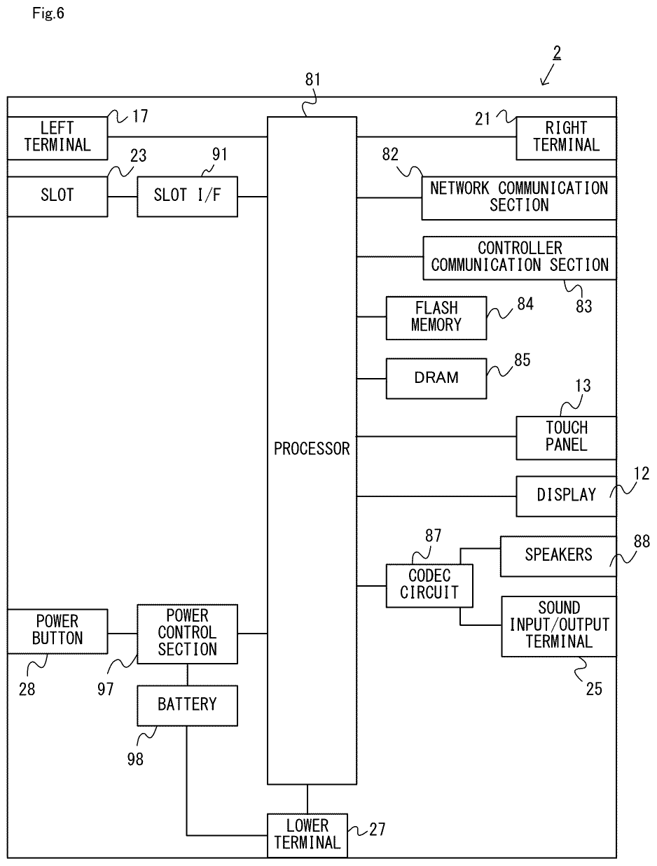

The main body apparatus 2 includes speakers (e.g., speakers 88 shown in FIG. 6) within the housing 11. As shown in FIG. 3, speaker holes 11a and 11b are formed on the main surface of the housing 11. Then, sounds output from the speakers 88 are output through the speaker holes 11a and 11b.

Further, the main body apparatus 2 includes a left terminal 17, which is a terminal for the main body apparatus 2 to perform wired communication with the left controller 3, and a right terminal 21, which is a terminal for the main body apparatus 2 to perform wired communication with the right controller 4.

As shown in FIG. 3, the main body apparatus 2 includes a slot 23. The slot 23 is provided on an upper side surface of the housing 11. The slot 23 is so shaped as to allow a predetermined type of storage medium to be attached to the slot 23. The predetermined type of storage medium is, for example, a dedicated storage medium (e.g., a dedicated memory card) for the game system 1 and an information processing apparatus of the same type as the game system 1. The predetermined type of storage medium is used to store, for example, data (e.g., saved data of an application or the like) used by the main body apparatus 2 and/or a program (e.g., a program for an application or the like) executed by the main body apparatus 2. Further, the main body apparatus 2 includes a power button 28.

The main body apparatus 2 includes a lower terminal 27. The lower terminal 27 is a terminal for the main body apparatus 2 to communicate with a cradle. In the exemplary embodiment, the lower terminal 27 is a USB connector (more specifically, a female connector). Further, when the unified apparatus or the main body apparatus 2 alone is mounted on the cradle, the game system 1 can display on a monitor an image generated by and output from the main body apparatus 2. The monitor may be stationary or may be movable. Further, in the exemplary embodiment, the cradle has the function of charging the unified apparatus or the main body apparatus 2 alone mounted on the cradle. Further, the cradle has the function of a hub device (specifically, a USB hub).

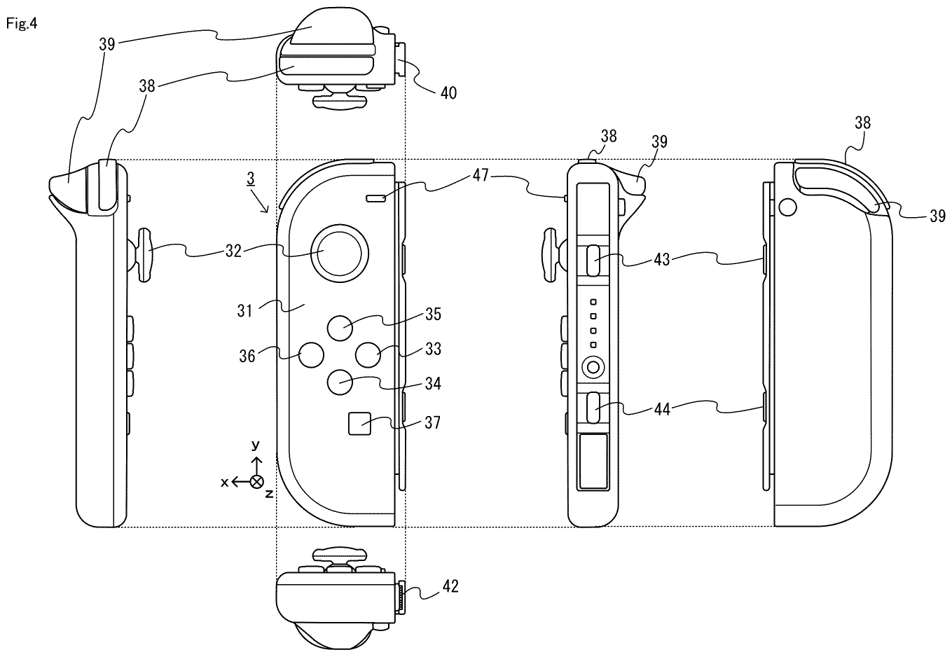

FIG. 4 is six orthogonal views showing an example of the left controller 3. As shown in FIG. 4, the left controller 3 includes a housing 31. In the exemplary embodiment, the housing 31 has a vertically long shape. The housing 31 may be shaped to be long in an up-down direction. For example, along the y-axis direction shown in FIGS. 1 and 4. In the state where the left controller 3 is detached from the main body apparatus 2, the left controller 3 can also be held in the orientation in which the left controller 3 is vertically long. The housing 31 has such a shape and a size that when held in the orientation in which the housing 31 is vertically long, the housing 31 can be held with one hand, particularly the left hand. Further, the left controller 3 can also be held in the orientation in which the left controller 3 is horizontally long. When held in the orientation in which the left controller 3 is horizontally long, the left controller 3 may be held with both hands.

The left controller 3 includes an analog stick 32. As shown in FIG. 4, the analog stick 32 is provided on a main surface of the housing 31. The analog stick 32 can be used as a direction input section with which a direction can be input. The user tilts the analog stick 32 and thereby can input a direction corresponding to the direction of the tilt (and input a magnitude corresponding to the angle of the tilt). It should be noted that the left controller 3 may include a directional pad, a slide stick that allows a slide input, or the like as the direction input section, instead of the analog stick. Further, in the exemplary embodiment, it is possible to provide an input by pressing the analog stick 32.

The left controller 3 includes various operation buttons. The left controller 3 includes four operation buttons 33 to 36 (specifically, a right direction button 33, a down direction button 34, an up direction button 35, and a left direction button 36) on the main surface of the housing 31. Further, the left controller 3 includes a record button 37 and a “−” (minus) button 47. The left controller 3 includes a first L-button 38 and a ZL-button 39 in an upper left portion of a side surface of the housing 31. Further, the left controller 3 includes a second L-button 43 and a second R-button 44, on the side surface of the housing 31 on which the left controller 3 is attached to the main body apparatus 2. These operation buttons are used to give instructions depending on various programs (e.g., an operating system (OS) program and an application program) executed by the main body apparatus 2.

Further, the left controller 3 includes a terminal 42 for the left controller 3 to perform wired communication with the main body apparatus 2.

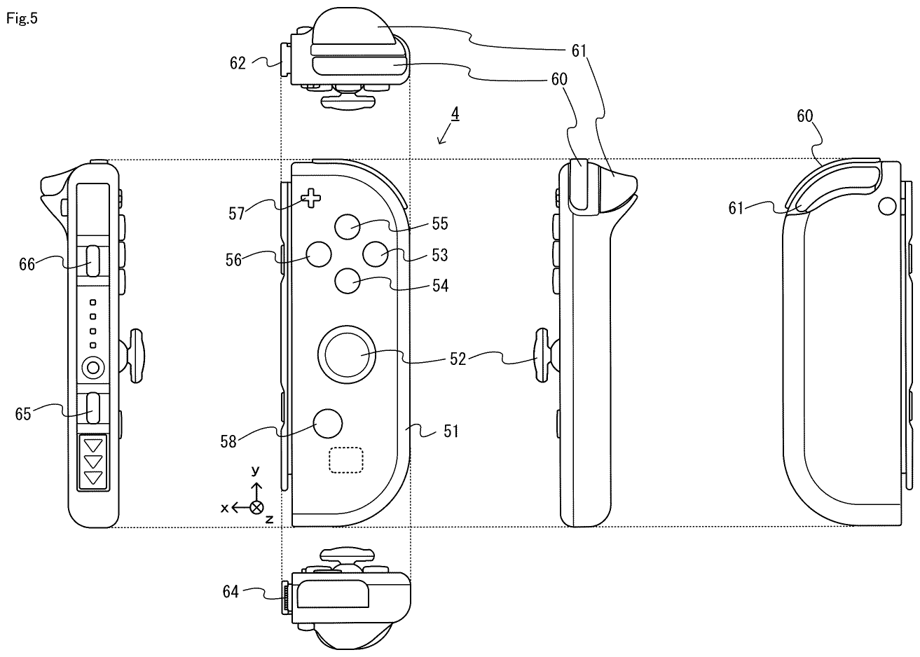

FIG. 5 is six orthogonal views showing an example of the right controller 4. As shown in FIG. 5, the right controller 4 includes a housing 51. In the exemplary embodiment, the housing 51 has a vertically long shape. For example, it may be shaped to be long in the up-down direction. In the state where the right controller 4 is detached from the main body apparatus 2, the right controller 4 can also be held in the orientation in which the right controller 4 is vertically long. The housing 51 has such a shape and a size that when held in the orientation in which the housing 51 is vertically long, the housing 51 can be held with one hand, particularly the right hand. Further, the right controller 4 can also be held in the orientation in which the right controller 4 is horizontally long. When held in the orientation in which the right controller 4 is horizontally long, the right controller 4 may be held with both hands.

Similarly to the left controller 3, the right controller 4 includes an analog stick 52 as a direction input section. In the exemplary embodiment, the analog stick 52 has the same configuration as that of the analog stick 32 of the left controller 3. Further, the right controller 4 may include a directional pad, a slide stick that allows a slide input, or the like, instead of the analog stick. Further, similarly to the left controller 3, the right controller 4 includes four operation buttons 53 to 56 (specifically, an A-button 53, a B-button 54, an X-button 55, and a Y-button 56) on a main surface of the housing 51. Further, the right controller 4 includes a “+” (plus) button 57 and a home button 58. Further, the right controller 4 includes a first R-button 60 and a ZR-button 61 in an upper right portion of a side surface of the housing 51. Further, similarly to the left controller 3, the right controller 4 includes a second L-button 65 and a second R-button 66.

Further, the right controller 4 includes a terminal 64 for the right controller 4 to perform wired communication with the main body apparatus 2.

FIG. 6 is a block diagram showing an example of the internal configuration of the main body apparatus 2. The main body apparatus 2 includes components 81 to 85, 87, 88, 91, 97, and 98 shown in FIG. 6 in addition to the components shown in FIG. 3. Some of the components 81 to 85, 87, 88, 91, 97, and 98 may be mounted as electronic components on an electronic circuit board and accommodated in the housing 11.

The main body apparatus 2 includes a processor 81. The processor 81 is an information processing section for executing various types of information processing to be executed by the main body apparatus 2. For example, the processor 81 may be composed only of a CPU (Central Processing Unit), or may be composed of a SoC (System-on-a-chip) having a plurality of functions such as a CPU function and a GPU (Graphics Processing Unit) function. The processor 81 executes an information processing program (e.g., a game program) or other instructions that are stored in storage (for example, in an internal non-transitory storage medium such as a flash memory 84, an external storage non-transitory medium attached to the slot 23, or the like), thereby performing the various types of information processing.

The main body apparatus 2 includes a flash memory 84 and a DRAM (Dynamic Random Access Memory) 85 as examples of internal storage media built into the main body apparatus 2. The flash memory 84 and the DRAM 85 are connected to the processor 81. The flash memory 84 is a memory mainly used to store various data (or programs) to be saved in the main body apparatus 2. The DRAM 85 is a memory used to temporarily store various data used for information processing. The DRAM 85 and flash memory 84 are illustrative non-limiting examples of non-transitory computer-readable media.

The main body apparatus 2 includes a slot interface (hereinafter abbreviated as “I/F”) 91. The slot I/F 91 is connected to the processor 81. The slot I/F 91 is connected to the slot 23, and in accordance with an instruction from the processor 81, reads and writes data from and to the predetermined type of storage medium (e.g., a dedicated memory card) attached to the slot 23.

The processor 81 appropriately reads and writes data from and to the flash memory 84, the DRAM 85, and each of the above storage media, thereby performing the above information processing.

The main body apparatus 2 includes a network communication section 82. The network communication section 82 is connected to the processor 81. The network communication section 82 communicates (specifically, through wireless communication) with an external apparatus via a network. In the exemplary embodiment, as a first communication form, the network communication section 82 connects to a wireless LAN and communicates with an external apparatus, using a method compliant with the Wi-Fi standard. Further, as a second communication form, the network communication section 82 wirelessly communicates with another main body apparatus 2 of the same type, using a predetermined communication method (e.g., communication based on a unique protocol or infrared light communication). It should be noted that the wireless communication in the above second communication form achieves the function of enabling so-called “local communication” in which the main body apparatus 2 can wirelessly communicate with another main body apparatus 2 placed in a closed local network area, and the plurality of main body apparatuses 2 directly communicate with each other to transmit and receive data.

The main body apparatus 2 includes a controller communication section 83. The controller communication section 83 is connected to the processor 81. The controller communication section 83 wirelessly communicates with the left controller 3 and/or the right controller 4. The communication method between the main body apparatus 2 and the left controller 3 and the right controller 4 is optional. In the exemplary embodiment, the controller communication section 83 performs communication compliant with the Bluetooth (registered trademark) standard with the left controller 3 and with the right controller 4.

The processor 81 is connected to the left terminal 17, the right terminal 21, and the lower terminal 27. When performing wired communication with the left controller 3, the processor 81 transmits data to the left controller 3 via the left terminal 17 and also receives operation data from the left controller 3 via the left terminal 17. Further, when performing wired communication with the right controller 4, the processor 81 transmits data to the right controller 4 via the right terminal 21 and also receives operation data from the right controller 4 via the right terminal 21. Further, when communicating with the cradle, the processor 81 transmits data to the cradle via the lower terminal 27. As described above, in the exemplary embodiment, the main body apparatus 2 can perform both wired communication and wireless communication with each of the left controller 3 and the right controller 4. Further, when the unified apparatus obtained by attaching the left controller 3 and the right controller 4 to the main body apparatus 2 or the main body apparatus 2 alone is attached to the cradle, the main body apparatus 2 can output data (e.g., image data or sound data) to the stationary monitor or the like via the cradle.

Here, the main body apparatus 2 can communicate with a plurality of left controllers 3 simultaneously (in other words, in parallel). Further, the main body apparatus 2 can communicate with a plurality of right controllers 4 simultaneously (in other words, in parallel). Thus, a plurality of users can simultaneously provide inputs to the main body apparatus 2, each using a set of the left controller 3 and the right controller 4. As an example, a first user can provide an input to the main body apparatus 2 using a first set of the left controller 3 and the right controller 4, and simultaneously, a second user can provide an input to the main body apparatus 2 using a second set of the left controller 3 and the right controller 4.

Further, the display 12 is connected to the processor 81. The processor 81 displays a generated image (e.g., an image generated by executing the above information processing) and/or an externally acquired image on the display 12.

The main body apparatus 2 includes a codec circuit 87 and speakers (specifically, a left speaker and a right speaker) 88. The codec circuit 87 is connected to the speakers 88 and a sound input/output terminal 25 and also connected to the processor 81. The codec circuit 87 is a circuit for controlling the input and output of sound data to and from the speakers 88 and the sound input/output terminal 25.

The main body apparatus 2 includes a power control section 97 and a battery 98. The power control section 97 is connected to the battery 98 and the processor 81. Further, although not shown in FIG. 6, the power control section 97 is connected to components of the main body apparatus 2 (specifically, components that receive power supplied from the battery 98, the left terminal 17, and the right terminal 21). Based on a command from the processor 81, the power control section 97 controls the supply of power from the battery 98 to the above components.

Further, the battery 98 is connected to the lower terminal 27. When an external charging device (e.g., the cradle) is connected to the lower terminal 27, and power is supplied to the main body apparatus 2 via the lower terminal 27, the battery 98 is charged with the supplied power.

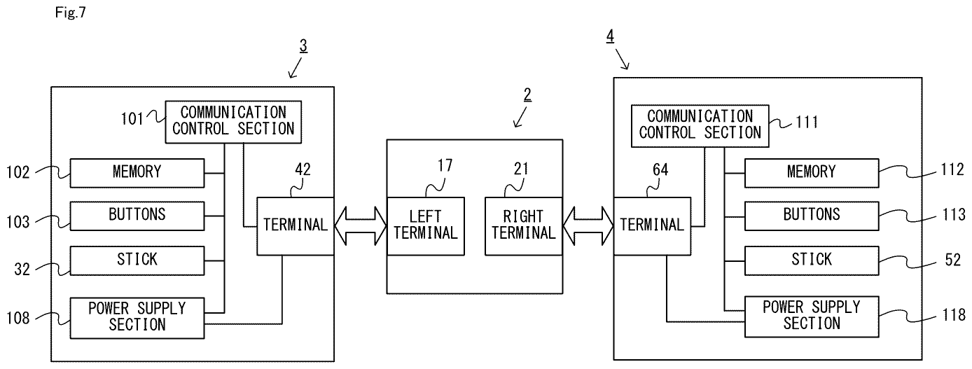

FIG. 7 is a block diagram showing examples of the internal configurations of the main body apparatus 2, the left controller 3, and the right controller 4. It should be noted that the details of the internal configuration of the main body apparatus 2 are shown in FIG. 6 and therefore are omitted in FIG. 7.

The left controller 3 includes a communication control section 101, which communicates with the main body apparatus 2. As shown in FIG. 7, the communication control section 101 is connected to components including the terminal 42. In the exemplary embodiment, the communication control section 101 can communicate with the main body apparatus 2 through both wired communication via the terminal 42 and wireless communication not via the terminal 42. The communication control section 101 controls the method for communication performed by the left controller 3 with the main body apparatus 2. That is, when the left controller 3 is attached to the main body apparatus 2, the communication control section 101 communicates with the main body apparatus 2 via the terminal 42. Further, when the left controller 3 is detached from the main body apparatus 2, the communication control section 101 wirelessly communicates with the main body apparatus 2 (specifically, the controller communication section 83). The wireless communication between the communication control section 101 and the controller communication section 83 is performed in accordance with the Bluetooth (registered trademark) standard, for example.

Further, the left controller 3 includes a memory 102 such as a flash memory. The communication control section 101 includes, for example, a microcomputer (or a microprocessor) and executes firmware stored in the memory 102, thereby performing various processes.

The left controller 3 includes buttons 103 (specifically, the buttons 33 to 39, 43, 44, and 47). Further, the left controller 3 includes the analog stick (“stick” in FIG. 7) 32. Each of the buttons 103 and the analog stick 32 outputs information regarding an operation performed on itself to the communication control section 101 repeatedly at appropriate timing.

The communication control section 101 acquires information regarding an input (specifically, information regarding an operation or the detection result of the sensor) from each of input sections (specifically, the buttons 103 and the analog stick 32). The communication control section 101 transmits operation data including the acquired information (or information obtained by performing predetermined processing on the acquired information) to the main body apparatus 2. It should be noted that the operation data is transmitted repeatedly, once every predetermined time. It should be noted that the interval at which the information regarding an input is transmitted from each of the input sections to the main body apparatus 2 may or may not be the same.

The above operation data is transmitted to the main body apparatus 2, whereby the main body apparatus 2 can obtain inputs provided to the left controller 3. That is, the main body apparatus 2 can determine operations on the buttons 103 and the analog stick 32 based on the operation data.

The left controller 3 includes a power supply section 108. In the exemplary embodiment, the power supply section 108 includes a battery and a power control circuit. Although not shown in FIG. 7, the power control circuit is connected to the battery and also connected to components of the left controller 3 (specifically, components that receive power supplied from the battery).

As shown in FIG. 7, the right controller 4 includes a communication control section 111, which communicates with the main body apparatus 2. Further, the right controller 4 includes a memory 112, which is connected to the communication control section 111. The communication control section 111 is connected to components including the terminal 64. The communication control section 111 and the memory 112 have functions similar to those of the communication control section 101 and the memory 102, respectively, of the left controller 3. Thus, the communication control section 111 can communicate with the main body apparatus 2 through both wired communication via the terminal 64 and wireless communication not via the terminal 64 (specifically, communication compliant with the Bluetooth (registered trademark) standard). The communication control section 111 controls the method for communication performed by the right controller 4 with the main body apparatus 2.

The right controller 4 includes input sections similar to the input sections of the left controller 3. Specifically, the right controller 4 includes buttons 113 and the analog stick 52. These input sections have functions similar to those of the input sections of the left controller 3 and operate similarly to the input sections of the left controller 3.

The right controller 4 includes a power supply section 118. The power supply section 118 has a function similar to that of the power supply section 108 of the left controller 3 and operates similarly to the power supply section 108.

### 2. Outline of Process on Game System

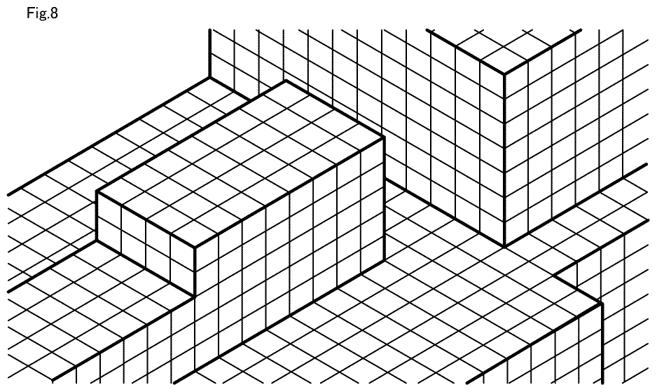

Next, referring to FIG. 8 to FIG. 29, an outline of the process performed on the game system 1 will be described. In the present embodiment, the game system 1 generates a game image in which terrain objects and characters (e.g., the player character controlled by the player) are arranged in a game space, which is a three-dimensional virtual space, and displays the game image on a display device. Note that in the present embodiment, the display device on which the game image is displayed may be the display 12 described above, or may be a stationary monitor.

### 2-1. Voxel

In the present embodiment, for some objects in the game space, the shape is defined by voxel data. Here, voxels are rectangular parallelepiped (more specifically, cubic) regions arranged in a grid pattern in the game space, and voxel data is data indicating information regarding the voxels. Hereinafter, an object whose shape is defined by voxel data will be referred to as a “voxel object”. In the present embodiment, the game system 1 stores voxel data for a plurality of voxels that are set in the game space as data for generating voxel objects in the game space.

FIG. 8 is a view showing an example of a terrain object, which is a voxel object. As shown in FIG. 8, in the present embodiment, a terrain object representing a terrain such as a ground surface has its shape defined by voxel data. The cubes shown in FIG. 8 represent a terrain object. Note that in FIG. 8, edges of the terrain object are indicated by thick lines. However, these thick lines are added for the purpose of making the drawings easier to understand, and there is no need for edges of the terrain object to be drawn thick.

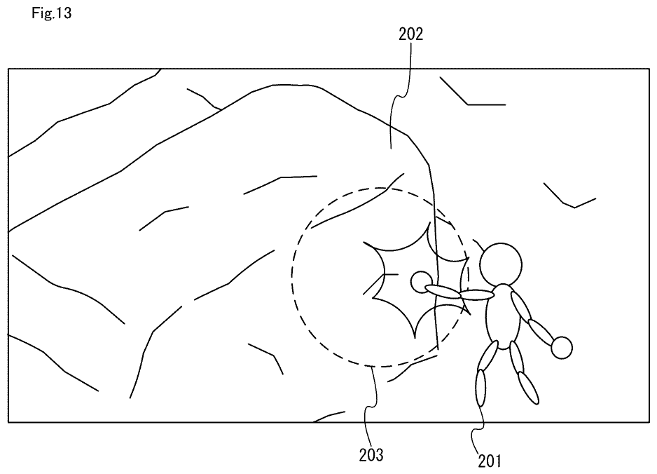

For example, the terrain object shown in FIG. 8 is generated by the following rule: “a cube is placed at the position of a voxel if a parameter included in the voxel data set for the voxel is greater than a predetermined value, and nothing is placed at the position of the voxel if the parameter is less than or equal to the predetermined value”. A terrain object in FIG. 8 is shown for the purpose of illustrating the relationship between voxels and voxel objects in an easy-to-understand manner. Note that in the present embodiment, in practice, a voxel object is generated (e.g., based on voxel data) by such a rule that results in a terrain object having a complicated shape, such as a terrain object shown in FIG. 13 to be described below, for example. Note that there is no limitation on the rule for determining the shape of the voxel object based on the voxel data. In other embodiments, the game system 1 may generate a voxel object as shown in FIG. 8 based on the object data or may generate a voxel object as shown in FIG. 13 based on the object data.

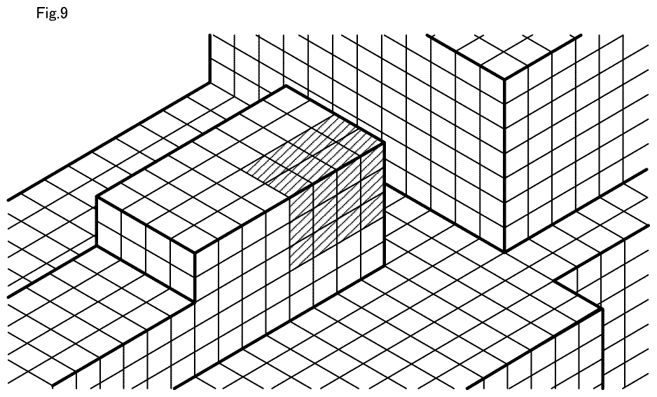

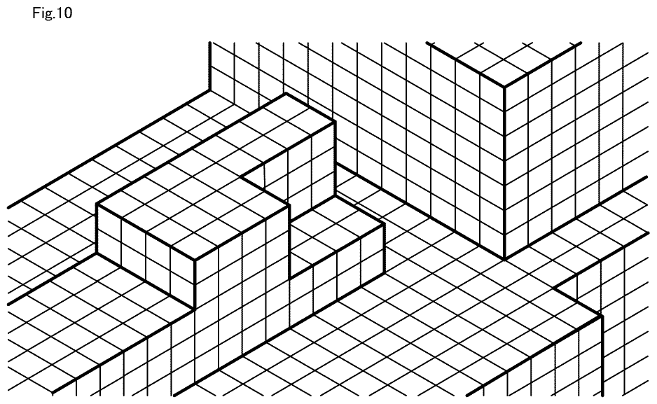

It is possible to change the shape of a voxel object by changing voxel data of voxels. FIG. 9 and FIG. 10 are views showing before and after the removal of a portion of the terrain object shown in FIG. 8. That is, when the hatched portion of the terrain object shown in FIG. 9 is broken, the terrain object changes to a shape as shown in FIG. 10. In such a case, the game system 1 can easily delete the terrain object by rewriting the voxel data described below so as to indicate that the terrain object is absent for voxels in the hatched portion. Note that also when making an addition to the terrain object, as when deleting the terrain object, the game system 1 can easily change the shape of the terrain object by changing the voxel data of voxels.

Thus, the game system 1 can freely change the shape of a voxel object by rewriting the voxel data. For example, the shape of a terrain object may be changed as a result of the terrain object in a game being broken for some reason (e.g., the player object striking the terrain object). In such a case, the game system 1 can freely change the shape of the terrain object by changing the voxel data used to generate the terrain object, rather than directly changing data representing the outer shape of the terrain object (e.g., the mesh to be described below).

In the exemplary embodiment, voxels are defined in the entire game space (e.g., a voxel space in which voxels are set corresponds to the entire game space). However, the voxel space may not necessarily be set over the entire game space, and may be set in a certain area in the game space. If the voxel space is set in a certain area in the game space, the shape of the voxel object is defined by voxel data regarding voxels in the voxel space, and the position of the voxel object in the game space is defined by the position of the voxel space in the game space. The game space may include a main voxel space that is set over the entire game space, and a sub voxel space that is set in a certain area in the game space. In this case, the game system 1 stores therein the voxel data for each voxel space.

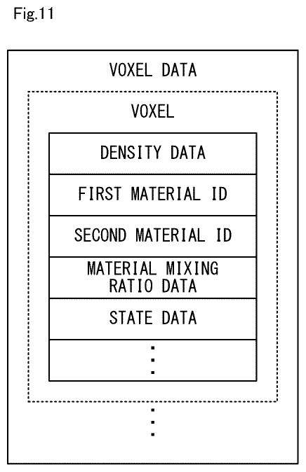

FIG. 11 shows an example of voxel data. The voxel data includes density data, a first material ID, a second material ID, material mixing ratio data, and state data, for each voxel defined in the game space. In the voxel data according to the exemplary embodiment, these pieces of data are set for each voxel.

The density data indicates a density that is an index used for defining the shape of a voxel object based on the voxel (specifically, the shape defined by a mesh described below). As will be described in detail below, the position and shape of the surface of the voxel object (e.g., the mesh described below) are determined based on the density.

In the exemplary embodiment, the density can take an integer value in a range from a lower limit value (e.g., 0) to an upper limit value (e.g., 255). In the exemplary embodiment, the game system 1 determines a surface shape of the voxel object, based on the density such that the proportion of the volume that the area in the voxel object occupies in the voxel tends to be greater when the density value set for the voxel is higher, and the proportion tends to be smaller when the density value is lower. Thus, the density is an index that has an influence on the proportion of the volume that the area in the voxel object occupies in the voxel. The density can also be regarded as an index that indicates the degree of virtual occupation of the content (e.g., the virtual content of the voxel object) in the space of the voxel. For example, when the density is 0, the voxel is empty. When the density is 255, the entire space in the voxel is the content of the voxel object. When the density is a value between 0 and 255, the content of the voxel object occupies the space in the voxel based on (e.g., in a proportion according to) the value. The shape of the mesh, e.g., the surface shape of the voxel object, can be determined based on the density. The mesh can be regarded as the surface of a part, of a voxel, in which the content exists, or as a boundary between a part, of a voxel, in which the content exists and a part, of the voxel, in which the content does not exist. The volume that the area in the voxel object generated based on the density occupies may not necessarily be the volume that exactly matches the proportion indicated by the density. For example, the volume of the voxel object may differ between the method for generating a voxel object as shown in FIG. 8 and the method for generating a voxel object as shown in FIG. 13 even if these methods are based on the same density.

In other embodiments, the density may indicate either a state in which the volume of the area in the voxel object occupies the entire area in the voxel or a state in which the volume of the area in the voxel object is not included in the area in the voxel. For example, the density data may be data that can take only 0 or 1.

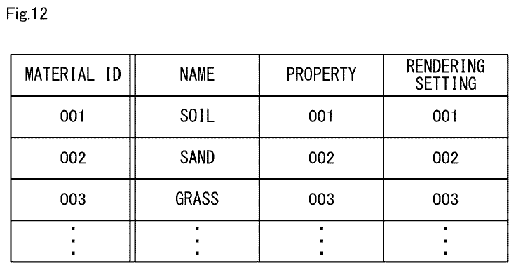

The first material ID and the second material ID are information indicating materials of the corresponding voxel. In the exemplary embodiment, a material such as sand, rock, or soil is set for a voxel. In the game system 1, multiple types of materials are prepared as materials that can be set for voxels (see material data shown in FIG. 12). In the exemplary embodiment, at most two materials out of the prepared multiple types of materials can be set for one voxel. The first material ID is an ID indicating a first material set for the voxel, and the second material ID is an ID indicating a second material set for the voxel. As will be described in detail below, a material of a voxel object (e.g., a material to be set for a polygon of the voxel object) is determined based on the materials set for voxels.

As described above, in the exemplary embodiment, the voxel data includes the ID indicating the material. However, in other embodiments, the voxel data may have a data structure that includes data directly indicating the details of the material (e.g., information on the name, property, and rendering setting described below).

The material mixing ratio data is an example of data indicating a ratio of materials in the voxel. In the exemplary embodiment, since at most two material IDs are set for one voxel, the material mixing ratio data, which indicates the ratio of one of the material indicated by the first material ID and the material indicated by the second material ID, can also indicate the ratio of the other material. In the exemplary embodiment, it is assumed that the material mixing ratio is a value indicating the ratio of the second material to the entire material consisting of the first material and the second material. The value is 0 or more and 1 or less. For example, if the material mixing ratio set for a certain voxel is 0.4, this indicates that the voxel is composed of the first material and the second material in the ratio of 0.6:0.4. As will be described in detail below, the appearance and property of the voxel object are determined based on the materials. The material mixing ratio is used to determine the appearance and property of the voxel object. In other embodiments, the material mixing ratio may be a value indicating the proportion of the first material. The ratio of the materials in the voxel may be indicated by the values of the proportions of the materials. In particular, in other embodiments, if the number of settable types of materials is not limited to two at most and three or more types of materials can be set, the ratio of the materials in the voxel is indicated by a plurality of values respectively indicating the proportions of the materials.

In the exemplary embodiment, two types of materials may not necessarily be set for a voxel, and one type of material may be set. For example, if one type of material is set for a certain voxel, the first material ID indicates this material, and the material mixing ratio is set at 0.

The state data indicates a state that is set for the corresponding voxel. The specific content of state data and the number of types thereof are discretionary. In the exemplary embodiment, the state data includes data indicating the amount of damage set on the voxel. In other embodiments, the state data may include data indicating whether or not the voxel is wet (and its extent), for example.

As described above, in the exemplary embodiment, since the voxel data includes the material ID, the game system 1 stores therein material data that defines the content of the material indicated by the material ID. FIG. 12 shows an example of the material data. As shown in FIG. 12, in the material data according to the exemplary embodiment, for each material, a material ID is associated with information on a name, a property, and rendering setting that are set for the material.

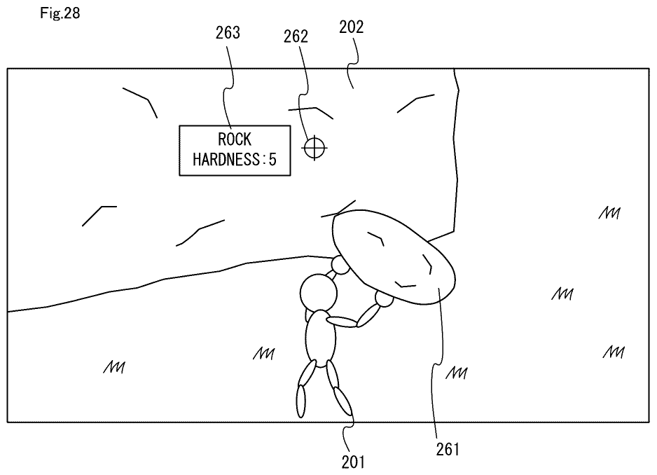

The name included in the material data is a name (e.g., soil, sand, grass, etc.) set for the material. As will be described in detail below, during the game, the name of the material of the voxel object may sometimes be displayed (see FIG. 28). In order to perform such a display, the material data includes information on the name of the material.

The property included in the material data is a property set for the material. The property of the material is a property that the voxel object, on which the material is set, possesses in the game. The specific content of the property of the material, and the number of types of properties are discretionary. For example, at least one of the following pieces of information may be set as properties of a material.
Hardness
Weight
Slipperiness
Damage setting in the case where the player character comes into contact with the voxel object
Temperature
Whether another object can be bonded to the voxel object
Amount of hit points to be regained by the player character when the player character destroys or acquires the voxel object
Amount of in-game currency to be gained by the player character when the player character destroys or acquires a voxel object

In other embodiments, information different from those listed above may be set as information indicating a property of a material.

In the exemplary embodiment, the material data includes, as information that identifies a property of a material, an ID indicating the property (see FIG. 12). Although not shown in FIG. 12, the game system 1 stores, for each property to be prepared, property information in which the property ID is associated with the content of the property (e.g., a value indicating the aforementioned weight or slipperiness). By referring to the property information, the game system 1 can specify the specific content of the property set for the material.

The rendering setting included in the material data is information that indicates setting regarding rendering, such as a texture used for rendering of the voxel object for which the material is set. In the exemplary embodiment, the material data includes, as information on rendering setting, an ID of a texture to be used for rendering the voxel object for which the material is set (see FIG. 12). Although not shown in FIG. 12, the game system 1 stores, for each texture prepared, texture information in which the texture ID is associated with the texture indicated by the texture ID. By referring to the texture information, the game system 1 can specify the specific content of the texture set for the material. In other embodiments, as information on rendering setting, any information regarding setting of shading may be set in addition to the texture information. For example, information regarding reflectivity, normal, or the like may be set.

The material data may include data other than the data shown in FIG. 13. For example, the material data may include data regarding sound setting. For example, the data regarding the sound setting may be data that defines the sound of footsteps that is outputted when the player character walks on the voxel object based on the voxel.

The material data may be data of any form capable of specifying the property and/or rendering setting of the material. For example, in other embodiments, the material data may have a data structure including data that directly indicates the property and/or rendering setting of the material, instead of the data structure including the material ID and the texture ID.

### 2-2. Update of Voxel Data

During the game, the voxel object is deformed when the voxel data is updated. In the exemplary embodiment, when a game event for updating the voxel object (hereinafter referred to as “update event”) has occurred, the game system 1 updates the voxel data. The update event may have any content. For example, the update event may be that a character that appears in the game has performed an action to deform the voxel object (e.g., the player character has punched the voxel object), or may be that an event that deforms the voxel object has occurred (e.g., contact of an object thrown by a character with the voxel object, or explosion of a bomb).

FIG. 13 shows an example of a game space when an update event has occurred. In the situation shown in FIG. 13, a player character 201 has performed a punching action to a terrain object 202 that is a voxel object. As will be described in detail below, in the example shown in FIG. 13, the voxel data is updated such that the terrain object 202 at and around a position hit by the punching action of the player character 201 is deleted. This represents how the terrain object 202 is destroyed by the punching action of the player character 201.

In the exemplary embodiment, when such an update event has occurred, the game system 1 sets, in the game space, an update range in which the voxel object is updated (in the example shown in FIG. 13, an update range 203). The position, shape, and size of the update range are discretionary. The position of the update range may be determined based on, for example, a position at which an object regarding the generated update event (e.g., the player character that has punched) comes into contact with the voxel object. In the example shown in FIG. 13, the position of the update range 203 may be determined based on a position that is hit by the punch of the player character 201. For example, the hit position, or a position a predetermined distance ahead of the hit position may be a center position of the update range 203. The shape and size of the update range may be determined in advance according to the type of the update event. For example, when an update event due to a punch of the player character 201 has occurred, the shape and size of the update range may be determined to be a sphere having a predetermined size as shown in FIG. 13. The size of the update range may be determined based on a value indicating the degree of influence of the generated update event (e.g., the intensity of the punch, or the magnitude of the explosion).

The game system 1 changes the density of a voxel corresponding to the set update range. The voxel corresponding to the update range is, for example, a voxel within the update range or a voxel overlapping the update range. As a result of the change in the density, the mesh of the voxel object is changed by a process described below, thereby changing the shape of the voxel object (the shape by appearance, and the shape used for contact determination). In other embodiments, in addition to changing the density of the voxel included in the update range, the game system 1 may change the material in the voxel (e.g., the first material, the second material, and the material mixing ratio), or may change the state in the voxel.

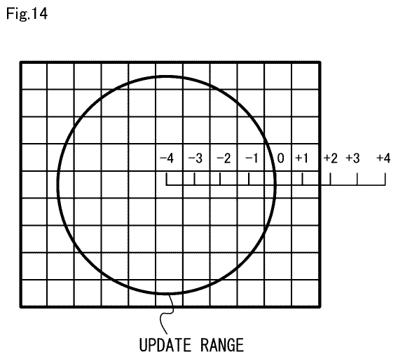

In the exemplary embodiment, the game system 1 determines whether or not a voxel is included in the update range, by using an SDF (Signed Distance Field). The game system 1 sets an SDF indicating an update range set in the game space, and performs the aforementioned determination based on the value of the SDF. The SDF represents distances, with signs, of any positions from a shape that the SDF defines. FIG. 14 shows an example of the update range. In the example shown in FIG. 14, a spherical update range is set in the game space. For example, in the example shown in FIG. 14, an SDF is set such that, among positions in the game space, positions inside the shape represented by the SDF have negative SDF values, and positions outside the shape represented by the SDF have positive SDF values. In this example, whether or not each position is included in the update range can be determined depending on whether or not the SDF value is positive or negative. In addition, using the SDF values allows not only simple inside/outside determination but also a process such as correction or interpolation.

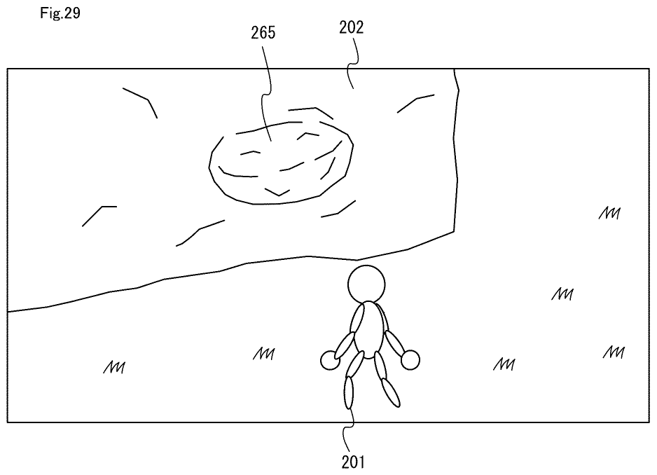

In the example described above, a change in which the voxel object in the update range is deformed as if it is deleted, is applied to the voxel object. However, a change to be applied to the voxel object by using the update range is not limited thereto. For example, a change in which a voxel object is newly added in the update range (e.g., the volume that an area in the voxel object occupies is increased by the update range) may be applied to the voxel object (see FIG. 29 described below). A change in which only the voxel material in the update range is changed while the voxel density is not changed, may be applied to the voxel object. A change in the voxel density and a change in the voxel material may be integrally applied.

### 2-3. Calculation of Vertices

When the voxel density has been updated as described above, the game system 1 sets vertices based on the updated voxel data. The vertices can be vertices of a mesh of a voxel object. As will be described in detail below, in the exemplary embodiment, the vertices are simplified, and the simplified vertices become the vertices of the mesh of the voxel object.

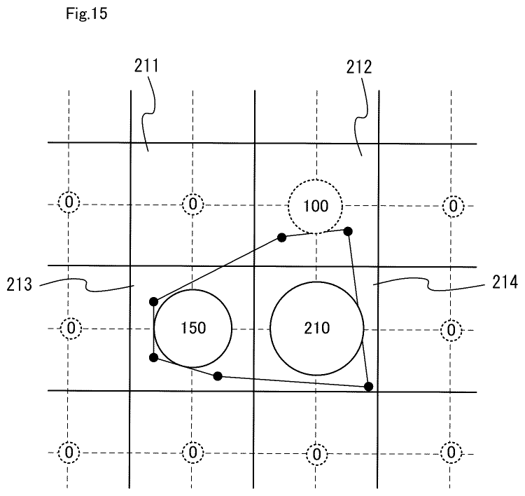

FIG. 15 shows an example of a method for setting vertices. In FIGS. 15 to 24, voxels, vertices, meshes, etc., are represented in two dimensions for the purpose of making the drawings easily viewable, and the description easily understandable. However, in actuality, vertices and meshes are set in a three-dimensional space, based on voxels in the three-dimensional space. In the exemplary embodiment, the game system 1 executes a method in which, for a portion where a voxel having a density that is set to a value indicating “existence” (e.g., a density equal to or greater than a reference value described below) is adjacent to a voxel having a density that is set to a value indicating “nonexistence” (e.g., a density less than the reference value described below), a vertex is set at coordinates based on the positions and densities of a plurality of neighboring voxels around the portion. Hereinafter, this method will be described in detail.

As described above, in the exemplary embodiment, the density set for a voxel is in the range of 0 to 255. A voxel having a density of 0 is completely empty, and a voxel having a density of 255 is completely filled up. Densities between 0 and 255 are complementarily treated, and are used for determining a vertex. In the exemplary embodiment, voxels are virtually treated such that voxels whose densities are equal to or greater than a reference value are inside a voxel object, and voxels whose densities are less than the reference value are outside the voxel object. It is also possible to virtually treat voxels such that voxels whose densities are equal to or greater than the reference value are voxels indicating “existence”, and voxels whose densities are less than the reference value are voxels indicating “nonexistence”. It is not necessary to define only voxels having a density of 0 as being outside the voxel object (e.g., reference value=1), and the reference value may be set to, for example, 128. In the example shown in FIG. 15, a voxel 211 and the other outer voxels have a density of 0, a voxel 212 has a density of 100 which is less than the reference value (e.g., 128), and voxels 213, 214 respectively have densities of 150, 210 which are greater than the reference value. In the exemplary embodiment, the game system 1 generates vertices between the voxels whose densities are equal to or greater than the reference value and the voxels whose densities are less than the reference value. Specifically, for each region (region delimited by dotted lines) that straddles eight (four in the figure) adjacent voxels, it is determined whether or not to generate a vertex. That is, a vertex is generated in each region that straddles both a voxel whose density is equal to or greater than the reference value and a voxel whose density is less than the reference value. The coordinates of each vertex are determined by comparing the densities of adjacent voxels and performing interpolation based on the difference in density for each of the XYZ axes. Normal information that defines positions and directions of straight lines connecting the vertices may be set in advance, whereby the coordinates of each vertex can be calculated based on the normal information. The normal information may be stored in advance for at least some of the voxels, or if not stored, the normal information may also be calculated based on the densities between adjacent voxels. In FIG. 15, since the density of the voxel 212 is less than the reference value, the voxel 212 is treated as being outside the voxel object in the determination of presence/absence of a vertex, but the density value itself of the voxel 212 is used to calculate the coordinates of the vertices to be generated. If the reference value is set to a value lower than the density of the voxel 212, it would result in an increase in the vertices on the upper right side and the upper left side in the voxel 212 shown in FIG. 15.

By setting the vertices as described above, it is possible to generate a shape whose volume is based on (e.g., reflects) the density of each voxel to some extent, in generating a mesh connecting the set vertices (or vertices obtained by subjecting the set vertices to a simplification process described below). However, depending on the relationship with the neighboring voxels, a voxel having a density of 0 may partially include a region inside the voxel object, or a voxel having a density of 255 may partially include a region outside the voxel object. In the exemplary embodiment, since voxels having densities less than the reference value are treated as being outside the voxel object, there are fewer vertices as compared with a case where those voxels are treated as being inside the voxel object, and the volume will be smaller accordingly. That is, there is no need to calculate the polygon mesh so that the volume strictly corresponds to the density value.

### 2-4. Determination of Material of Vertex

The game system 1 determines a material for each of the vertices set as described above. The material of the vertex is determined based on materials regarding voxels around this vertex. The voxels around the vertex are, for example, voxels used for determining whether or not to generate the vertex (e.g., voxels overlapping the aforementioned region that straddles voxels). In other embodiments, the voxels used for determining the material of the vertex and the voxels used for determining generation of the vertex may not necessarily be the same, and may be different from each other.

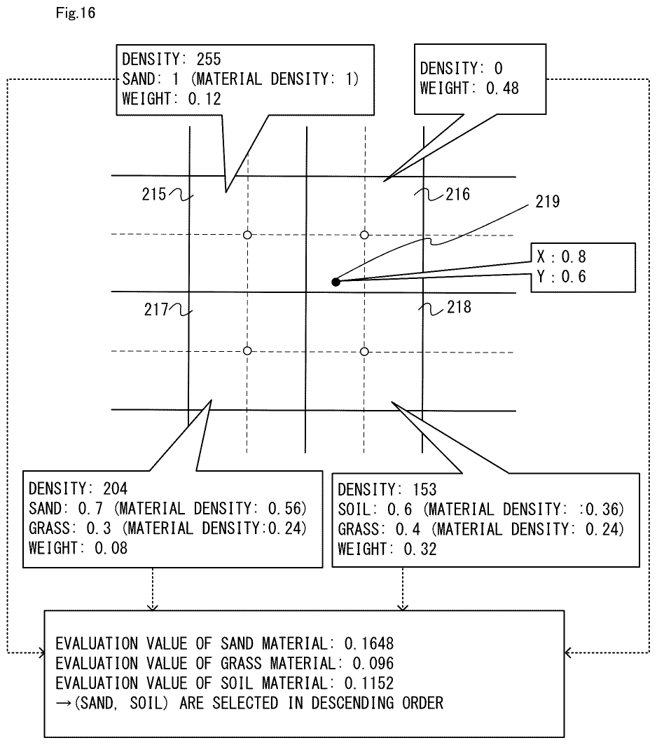

FIG. 16 shows an example of a method for determining a material of a vertex. In the example shown in FIG. 16, a vertex 219 is set with respect to four voxels 215 to 218, and the four voxels 215 to 218 correspond to the aforementioned “voxels around the vertex”. In an actual three-dimensional space, the number of voxels around the vertex is eight. In the example shown in FIG. 16, as for the voxel 215, a density of 255, a first material of “sand”, and a material mixing ratio of 0 (e.g., first material:second material=1:0, or the second material may not necessarily be set) are set. As for the voxel 216, a density of 0 is set (the first and second materials may not necessarily be set). As for the voxel 217, a density of 204, a first material of “sand”, a second material of “grass”, and a material mixing ratio of 0.3 (e.g., first material:second material=0.7:0.3) are set. As for the voxel 218, a density of 153, a first material of “soil”, a second material of “grass”, and a material mixing ratio of 0.4 (e.g., first material:second material=0.6:0.4) are set. In addition, the coordinates indicating the position of the vertex 219 are (X, Y)=(0.8, 0.6). A coordinate system for the coordinates has an X coordinate in the left-right direction and a Y coordinate in the up-down direction, in FIG. 16. In the coordinate system, among center positions of the voxels 215 to 218 (positions of white circles in FIG. 16), the center position of the lower-left voxel 217 is (0, 0).

In determining a material of the vertex, the game system 1 calculates an evaluation value for each of the materials of the neighboring voxels, based on the density of the material, and a weight value based on the distance from the voxel to the vertex. First, the weight value is calculated for each voxel. The shorter the distance from the center position of the voxel to the vertex is, the greater the weight value is. In the exemplary embodiment, assuming that the center position of a certain voxel is (x1, y1) and the coordinates of the vertex are (x2, y2), a weight value for the voxel is calculated according to the following formula (1).

$$( weight value ) = \vert ( 1 - x 1 ) - x 2 \vert \cdot \vert ( 1 - y 1 ) - y 2 \vert \qquad ( 1 )$$

In the example shown in FIG. 16, the weight values of the voxels 215 to 218 calculated according to the formula (1) are as follows.

$$( weight value of voxel 215 ) = \vert ( 1 - 0 ) - 0.8 \vert \cdot \vert ( 1 - 1 ) - 0.6 \vert = 0.12$$

$$( weight value of voxel 216 ) = \vert ( 1 - 1 ) - 0.8 \vert \cdot \vert ( 1 - 1 ) - 0.6 \vert = 0.48$$

$$( weight value of voxel 217 ) = \vert ( 1 - 0 ) - 0.8 \vert \cdot \vert ( 1 - 0 ) - 0.6 \vert = 0.08$$

$$( weight value of voxel 218 ) = \vert ( 1 - 1 ) - 0.8 \vert \cdot \vert ( 1 - 0 ) - 0.6 \vert = 0.32$$

The game system 1 calculates a density of a material for each voxel. Here, the density of the material is a value obtained by multiplying the proportion of this material, among materials set for the voxel, by the density of the voxel. In the exemplary embodiment, for the densities of the voxels, values obtained by normalizing the aforementioned values from 0 to 255 to values from 0 to 1 are used. In the example shown in FIG. 16, as for the voxel 215, since the material set for this voxel is only sand, the proportion regarding the sand material is 1, and the density of the voxel is 1, and therefore, the density of the sand material is 1. As for the voxel 216, since the density is 0 and no material is set, a material density is not calculated. If any material is set, the density of this material is 0. As for the voxel 217, the proportions of the sand material and the grass material being set are 0.7 and 0.3, respectively, and the density of the voxel is 204/255=0.8. Therefore, the density of the sand material is 0.7·0.8=0.56, and the density of the grass material is 0.3·0.8=0.24. As for the voxel 218, the proportions of the soil material and the grass material being set are 0.6 and 0.4, respectively, and the density of the voxel is 153/255=0.6. Therefore, the density of the soil material is 0.6 ·0.6=0.36, and the density of the grass material is 0.4·0.6=0.24.

Then, the game system 1 calculates the evaluation value for each material, based on the weight value and the density of the material. In the exemplary embodiment, the evaluation value of the material is a value obtained by weighting the density of the material calculated for each voxel, according to the weight value of the voxel, and summing up the weighted densities of the neighboring voxels. In the example shown in FIG. 16, the evaluation value of the sand material is 1·0.12+0.56·0.08=0.1648 because the density of the material is 1 and the weight value is 0.12 for the voxel 215, and the density of the material is 0.56 and the weight value is 0.08 for the voxel 217. The evaluation value of the grass material is 0.24·0.08+0.24·0.32=0.096 because the density of the material is 0.24 and the weight value is 0.08 for the voxel 217, and the density of the material is 0.24 and the weight value is 0.32 for the voxel 218. The evaluation value of the soil material is 0.36·0.32=0.1152 because the density of the material is 0.36 and the weight value is 0.32 for the voxel 218.

The game system 1 determines a material of the vertex, based on the evaluation values of the respective materials. Specifically, a predetermined number of materials in order from one having the greater evaluation value are determined as materials of the vertex. In the exemplary embodiment, two materials having the first and second greatest evaluation values are determined as materials of the vertex. In the example shown in FIG. 16, since the evaluation values of the sand, grass, and soil materials are 0.1648, 0.096, and 0.1152, respectively, the sand material and the soil material are determined as the materials of the vertex. Furthermore, the game system 1 calculates the ratio of the determined two materials, based on the evaluation values described above. In the exemplary embodiment, the ratio of the two materials may be represented as a second material ratio that is a ratio of the second material to the whole, like the aforementioned material mixing ratio. In the example shown in FIG. 16, for example, if the first material and the second material are set to soil and sand, respectively, the second material ratio is represented as 0.1648/(0.1648+0.1152)≈0.59. In other embodiments, as a value representing the ratio of the two materials, a value representing the proportion of the first material may be used. Alternatively, values representing the proportions of the respective materials may be used.

In the exemplary embodiment, the game system 1 generates and stores therein vertex data indicating the position of a vertex, material IDs of the first and second materials set for the vertex, and the ratio of the materials. However, the method for managing materials set for a vertex is discretionary. In other embodiments, the vertex data may have a data structure including data that directly indicates the contents of the first and second materials.

As described above, in the exemplary embodiment, regarding material IDs included in voxel data of a plurality of neighboring voxels around each vertex, the game system 1 calculates a priority parameter (e.g., evaluation value) for each material ID, based on the voxel data. Then, based on the priority parameters, the game system 1 selects a predetermined number of (two in this embodiment) material IDs having the higher priorities, and determines the selected materials IDs as material IDs for the vertex. The specific parameter to be used as the priority parameter is not limited to the evaluation value. For example, in other embodiments, an evaluation value that is calculated using the density of the material without using the weight value may be used as a priority parameter.

In the exemplary embodiment, the evaluation value as an example of the priority parameter is calculated based on the densities of the plurality of neighboring voxels around the vertex such that the material set for the voxel having the higher density has the higher priority (e.g., the evaluation value of the material is increased and thereby the material is highly likely to be selected). Thus, the material of the vertex can be determined while also incorporating (e.g., reflecting) the magnitude of the density set for the voxel.

In the exemplary embodiment, the evaluation value as an example of the priority parameter is calculated based on the distances from reference positions (specifically, center positions) of a plurality of neighboring voxels around the vertex, to the vertex such that the material set for the voxel closer to the vertex has the higher priority. Thus, the material of the vertex can be determined while also incorporating (e.g., reflecting) the distances between the voxels and the vertex.

In the exemplary embodiment, it can also be said that the evaluation value as an example of the priority parameter is calculated based on the material mixing ratios of a plurality of neighboring voxels around the vertex such that the material having the higher material mixing ratio has the higher priority. Thus, in the case where a plurality of materials are set for one voxel, the material of the vertex can be determined while also incorporating (e.g., reflecting) the ratio of the materials.

### 2-5. Simplification of Vertices

In the exemplary embodiment, the game system 1 simplifies the vertices calculated as described above. That is, the game system 1 replaces some of the vertices calculated as described above with one vertex to decrease the number of vertices. As will be described in detail below, the coordinates (e.g., position) and the material of the replacing vertex are set based on a plurality of vertices before replacement. Such simplification can reduce the numbers of vertices and polygons that form a mesh of a voxel object, thereby reducing the amount of memory used for processing, and reducing the processing load.

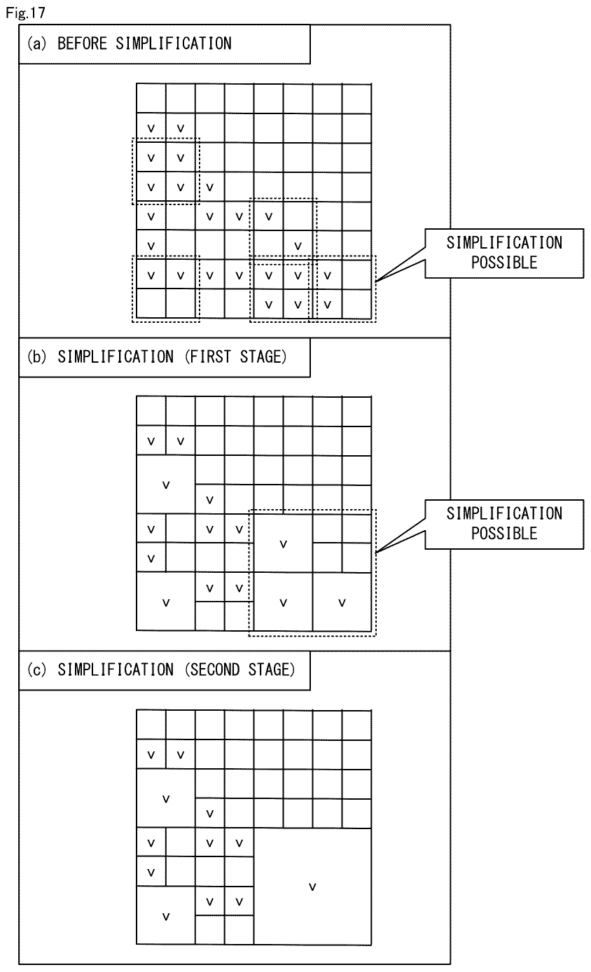

In the exemplary embodiment, the game system 1 performs simplification by representing vertices using SVO (Sparse Voxel Octree). FIG. 17 shows an example of vertex simplification. In FIG. 17, one square delimited by solid lines in (a) represents one vertex division region. Here, the vertex division region is a square region with a center position of a voxel being a vertex (in an actual three-dimensional space, the vertex division region is a cube or a rectangular parallelepiped), and corresponds to a region with the dotted lines being sides shown in FIG. 15 and FIG. 16. In FIG. 17, each vertex division region having a character “v” inside is a vertex division region in which a vertex is set.

In the exemplary embodiment, the game system 1 determines whether or not simplification can be performed with respect to the vertices in a predetermined number of (four in FIG. 17, and eight in an actual three-dimensional space) vertex division regions adjacent to each other. If the determination result is that simplification can be performed, simplification is performed for the vertices in the predetermined number of vertex division regions.

In FIG. 17, (a) shows the state before simplification is performed. In the example shown in FIG. 17, it is determined that simplification can be performed for vertex division regions within a range surrounded by dotted lines. In this case, the game system 1 performs simplification such that the vertices in the predetermined number of vertex division regions determined to be simplified are replaced with one vertex (see (b) of FIG. 17). Thus, the vertices in the predetermined number of vertex division regions are simplified to one vertex.

In the exemplary embodiment, the game system 1 performs simplification in a plurality of stages. The number of the stages is discretionary. In FIG. 17, first and second stages are shown and described. In FIG. 17, (b) shows the state in which the first-stage simplification has been performed, and (c) shows the state in which the second-stage simplification has been performed. In the second-stage simplification, whether or not simplification can be performed is determined for vertices that are generated by the first-stage simplification. In the example shown in FIG. 17, when the determination result is that the vertex division regions within a range surrounded by dotted lines in (b) of FIG. 17 can be subjected to simplification, the vertices in the vertex division regions are simplified, resulting in the state shown in (c) of FIG. 17. The condition for determining whether or not the first-stage simplification can be performed and the condition for determining whether or not the second-stage simplification can be performed may be the same or different from each other.

The specific method for determining whether or not simplification can be performed is discretionary. In the exemplary embodiment, as conditions for the above determination, a condition regarding the shape of the voxel object and a condition regarding the material of the voxel object are used. In the exemplary embodiment, if both the condition regarding the shape of the voxel object and the condition regarding the material of the voxel object are satisfied, it is determined that simplification can be performed. If at least one of the condition regarding the shape of the voxel object and the condition regarding the material of the voxel object is not satisfied, it is determined that simplification cannot be performed.

The condition regarding the shape is, for example, that there is no significant change between the shape due to the vertices before the simplification and the shape due to the vertices after the simplification. For example, determination as to whether or not there is a significant change in the shape due to the vertices before and after the simplification may be performed by calculating an index indicating an error between the mesh before the simplification and the mesh after the simplification, and determining whether or not the index is equal to or smaller than a predetermined allowable value. Furthermore, for example, if the shape due to the vertices after the simplification is not a hollow shape while the shape due to the vertices before the simplification is a hollow shape (e.g., the simplification causes missing of information that the shape is hollow), it is determined that the condition regarding the shape is not satisfied. Whether or not the aforementioned case will occur can be determined based on, for example, the densities of voxels corresponding to the vertex division regions to be subjected to the determination. Moreover, for example, if the shape due to the vertices before the simplification can be represented only by two or more vertices, e.g. it cannot be represented by one vertex, it is determined that the condition regarding the shape is not satisfied. As the condition regarding the shape of the voxel object, the same condition as that used for the conventional method with the SVO may be used.

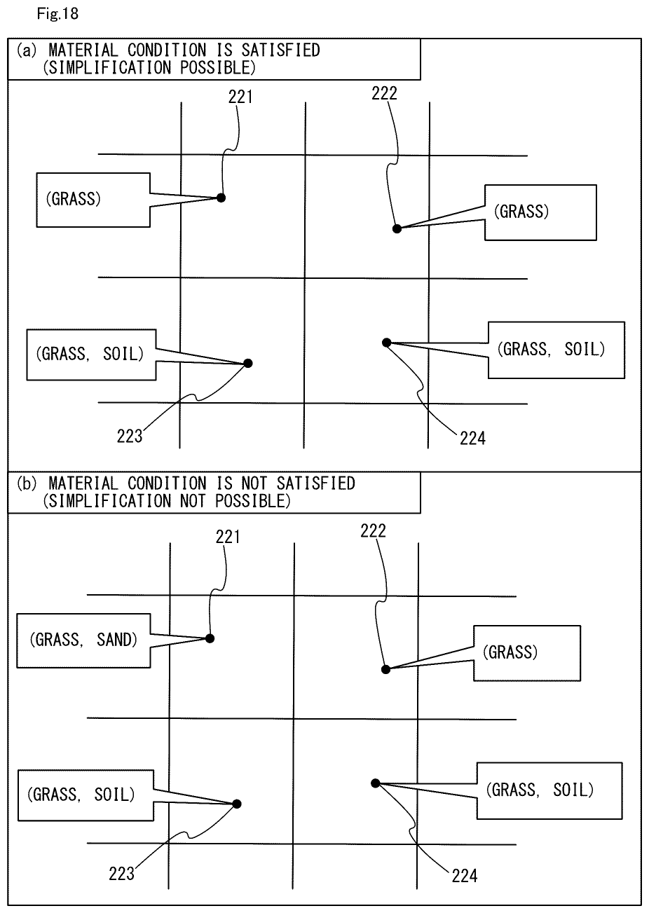

In the exemplary embodiment, as the condition regarding the material, a condition regarding the number of types of materials to be set for the vertices in the predetermined number of vertex division regions to be subjected to simplification, is used. FIG. 18 shows an example of the first condition regarding the material. In FIG. 18, (a) shows a case where the materials of vertices 221 to 224 are “grass”, “grass”, “grass and soil”, and “grass and soil”, respectively, and (b) shows a case where the materials of the vertices 221 to 224 are “grass and sand”, “grass”, “grass and soil”, and “grass and soil”, respectively. In the exemplary embodiment, the condition regarding the material is that the total number of the types of materials set for the vertices to be subjected to simplification is equal to or less than a predetermined number. For example, the condition regarding the material is that the total number is equal to or less than the number of materials that can be set for one vertex. In the exemplary embodiment, the predetermined number is 2. For example, in the case of (a) of FIG. 18, since the total number of the types of materials set for the vertices 221 to 224 to be subjected to simplification is 2 (e.g., grass and soil), the condition regarding the material is satisfied. In this case, it is determined that the vertices 221 to 224 can be subjected to simplification on the condition that the aforementioned condition regarding the shape of the object are satisfied. On the other hand, in the case of (b) of FIG. 18, since the total number of the types of materials set for the vertices 221 to 224 to be subjected to simplification is 3 (e.g., grass, soil, and sand), the condition regarding the material is not satisfied. In this case, it is determined that the vertices 221 to 224 cannot be subjected to simplification regardless of whether or not the second condition and the condition regarding the shape of the object are satisfied.

In the game system 1, multiple types of materials to which the same property is set and which are different in appearance may be prepared even though these materials should strictly be classified into different types. Some of the multiple types of materials may be regarded as being of the same type in determining whether the condition regarding the material is satisfied. For example, multiple types of soil materials having the same property and similar appearances (e.g., texture colors or patterns) may be prepared. In this case, the game system 1 may determine whether the condition regarding the material is satisfied while regarding the multiple types of soils as being of the same type.

In the exemplary embodiment, at most two types of materials can be set for a vertex as in the case of a voxel. Meanwhile, in the exemplary embodiment, if the total number of the types of materials set for the vertices to be subjected to simplification is three or more, simplification is not performed. That is, if the total number of the types of materials exceeds the number of materials that can be set for one vertex, simplification is not performed. Therefore, even when the number of vertices is reduced through simplification, the simplification does not cause missing of information on the materials set for the vertices, thereby maintaining the information on the materials.

In the exemplary embodiment, a material of the vertex after the simplification is determined based on the materials of the vertices before the simplification. Specifically, the game system 1 sets the one or two types of materials set on the vertices before the simplification, as the first material and the second material of the vertex after the simplification. This allows the information on the materials to be maintained. The ratio of the materials after the simplification is determined based on the ratio of the materials of the vertices before the simplification. In the exemplary embodiment, the radio of the materials after the simplification is calculated similarly to the aforementioned method for calculating the ratio of materials of vertices by using the evaluation values. That is, the game system 1 calculates weight values based on the distances between the vertex after the simplification and the vertices before the simplification, and calculates an evaluation value for each material, based on the weight values and the densities of the materials of the vertices before the simplification (the evaluation values of the materials described in the above [2-4. Determination of material of vertex] can be used as the densities of the materials here). Then, the ratio of the materials is calculated based on the calculated evaluation values of the materials.

### 2-6. Generation of Mesh

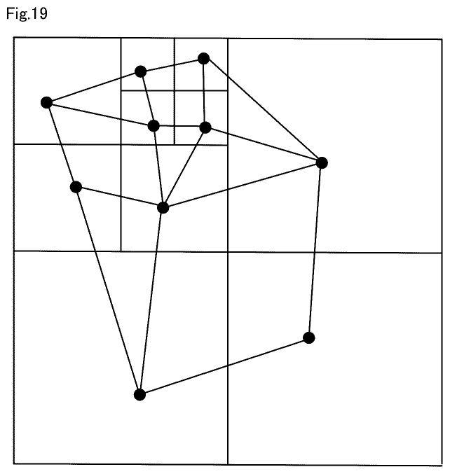

In the exemplary embodiment, a mesh of a voxel object is generated based on vertices having been simplified as described above. FIG. 19 shows an example of a mesh generated based on such vertices. Each of squares shown in FIG. 19 represents a vertex division region as described above, or a vertex division region obtained by integrating a plurality of vertex division regions through simplification. As shown in FIG. 19, the game system 1 generates a mesh that is composed of polygonal shapes each having, as one side, a straight line connecting vertices of adjacent vertex division regions. Each of the polygonal shapes forming the mesh is a triangle or a quadrangle.

In the exemplary embodiment, the game system 1 generates two types of meshes, a display mesh and a determination mesh. The display mesh is a mesh used for displaying a voxel object. The determination mesh is a mesh used for collision determination for a voxel object. As will be described in detail below, by using the two types of meshes, the game system 1 can perform processing with the meshes suitable for display of the voxel object and collision determination, respectively.

In the exemplary embodiment, the game system 1 generates the display mesh and the determination mesh, based on data of the SVO described above (e.g., based on the simplified vertices). Thus, sharing vertex data in generating the two types of meshes improves efficiency of processing. In other embodiments, the game system 1 may not necessarily perform simplification of vertices, and may generate a display mesh and/or a determination mesh, based on vertices that are not simplified.

In the exemplary embodiment, the game system 1 generates the determination mesh so as to be simpler in shape than the display mesh. Specifically, the game system 1 makes the number of vertices of the determination mesh less than the number of vertices of the display mesh. Here, in the exemplary embodiment, the data of the SVO holds, in an octree data structure, data of vertices before simplification and data of simplified vertices, and also includes data used for determining whether or not simplification can be performed. This data includes, for example, data of vertices (referred to as “provisional vertices”) calculated as candidates for a vertex after simplification, and data of the aforementioned index indicating an error between the vertices before simplification and the provisional vertices. For example, the game system 1 may use, among the provisional vertices, a vertex the index of which is equal to or less than a predetermined threshold value (this threshold value is greater than the aforementioned allowable value), for generation of the determination mesh. This allows the number of vertices of the determination mesh to be less than the number of vertices of the display mesh. The number of vertices of the determination mesh being less than the number of vertices of the display mesh allows a reduction in processing load for collision determination. Moreover, since the number of vertices of the display mesh is not excessively reduced, the appearance of the voxel object can be represented in detail.

In other embodiments, the display mesh and the determination mesh may be generated based on the same data, or may be generated based on different data. The display mesh and the determination mesh may have the same shape (even in this case, materials set for these meshes may be different from each other). The number of vertices of the determination mesh may be equal to the number of vertices of the display mesh, or may be greater than the number of vertices of the display mesh.

### 2-6-1. Determination of Material of Display Mesh

Next, an example of a method for determining materials and an appearance of a display mesh will be described. In the exemplary embodiment, the game system 1 determines a material for each of the polygonal shapes forming the display mesh. As will be described in detail below, in the exemplary embodiment, a polygon corresponding to each polygonal shape is rendered using at most two types of textures corresponding to at most two types of materials. Therefore, the game system 1 determines materials for the polygonal shapes forming the mesh such that two or less types of materials are finally set for one polygonal shape. In other embodiments, three or more materials may be set. For example, in an embodiment in which three or more types of voxel materials and three or more types of vertex materials are set, the same number of materials may be set for the polygonal shapes.

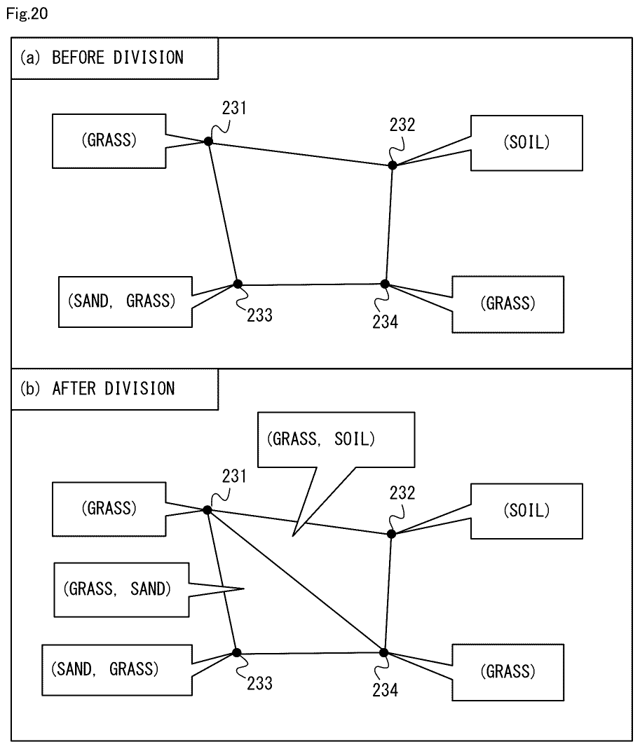

In the exemplary embodiment, quadrangles may be formed as polygonal shapes forming the display mesh (see FIG. 19). In determining materials of the display mesh, the game system 1 firstly divides each of the quadrangles forming the display mesh into two triangles under certain conditions. Hereinafter, a process of dividing a quadrangle into two triangles will be described with reference to FIG. 20.

FIG. 20 shows an example of diving a quadrangle forming a mesh into two triangles. In FIG. 20, (a) shows a quadrangle before division, formed by vertices 231 to 234 included in the vertices of the mesh. In FIG. 20, (b) shows two triangles into which the quadrangle is divided. In the example shown in FIG. 20, “grass”, “soil”, “sand and grass”, and “grass” are set as materials of the respective vertices 231 to 234.

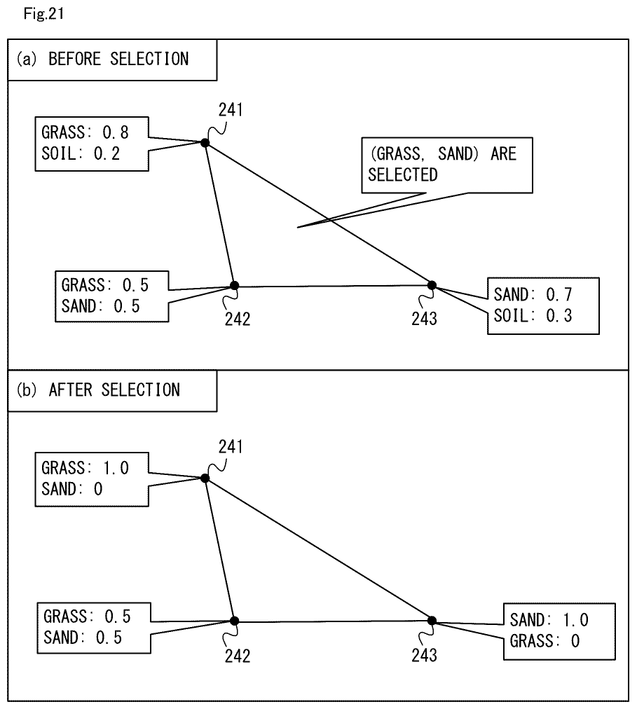

In the exemplary embodiment, if the number of types of materials set for the vertices of the quadrangle is three or more in total, the game system 1 determines whether or not a division condition is satisfied. In the exemplary embodiment, the division condition is that dividing the quadrangle into two triangles allows the number of types of materials set for the vertices of each triangle to be two or less in total. If the division condition is satisfied, the game system 1 divides the quadrangle into two triangles each having two or less types of materials set for the vertices. In the example shown in FIG. 21, three types of example materials, grass, soil, and sand, are set for the vertices 231 to 234 forming the quadrangle. If the quadrangle is divided into a triangle formed by the vertices 231, 232, 234 and a triangle formed by the vertices 231, 233, 234, two types of materials, sand and grass, are set for the vertices of the former triangle, and two types of materials, grass and soil, are set for the vertices of the latter triangle (see (b) of FIG. 20). Since the division condition is satisfied for the quadrangle, the game system 1 divides the quadrangle into two triangles.

Since there are two methods for dividing a quadrangle into two triangles, if the division condition is satisfied for the triangles into which the quadrangle is divided by at least one of the two methods, the game system 1 performs the division by the method satisfying the division condition. Meanwhile, if the division condition is not satisfied for the triangles into which the quadrangle is divided by either of the two methods, the game system 1 performs the division by either method.

By performing the division as described above, the game system 1 can generate two triangles each having two or less types of materials set for the vertices, without missing information on three or more types of materials set for the vertices of the quadrangle as much as possible. Here, as described above, each of the polygons forming the mesh is rendered using at most two types of textures. Therefore, by performing the division, the game system 1 can render each polygon by using two types of textures without missing information on the materials set for the vertices as much as possible.

In the exemplary embodiment, the game system 1 sets polygons corresponding to the polygonal shapes obtained through the aforementioned division. That is, the vertices of the polygonal shapes obtained through the division become the vertices of the polygons of the display mesh.

In the exemplary embodiment, as for the polygons forming the display mesh, if the number of types of materials set for the vertices of one polygon is three or more in total, the game system 1 selects two types of materials to determine materials of this polygon. FIG. 21 shows an example of a method for determining materials of a polygon forming the display mesh. In the example shown in FIG. 21, as for a vertex 241 of a triangular polygon forming the display mesh, the first material is “grass”, the second material is “soil”, and the material ratio of the first material to the second material is 0.8:0.2. As for a vertex 242 of the polygon, the first material is “grass”, the second material is “sand”, and the material ratio of the first material to the second material is 0.5:0.5. As for a vertex 243 of the polygon, the first material is “sand”, the second material is “soil”, and the material ratio of the first material to the second material is 0.7:0.3.

If the number of types of materials set for the vertices of the polygon is three or more in total, the game system 1 calculates a determination value for each material. The determination value is calculated as a sum of the proportions of the material at the vertices on which the material is set. Then, the game system 1 selects two materials in order from one having the greatest determination value, as materials of the polygon. In the example shown in FIG. 21, the determination value of the grass material is 0.8+0.5=1.3, the determination value of the sand material is 0.5+0.7=1.2, and the determination value of the soil material is 0.2+0.3=0.5. Therefore, the grass material and the sand material are selected as materials of the polygon shown in FIG. 21 (see (a) of FIG. 21).

The specific method for selecting a material of a polygon of the display mesh is discretionary. In other embodiments, a material of a polygon of the display mesh may be selected by any method based on information set for the vertices of the polygon. For example, a material of a polygon of the display mesh may be selected as follows. That is, a material having the greatest proportion at one vertex is specified for each vertex, and a material that is most frequently specified for each vertex is selected as a material of the polygon.

In the exemplary embodiment, the selected materials of the polygon are indicated as materials set for the vertices of the polygon. That is, when the materials of the polygon have been selected, the game system 1 changes the materials being set for the vertices of the polygon (e.g., the material IDs included in the vertex data) to the selected materials. In the example shown in FIG. 21, as for the vertex 241 and the vertex 243, “grass and soil” and “sand and soil” are respectively set before the selection of materials of the polygon (see (a) of FIG. 21). When grass and sand have been selected as materials of the polygon as described above, the materials set for the vertex 241 and the vertex 243 are changed to “grass and sand” (see (b) of FIG. 21). Since the materials set for the vertex 242 before the selection are the same as the selected materials of the polygon, the materials are not changed. In the case where two types of materials are selected as materials of the polygon as described above, information on the third and subsequent types of materials set for the vertices of the polygon are deleted.

According to the change of the materials set for each vertex, the game system 1 changes the ratio of the materials set for the vertex. For example, as for the vertex 241, the content indicating that the first material is grass and the second material is soil is changed to the content indicating that the first material is grass and the second material is sand. Here, since the proportion of the sand material is 0, the material ratio of the first material to the second material becomes 1:0. Thus, the above change is formally changing the materials of the vertices of the polygon in order to represent the materials of the polygon by the materials of the vertices of the polygon.

According to the above, since the materials set for the vertices of one polygon are only the materials corresponding to the textures used for rendering described below, a rendering process using the textures can be easily performed.

There may be a case where the aforementioned change causes all the materials at a certain vertex to be changed (e.g., none of the materials after the change correspond to the materials before the change). For example, there is a case where the material set for the vertex before the change is soil, and the materials selected as materials of the polygon are grass and sand. In this case, the ratio of the materials at the certain vertex may be set based on the material ratios at the other vertices of the polygon. For example, in the above example, in the case where the first material set for one of the remaining two vertices of a triangular polygon is grass and the material ratio of grass to sand is 1:0 while the material set for the other vertex is sand and the material ratio of sand to grass is 1:0, the material ratio at the certain vertex may be set to grass:sand=0.5:0.5. The game system 1 may determine the material ratio at the certain vertex in consideration of the distance between this vertex and the other vertex (e.g., based on a weight value that increases as the distance is shorter).

As described above, in the exemplary embodiment, the game system 1 selects, for each polygon, at most a predetermined number of (two in this embodiment) material IDs from among the material IDs set for the vertices included in the polygon (e.g., material IDs set for the vertices of the polygonal shape corresponding to the polygon), and determines the selected material IDs as material IDs of the polygon. Thus, the game system 1 can perform the rendering process with the number of textures to be used being reduced, while incorporating (e.g., reflecting) the materials set for the vertices into the appearance of the polygon.

In the exemplary embodiment, regarding the materials of all the vertices forming a polygon, if the number of the materials is equal to or less than the predetermined number, the game system 1 determines the materials as materials of the polygon. Meanwhile, if the number of the materials exceeds the predetermined number, the game system 1 selects a predetermined number of materials having higher priorities, based on the priority parameters of the vertices (specifically, based on the determination values calculated based on the aforementioned evaluation values), and determines the selected materials as materials of the polygon. Thus, even if the number of the materials set for the vertices exceeds, in total, the predetermined number, the number of the materials of the polygon can be made equal to or less than the predetermined number in consideration of the priority.

As described above, in the exemplary embodiment, the first and second materials set for each of the vertices of one polygon are changed to the two types of materials to be set for the polygon. In performing such a change, as for a vertex shared by adjacent two polygons, there is a possibility of inconsistency in the first and second materials to be set.

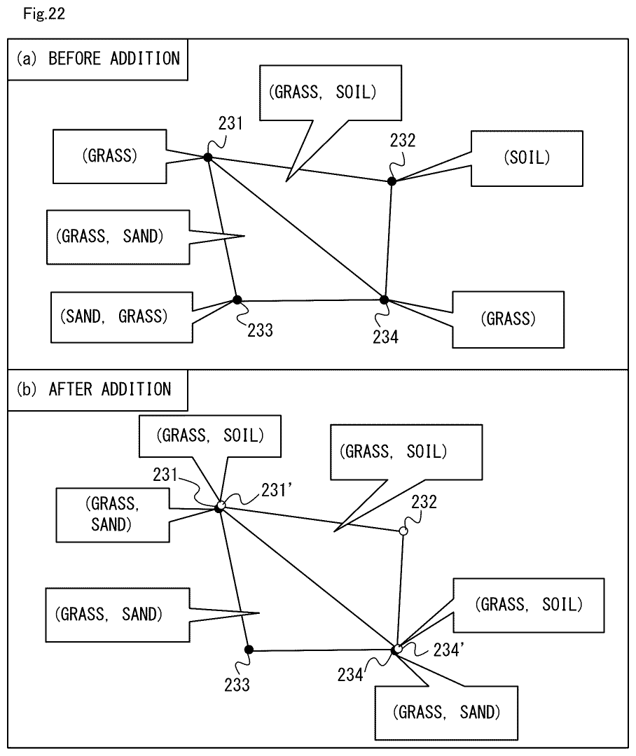

FIG. 22 shows an example of materials set for vertices of adjacent two polygons. FIG. 22 shows a state in which two polygons are formed by the vertices 231 to 234 shown in FIG. 20 ((b) of FIG. 20). In the example shown in FIG. 22, since grass and sand are determined as materials of a first polygon formed by the vertices 231, 233, and 234, the first and second materials of these vertices should be set to grass and sand, respectively. Meanwhile, since grass and soil are determined as materials of a second polygon formed by the vertices 231, 232, and 234, the first and second materials of these vertices should be set to grass and soil, respectively. Therefore, in the example shown in FIG. 22, as for the vertices 231 and 234 shared by the two polygons, inconsistency occurs in the materials to be set.

In the exemplary embodiment, when inconsistency occurs in material to be set for a vertex shared by two polygons, the game system 1 adds another vertex at the position of the vertex. In FIG. 22, (b) shows an example of a state in which a vertex 231′ is added for the vertex 231 and a vertex 234′ is added for the vertex 234. In the example shown in FIG. 22, the game system 1 sets, for the vertices 231 and 234, grass and sand as the first and second materials according to the materials of the first polygon. In addition, the game system 1 sets, for the vertices 231′ and 234′, grass and soil as the first and second materials according to the materials of the second polygon. By formally setting two vertices as vertices to be shared by two polygons (e.g., by generating data of two vertices located at the same position and having different materials), it is possible to inhibit occurrence of inconsistency in materials to be set for the vertices.

The game system 1 generates a display mesh composed of the polygons whose vertices and materials are determined as described above. In addition, the game system 1 renders the polygons, based on information on the materials set for the vertices (e.g., the first material and the second material), thereby rendering a voxel object.

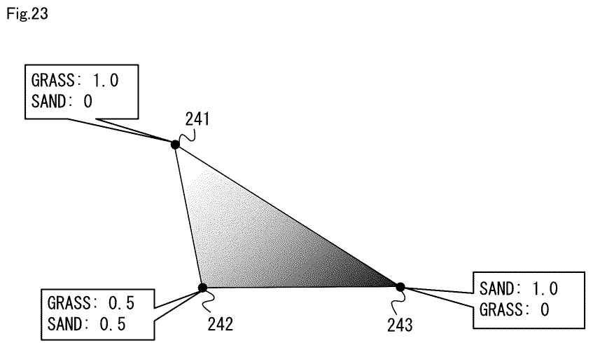

FIG. 23 shows an example of applying a texture to a polygon. FIG. 23 shows a triangular polygon formed by the vertices 241 to 243 shown in FIG. 21. The materials set for the vertices 241 to 243 are those shown in (b) of FIG. 21.

As for the position of a vertex of a polygon, rendering is performed by a mapping in which a texture of a first material set for the vertex and a texture of a second material set for the vertex are blended at a ratio of the materials set for the vertex (e.g., using this ratio as a blending ratio). The textures of the first and second materials used for the rendering are textures indicated by information on rendering setting associated with the material ID that is associated with data of the vertex in the aforementioned material data (see FIG. 12). In the example shown in FIG. 23, as for the position of the vertex 241, since the material ratio of grass to sand is 1:0, rendering is performed by using only the texture of grass. As for the position of the vertex 243, since the first material is sand and the material ratio of sand to grass is 1:0, rendering is performed by using only the texture of sand. As for the position of the vertex 242, since the first material is grass, the second material is sand, and the material ratio of grass to sand is 0.5:0.5, rendering is performed such that the texture of grass and the texture of sand are blended at a blending ratio of 0.5:0.5.

As for positions other than the vertices of the polygon, the game system 1 determines a blending ratio by interpolating the blending ratios at the vertices. Then, rendering is performed by a mapping in which the textures of two materials set for each vertex are blended at the interpolated blending ratio. The specific method for interpolation is discretionary. As an example, a blending ratio between vertices is subjected to linear interpolation. In FIG. 23, a position at which the texture of grass material is applied at a high ratio is shown in white, and a position at which the texture of sand material is applied at a high ratio is shown in black. In the example shown in FIG. 23, the texture of grass is applied to the vertex 241, and the blending ratio of the texture of sand increases toward the vertex 243. At the position of the vertex 242, the blending ratio of grass to sand becomes 1:1, and only the texture of sand is applied at the position of the vertex 243. Thus, rendering is performed with the two textures set for the polygon (e.g., set for the vertices of the polygon) being blended with the blending ratio according to the material ratio, whereby the appearance at the boundary between different materials can be made natural in the display mesh. This makes the appearance of the display mesh, in which a plurality of types of materials are set, natural.

### 2-6-2. Determination of Material of Determination Mesh

Next, an example of a method for determining materials of a determination mesh will be described. As will be described in detail below, in the exemplary embodiment, there may be a case where collision determination is performed for a voxel object by using a determination mesh, and processing is performed according to a material of a voxel object for which a collision has been determined. Therefore, in the exemplary embodiment, materials are determined also for the determination mesh.

In the exemplary embodiment, the game system 1 sets polygons corresponding to the polygonal shapes forming the determination mesh such that one type of material is set for one polygon. Specifically, the game system 1 determines a material to be set for a polygon of the determination mesh, based on information on materials set for vertices of this polygon (e.g., information on first and second materials, and a material ratio).

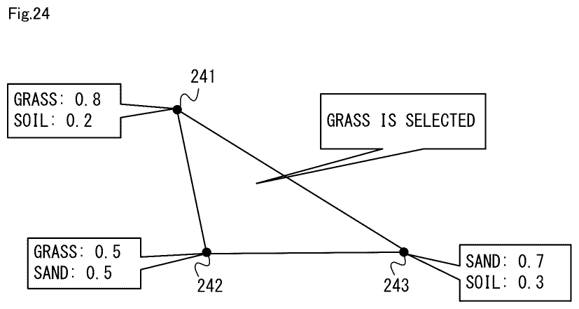

FIG. 24 shows an example of a method for determining a material of a polygon forming the determination mesh. FIG. 24 shows an example of determining a material for a triangular polygon formed by the vertices 241 to 243 shown in FIG. 21. The materials set for the vertices 241 to 243 are those shown in (a) of FIG. 21.

In determining a material of a polygon, the game system 1 calculates a determination value for each of materials set for the vertices of the polygon. In the exemplary embodiment, a calculation method for the determination value is identical to the calculation method for the determination value that is used for selection of the materials to be set for the polygonal shapes of the display mesh. The specific calculation method for the determination value is discretionary. In other embodiments, the determination value may be calculated in any method based on information set for the vertices of the polygon of the determination mesh.

In the example shown in FIG. 24, the determination value for each material is 1.3 for the grass material, 1.2 for the sand material, and 0.5 for the soil material as in the case shown in FIG. 21. Therefore, the grass material is selected as a material of the polygon shown in FIG. 24.

As described above, in the exemplary embodiment, the game system 1 selects, for each polygon, at most a predetermined number of (one in this embodiment) material IDs from among the material IDs set for the vertices included in the polygon (e.g., material IDs set for the vertices of the polygonal shape corresponding to the polygon), and determines the selected material ID as a material ID of the polygon. This allows the game system 1 to reduce the number of materials to be set for the determination mesh to the predetermined number or less. Thus, processing based on the material type, which is performed according to the result of collision determination using the determination mesh, is prevented from being complicated. The method for determining a material of a polygon of the determination mesh is discretionary, and is not limited to the above method. In other embodiments, a material of a polygon of the determination mesh may be determined by any method based on information set for the vertices of the polygon.

In the exemplary embodiment, one type of material is set for a polygon of the determination mesh while at most two types of materials are set for a polygon of the display mesh. Therefore, natural appearance can be achieved for the polygon of the display mesh by using two types of textures. In addition, as for the determination mesh, a process to be performed according to the result of collision determination using the determination mesh can be prevented from being complicated. In other embodiments, the types of materials settable for polygons of the display mesh and the determination mesh are discretionary. The number of materials settable for a polygon of the display mesh and the number of materials settable for a polygon of the determination mesh each may be plural, and may be the same or different from each other.

In the exemplary embodiment, the number of types of materials to be set for one voxel is two at most, and the number of types of materials to be set for one polygon in the display mesh is two at most. Thus, information on materials set in the voxel data can be used for (e.g., reflected in) the materials of the display mesh while reducing the data amount of the voxel data. Moreover, in the exemplary embodiment, the number of types of materials to be set for vertices based on the voxel data is also two at most (see FIG. 16). In this case, since two types of materials can be set also for vertices that are generated during the process to obtain the display mesh from the voxel data, the information on materials set in the voxel data used for (e.g., reflected in) the display mesh, without missing the information on materials during the process.

In other embodiments, the game system 1 may set materials such that, regarding vertices to be set based on the voxel data, materials set for vertices to be used for generation of the display mesh are different from materials set for vertices to be used for generation of the determination mesh. For example, the game system 1 may set at most two types of materials as described above for the vertices to be used for generation of the display mesh, and may set one type of material for the vertices to be used for generation of the determination mesh. Then, the game system 1 may set two types of materials as materials of a polygon of the display mesh, and may set one type of material as a material of a polygon of the determination mesh, based on one type of material that is set for each vertex of this polygon. In setting one type of material for the vertices to be used for generation of the determination mesh, a material having the greatest determination value, among the determination values calculated for each material, may be set as a material of the vertices. Also in this case, as in the exemplary embodiment, the number of types of materials to be set for one polygon in the display mesh may be two at most, and the number of types of materials to be set for one polygon in the determination mesh may be one. Therefore, the information on materials set in the voxel data can be used for (e.g., reflected in) the display mesh, and the process to be performed according to the result of collision determination using the determination mesh is prevented from being complicated.

As described above, in the exemplary embodiment, a display mesh and a determination mesh are set for one voxel object. However, depending on the game situation, both the display mesh and the determination mesh may not necessarily be set for one voxel object at the same time (e.g., both the meshes may not necessarily be set in processing one frame). For example, in the game space, the determination mesh may be generated in a range where collision determination is performed, and may not necessarily be generated in a range where collision determination is not performed. As an example, the game system 1 may generate the determination mesh for voxel objects within a predetermined range around the player character. For voxel objects outside the predetermined range, the game system 1 may generate only the display mesh without generating the determination mesh.

As for the display mesh, the game system 1 may store data regarding the generated mesh in a memory. In frames after generation of the mesh, the game system 1 may use the stored data without executing the mesh generating process again, except for a range where an update is performed. This can decrease the processing load for generating the display mesh. Meanwhile, as for the determination mesh, the game system 1 may not necessarily store data regarding the generated mesh in the memory, and may generate a mesh on an as-needed basis (e.g., each time collision determination is required). This saves memory use for generation of the mesh.

The method for, when voxel data has been changed from its initial state, generating meshes (e.g., a display mesh and a determination mesh) based on the changed voxel data, has been described above. This method can also be used for a case where the meshes are generated based on the voxel data in the initial state when a game is started, for example. However, the meshes based on the voxel data in the initial state may not necessarily be generated based on the voxel data in the initial state when the game is started, and may be prepared in advance of starting the game.

### 2-7. Processing Using Mesh

Next, an example of processing using a mesh generated for a voxel object as described above will be described. Hereinafter, a description will be given of a case where a terrain object such as the ground or a wall is a voxel object, a player character performs an action, and an in-game behavior is generated as a result of collision determination.

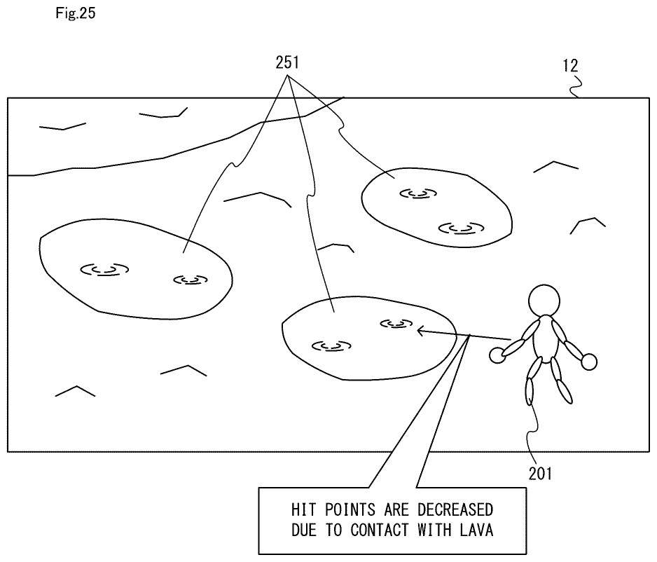

FIG. 25 shows an example of a game image representing a state in which a player character moves on a terrain object. In the example shown in FIG. 25, a material of polygons in partial regions 251 in a determination mesh of the terrain object being the ground is set to “lava”. Meanwhile, a material of polygons other than those in the regions 251 in the determination mesh of the terrain object is set to “rock”. In the example shown in FIG. 25, the game system 1 performs collision determination between the terrain object and the player character 201 by using the determination mesh. That is, the game system 1 performs collision determination as to whether or not the determination mesh of the terrain object comes into contact with a determination region set for the player character (e.g., a region having a predetermined shape that is set based on the position of the player character). When a collision between the polygon whose material is lava and the player character 201 has been determined, a process of reducing the hit points of the player character 201 is performed as a process of generating an in-game behavior. Moreover, in the above case, a process of causing the player character 201 to perform a predetermined reaction is performed.

In the exemplary embodiment, regarding the lava material, a property of reducing the hit points of the player character that has come into contact with the material (e.g., a property of having a temperature equal to or higher than a predetermined value) is set as property information included in the aforementioned material data. The game system 1 generates an in-game behavior (in the above example, reduction in the hit points of the player character) based on the property information corresponding to the material set for the polygon in the determination mesh for which a collision has been determined through the collision determination.

When a collision between a polygon whose material is rock and the player character 201 has been determined, the process of reducing the hit points of the player character is not performed. Based on the collision, the player character 201 is controlled so as not to be able to enter the polygon. Therefore, the player character can stand and walk on the polygon. Thus, in the exemplary embodiment, by setting a material for each polygon, the game system 1 can perform different processes depending on which part of the voxel object another object has come into contact with. In addition, the content of a process to be performed can be matched to the type of the material. In the exemplary embodiment, the player character can change the terrain object (e.g., deform the terrain object, or change the material of the terrain object), and therefore, for example, can delete the lava part of the terrain object, or change the lava to another material. Therefore, by changing the terrain object, the player can avoid a reduction in the hit points of the player character due to contact with the lava.

The content of the process to be performed when a collision between the voxel object and another object has been determined, is discretionary. For example, if the other object is a moving object such as the player character or an enemy character, the process may be a process of outputting the sound of footsteps of the object, or displaying an effect (e.g., effect of representing dust or splash of water) on the contact part. In this case, the game system 1 can change the sound of footsteps or the effect according to the type of the material set for the polygon, in the contact part, of the voxel object.

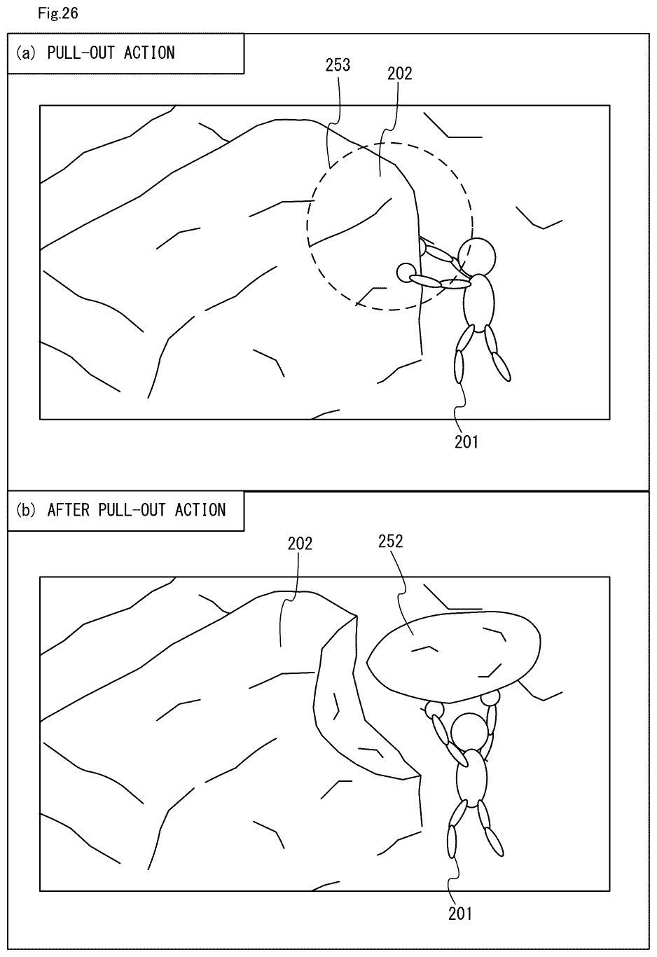

FIG. 26 shows an example of a game image representing a state in which the player character pulls out a fragment object from the terrain object. As shown in FIG. 26, in the exemplary embodiment, the player, through a predetermined operation input, can cause the player character 201 to perform an action of holding the terrain object 202, pulling out a part of the terrain object 202 as a fragment object 252, and grasping the fragment object 252 (hereinafter referred to as “pull-out action”). The game system 1 deletes the part of the terrain object 202 and generates the fragment object 252 as an in-game behavior caused by the pull-out action.

In performing the pull-out action, specifically, the game system 1 executes the following process. That is, when an operation input that causes the player character to perform the pull-out action has been performed by the player, the game system 1 causes the player character to perform an action of digging forward and holding, and performs collision determination. Then, when a collision between the player character performing the pull-out action and the terrain object has been determined, the game system 1 generates an update range 253 based on the position and direction of the player character. For example, the update range 253 is generated in a predetermined direction (e.g., forward) with reference to the player character. The shape and size of the update range may be determined in advance according to the type of the action of the player character. Furthermore, the game system 1 decreases the densities of voxels corresponding to the update range 253. Then, update of the mesh according to the decrease in densities of the voxels causes the terrain object 202 to be deformed such that the part inside the update range 253 is deleted (see (b) of FIG. 26). In the exemplary embodiment, the densities of the voxels corresponding to the update range 253 are decreased. However, voxels whose densities are to be decreased may be at least part of the voxels corresponding to the update range 253.

In the exemplary embodiment, the voxel object corresponding to the update range 253 is unconditionally deformed due to the pull-out action. In other embodiments, the voxel object corresponding to the update range 253 may be deformed on the condition of the amount of damage set for the voxels. For example, instead of unconditionally deforming the voxel object corresponding to the update range 253, the game system 1 may increase the amount of damage set for the voxels corresponding to the update range 253, and decrease the densities of the voxels in response to the amount of damage having exceeded a predetermined value. In this case, the amount of increase in the damage may be determined according to the action performed to the voxel object.

The game system 1 generates the fragment object 252 representing the deleted part of the terrain object 202. That is, based on the pull-out action, the game system 1 generates the fragment object 252 in the state of being held by the player character. The fragment object 252 may be generated so as to have a shape corresponding to the deleted part of the terrain object 202, or a predetermined shape. The fragment object 252 may or may not be a voxel object. When the fragment object is a voxel object, a voxel space different from the voxel space of the voxels corresponding to the terrain object 202 or the like is defined for the fragment object 252.

The game system 1 determines a material of the fragment object 252. The material of the fragment object 252 is determined based on materials set for polygons in a determination mesh that comes into contact with the update range 253 among determination meshes of the terrain object 202. The material of the fragment object 252 is determined to be the same as at least one of the materials set for the polygons in the determination mesh that comes into contact with the update range 253. Thus, the material of the fragment object 252 can be made identical to the material of the deleted part of the terrain object. As is apparent from the above description, the fragment object 252 is actually not a part of the terrain object. However, since the fragment object 252 is generated simultaneously with deletion of a part of the terrain object and takes over the material of the deleted part of the terrain object, an impression that the player character 201 takes out a part of the terrain object 202 by a pull-out action can be given to the player.

In the exemplary embodiment, priorities are set for the types of materials prepared, and the game system 1 determines, as a material of the fragment object 252, a material having the highest priority among the materials set for the polygons of the determination mesh in the update range 253. Here, for example, a case where the determination mesh in the update range 253 includes a polygon whose material is rock and a polygon whose material is lava, is considered. In this case, if the material of the fragment object 252 is set to lava, there is a possibility of inconvenience that the hit points of the player character are reduced because the player character holds the fragment object 252 through the pull-out action (as described with reference to FIG. 25, the lava material has the property of reducing the hit points of the player character if the player character comes into contact with it). Furthermore, as described above, if the determination mesh in the update range 253 includes polygons for which different types of materials are set, it is difficult for the player to predict a material of the fragment object 252, and the above inconvenience may occur against the player's will. Meanwhile, in the exemplary embodiment, since the priorities are given to the materials to be set as a material of the fragment object, the risk of the above inconvenience can be reduced.

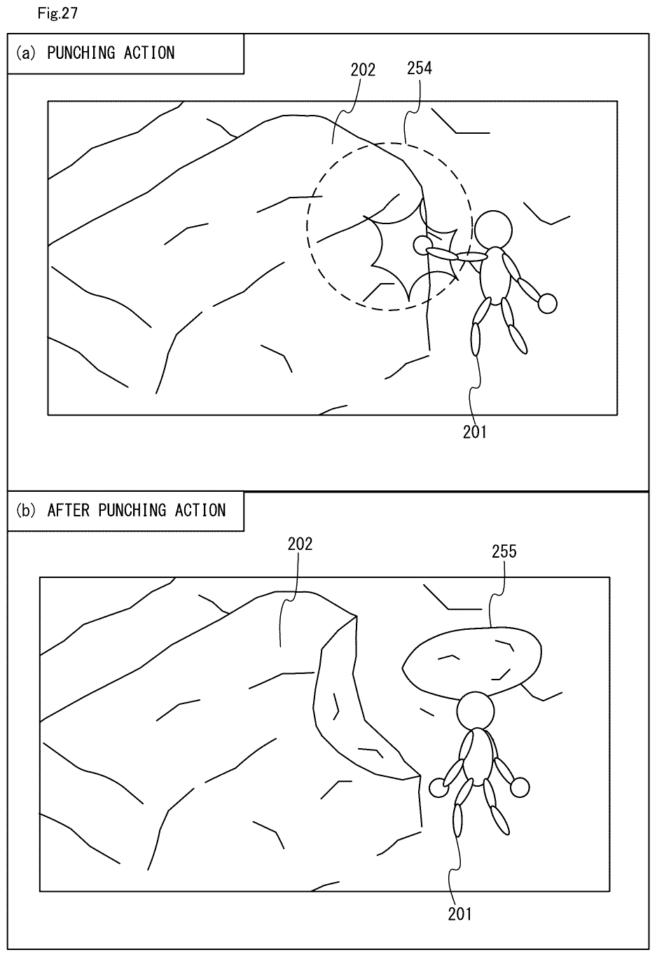

FIG. 27 shows an example of a game image representing a state in which a fragment object is generated because the player character has destroyed the terrain object. As shown in FIG. 27, in the exemplary embodiment, the player, through a predetermined operation input, can cause the player character 201 to perform a punching action. As in the case of the aforementioned pull-out action, the game system 1 deletes a part of the terrain object 202 and generates a fragment object 255, as an in-game behavior caused by the punching action. Specifically, the game system 1 deforms the terrain object 202 such that a part of the terrain object 202 is deleted. In the case of the punching action, unlike the aforementioned pull-out action, the fragment object 255 is not held by the player character 201 but is disposed near the position where the punching action has been performed (see (b) of FIG. 27). Such a fragment according to destruction of the terrain object 202 may not necessarily be generated.

In performing the punching action, specifically, the game system 1 executes the following process. That is, when an operation input to cause the player character to perform the punching action has been performed by the player, the game system 1 causes the player character to perform an action of punching forward, and performs collision determination. Then, when a collision between the player character performing the punching action and the terrain object has been determined, the game system 1 generates an update range 254 based on the position and direction of the player character. For example, the update range 254 is generated in a predetermined direction (e.g., forward) with reference to the player character. The position, shape, and size of the update range 254 due to the punching action may be the same as or different from those of the update range 253 due to the pull-out action. Then, the game system 1 decreases the densities of voxels corresponding to the update range 254. Thus, the terrain object 202 is deformed such that the part inside the update range 254 is deleted by the punching action, similarly to the pull-out action (see (b) of FIG. 27). In the case of the punching action, as in the case of the pull-out action, instead of unconditionally deforming the voxel object corresponding to the update range 254, the game system 1 may increase the amount of damage set for the voxels in the update range 254 according to the punching action, and decrease the densities of the voxels in response to the amount of damage having exceeded a predetermined value. In addition, the voxels whose densities are to be decreased by the punching action may be at least part of the voxels corresponding to the update range 254.

The game system 1 generates a fragment object 255 corresponding to the deleted part of the terrain object 202. That is, based on the punching action, the game system 1 generates the fragment object 255 in the state of not being held by the player character (e.g., in the state of being disposed near the position where the punching action has been performed). The fragment object 255 may be generated so as to have a shape corresponding to the deleted part of the terrain object 202, or a predetermined shape. The fragment object 255 may or may not be a voxel object.

The game system 1 determines a material of the fragment object 255. The material of the fragment object 255 is determined based on materials set for polygons in a determination mesh that comes into contact with the update range 254 among the determination meshes in the terrain object 202. The material of the fragment object 255 is determined to be the same as at least one of the materials set for the polygons in the determination mesh that comes into contact with the update range 254. Thus, the material of the fragment object 255 can be made identical to the material of the deleted part of the terrain object. Since the fragment object 255 is generated simultaneously with deletion of a part of the terrain object and takes over the material of the deleted part of the terrain object, an impression that a part of the terrain object destroyed due to a punching action of the player character is generated as a fragment object can be given to the player.

In the exemplary embodiment, the material of the fragment object 255 is set to a material having the greatest degree of decrease in voxel density among the materials set for the polygons in the determination mesh that comes into contact with the update range 254. This allows generation of a fragment object in which the material composition of the part, of the terrain object, deleted due to the punching action is more accurately shown (e.g., reflected).

The method for determining a material of a fragment object to be generated due to the pull-out action or the punching action is discretionary. For example, the method for determining a material of a fragment object may be the same between the pull-out action and the punching action. Moreover, for example, among the materials set for the polygons of the determination mesh in the update range, a material that is set for the largest number of polygons may be determined as a material of the fragment object. Alternatively, for example, a material that is set for a polygon satisfying a predetermined condition (e.g., a polygon in a position that comes into contact with a hand of the player character performing the pull-out action or the punching action) among the polygons of the determination mesh in the update range, may be determined as a material of the fragment object. In other embodiments, a plurality of types of materials may be set for the fragment object.

In the exemplary embodiment, the player can cause the player character to perform an action of throwing the fragment object 252 or 255 generated as described above (hereinafter referred to as “throwing action”). The player, through a predetermined operation input, can cause the player character to perform an action of holding a fragment object that is generated according to the punching action and placed on the ground. The pull-out action or the action of holding the fragment object after the punching action causes the player character to be in the state of holding the fragment object. In this state, the game system 1 causes the player character to perform an action of throwing the fragment object in a predetermined direction, as the throwing action according to the operation input performed by the player.

FIG. 28 shows an example of a game image of a scene in which a throwing direction is determined while the player character takes a throwing posture, in the state where a throwing action by the player character is possible. As shown in FIG. 28, in the state where the player character 201 is holding a fragment object 261, the player character 201 can perform a throwing action. In this state, as shown in FIG. 28, the game system 1 displays an aim image 262 (e.g., a reticle) and an object information image 263 on the image showing the game space, as a process of generating an in-game behavior.

The aim image 262 indicates a direction (or aim direction) in which the fragment object is thrown due to the throwing action. That is, in response to an operation input performed by the player for the throwing action, the game system 1 moves the fragment object 261 from the position of the player character 201 toward a position, in the virtual space, indicated by the aim image 262. The aim direction is controlled based on an operation input performed by the player. For example, the game system 1 may change the aim direction in response to an operation input for changing the direction of a virtual camera. Specifically, the game system 1 may control the virtual camera according to the operation input such that the virtual camera rotates and moves around the player character while maintaining a state in which the player character is within a field-of-view range, and may control the aim direction to be a direction according to the field-of-view direction of the virtual camera. In this case, the aim image 262 pointing a position where a terrain object 202 intersects a straight line extending in the aim direction from the position of the player character, is displayed. Specifically, the game system 1 performs collision determination between the aim direction (e.g., the straight line extending in the aim direction) and the determination mesh of the terrain object 202, and displays the aim image 262 when a collision has been determined. The aim image 262 is arranged so as to point the position of a polygon, in the determination mesh, which intersects the straight line extending in the aim direction.

The aim image 262 allows the position at which the fragment object comes into contact with the voxel object due to the throwing action of the player character to be presented to the player. This allows the player to easily perform the operation for the throwing action. The specific control method for the aim direction and the aim image 262 is discretionary, and a conventional method may be used. For example, in other embodiments, in the state where the aim image 262 is displayed, the aim image 262 may be displayed in a game image in a first-person viewpoint in which the player character is not displayed.

In the state where the player character takes a posture to throw the fragment object, an action of throwing the fragment object to the aim direction is performed in response to a predetermined operation input performed by the player.

The object information image 263 indicates information regarding the terrain object 202 at the position pointed by the aim image 262. In the exemplary embodiment, the object information image 263 indicates the name of the material (“rock” in the example shown in FIG. 28) set for the polygon of the determination mesh at the position pointed by the aim image 262. Thus, the material of the voxel object with which the fragment object thrown by the throwing action comes into contact can be presented to the player. In addition, the object information image 263 indicates information regarding the property (here, hardness) of the material. Thus, the property of the voxel object with which the fragment object thrown by the throwing action comes into contact can be presented to the player. The object information image 263 may have any content. For example, in other embodiments, the object information image 263 may indicate any property regarding the material that is set for the polygon at the position pointed by the aim image 262, or may indicate the state of the polygon (e.g., the amount of damage described above). In the exemplary embodiment, since one type of material is set for the polygon of the determination mesh, the material corresponding to the aim position is specified to one material. This is suitable for displaying the information regarding the material.

In the exemplary embodiment, in response to the result of the collision determination indicating that the fragment object thrown by the throwing action has come into contact with the voxel object, the game system 1 adds a change to the voxel object as an in-game behavior. FIG. 29 shows an example of a game image after a change is added to the terrain object 202 because the fragment object 261 has come into contact with the terrain object 202 shown in FIG. 28. In the example shown in FIG. 29, the terrain object 202 is deformed such that the fragment object is attached to the contact position between the fragment object and the terrain object 202. Specifically, the game system 1 generates an update range that includes the contact position, and increases the densities of voxels in the update range to deform the terrain object 202 to the aforementioned shape. For example, the update range may be set to a shape corresponding to the shape of the fragment object, and the terrain object 202 may be deformed such that the update range is inside the terrain object 202. As described above, in the example shown in FIG. 29, an additional part 265 is added to the terrain object before deformation. In the example shown in FIG. 29, the fragment object is deleted in response to that it comes into contact with the terrain object 202.

A material of a polygon in the additional part 265 is determined based on the material of the fragment object that has come into contact with the terrain object 202. Specifically, the game system 1 sets the material of voxels in the update range to be the material of the fragment object. Then, materials of the display mesh and the determination mesh are determined based on the material of the voxels. In this case, since the appearance of the attached additional part 265 can be made identical to the appearance of the fragment object, an impression that the fragment object is attached to the terrain object 202 (although the terrain object 202 is deformed in actuality) can be more easily given to the player.

In the example shown in FIG. 29, the change added to the voxel object in response to contact of the fragment object with the voxel object is deformation to add the additional part to the voxel object. However, the change to be added to the voxel object is not limited thereto. The change may be a change in voxel density, or a change in material. For example, if the fragment object has a property of explosion, the fragment object may be exploded in response to contact with the voxel object, and in this case, the voxel object may be deformed as if a part of the voxel object is deleted. Specifically, the game system 1 sets an update range so as to include the contact position, and decreases the voxel density in the update range. In addition, for example, when the material of the voxel object is lava and the material of the fragment object is ice, the material of the voxel object may be changed in response to contact with the fragment object. Specifically, the game system 1 may set an update range including the contact position, and change the material being lava, among the materials of voxels in the update range, to obsidian or rock. This allows representation of a state in which the object of lava is cooled by the object of ice and turns into obsidian or rock.

The content of the change may be determined based on the material of the voxel object, the material of the fragment object, or a combination of the material of the voxel object and the material of the fragment object. This allows occurrence of various changes to the voxel object.

The game system 1 may determine whether or not to perform the above change, based on the material of the voxel object, the material of the fragment object, or a combination of the material of the voxel object and the material of the fragment object. For example, the game system 1 may perform the change as shown in FIG. 29 in the case where the fragment object whose material is rock comes into contact with the voxel object whose material is rock, and may not necessarily perform the change as shown in FIG. 29 when the fragment object whose material is rock comes into contact with the voxel object whose material is iron.

In the exemplary embodiment, one type of material is set for each of the polygons of the determination mesh and for the fragment object. If a plurality of types of materials are set for at least either the polygon of the determination mesh or the fragment object, it is difficult to determine the content of a change to be added to the voxel object according to the types of materials of the determination mesh and the fragment object when they come into contact with each other. Meanwhile, in the exemplary embodiment, since one type of material is set for each of the determination mesh and the fragment object that have been determined to be in contact with each other by the collision determination, it is easy to determine the content of a change to be added to the voxel object.

### 2-8. Example of Setting Voxel Object Based on Movement Path of Object

Next, an example of setting a voxel object (e.g., placing a new voxel object, or deforming a voxel object) based on a path of an object moving in a game space, will be described. In the first to fourth examples described below, when an event in which an object moves has occurred in a game, the game system 1 places a voxel object whose shape follows the path based on movement of the object. An object such as a player character can get on the voxel object, and move on the voxel object. Therefore, in the first to fourth examples, a new game in which various movement routes are generated in the game space by the voxel object, can be provided. In the following description, a voxel object placed along a path is referred to as “path object”, an event that triggers placement of a path object is referred to as “placement event”, and an object that moves in a placement event is referred to as “moving object”.

### 2-8-1. First Example

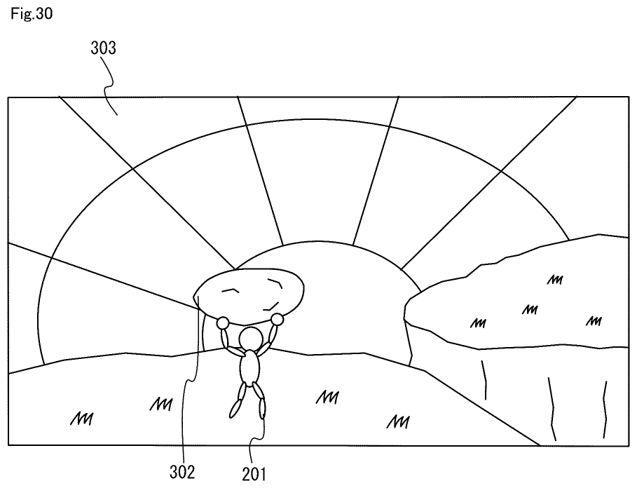

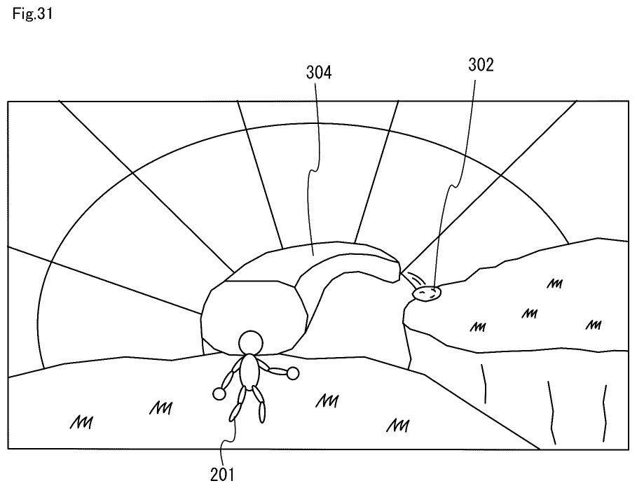

As the first example, an example in which a path object is placed in response to movement of a moving object in the game space due to a throwing action or the like performed by a player character, will be described. FIG. 30 is a view showing an example of a game image according to the first example. In the state shown in FIG. 30, a player character 201 is lifting a fragment object 302. FIG. 31 is a view showing an example of a game image in a state where the player character 201 has thrown the fragment object 302 by a throwing action from the state shown in FIG. 30. As shown in FIG. 30 and FIG. 31, in the first example, when the player character 201 has performed the action of throwing the fragment object 302, a path object 304 is placed along a movement path of the thrown fragment object 302. In the example shown in FIG. 31, as a result of the fragment object 302 moving along a parabolic trajectory, the path object 304 whose shape follows the parabolic path is placed. In the first example, as described with reference to FIG. 28, the direction in which the fragment object 302 is thrown by the player character 201 is controlled based on an operation input performed by the player.

In the first example, the moving object is not limited to the fragment object. For example, the moving object may be an object of any type that can be thrown by a throwing action of the player character. Specifically, in addition to the above fragment object, objects such as rock, three, and furniture placed in the game space may function as moving objects. The fragment object may be generated from any voxel object. The fragment object may be caused by a punching action or a pull-out action performed on a terrain object as shown in FIG. 27, or may be caused by a punching action or a pull-out action performed on a path object. In other embodiments, a fragment object generated from a specific type of voxel object may function as a moving object. The moving object may or may not be a voxel object.

In the first example, the placement event is an event in which a moving object moves under a predetermined condition. In the first example, the predetermined condition is that a moving object is moved by a predetermined action performed by an action-capable object. The action-capable object is, for example, an object capable of performing a predetermined action, such as a player character or an enemy character. In the first example, the predetermined action is a throwing action to throw a moving object. The action to throw a moving object is not limited to the throwing action, and may include other actions. For example, when a moving object moves as if it is blown away by a punching action or a gun shooting action performed by the player character or the like, it may be determined that the predetermined condition is satisfied.

In the first example, the predetermined condition may not necessarily be satisfied when a moving object moves. For example, the predetermined action may not include an action of placing a lifted moving object on the ground. In this case, for example, when the player character has performed an action of placing the fragment object on the ground, the predetermined condition is not satisfied and a placement event does not occur, and therefore, a path object is not placed. In other embodiments, the placement event may be an event in which a moving object moves under any condition. In this case, a placement event always occurs when a moving object moves, and a path object is placed.

As described above, in the first example, a path object is placed not only when the player character throws a moving object but also when an enemy character throws a moving object. However, in other embodiments, the predetermined condition may include a condition regarding the type of an object that performs an action. For example, the game system 1 may determine that a placement event has occurred, when a moving object moves due to a throwing action performed by the player character, and may determine that a placement event does not occur, when a moving object moves due to a throwing action performed by an enemy character.

In the first example, a path object is generated based at least on the condition that a moving object moves within an object generation area set in the game space. For example, in a placement event, when a moving object moves from inside to outside of the object generation area, or from outside to inside, the game system 1 places a path object inside the object generation area and does not place a path object outside the object generation area. In other embodiments, an object generation area may not necessarily be set in a part of the game space. The entirety of the game space may be an object generation area.

In the example shown in FIG. 30 and FIG. 31, the object generation area has a cylindrical shape, and the player character 201 is located within the object generation area. In the first example, the game image includes an image 303 indicating the boundary of the object generation area (see FIG. 30). In the example shown in FIG. 30 and FIG. 31, the image 303 shows parts of the side surface and one of the bottom surfaces of the cylinder that constitutes the object generation area. The image 303 may be, for example, semi-transparent, so that the view outside the object generation area is visible through the image 303. The image 303 allows the player to recognize the extent of the object generation area. In other embodiments, the image indicating the boundary of the object generation area need not be displayed.

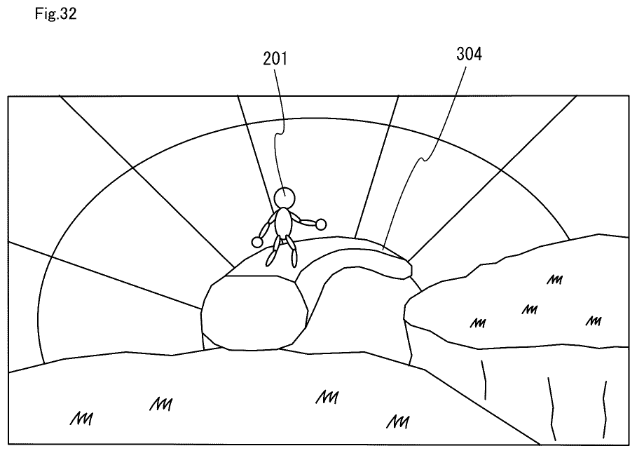

FIG. 32 is a view showing an example of a game image in a state where a player character moves on a path object. In the first example, as shown in FIG. 32, the player character 201 can move on the path object 304. For example, by placing the path object 304 in the game space, the player allows the player character 201 to move from its current foothold to another distant foothold. As described above, in the first example, by causing the player character 201 to perform an action that moves a moving object in the object generation area, the player can place a path object that provides a new movement route in the game space. Thus, the strategy and interest of the game can be improved. Furthermore, in the first example, in addition to an object that is placed in advance in the game space and becomes a moving object, a moving object can be generated through a punching action or a pull-out action described above. Thus, various methods for placing path objects can be provided to the player, thereby further improving the strategy of the game.

As will be described in detail below, in the first example, the path object 304 is formed so that its upper surface facing upward in the game space has no steps (see FIG. 32). This allows the player character 201 to easily move on the path object 304.

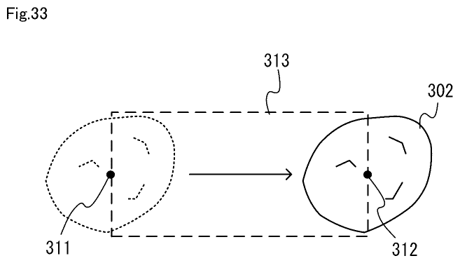

FIG. 33 is a view showing an example of a path object generation method according to the first example. In FIG. 33, a current position 312 is the position of the fragment object 302 as a moving object in the current frame. In addition, a previous position 311 is the position of the fragment object 302 one frame before the current frame. In FIG. 33, as an example, the center position of the fragment object 302 is used as the position of the fragment object 302.

When the moving object moves in the above placement event, the game system 1 sets a voxel update range 313 extending from the previous position 311 to the current position 312. For example, the voxel update range 313 has a shape obtained by rounding the edges and corners of a quadrangular prism with four side surfaces parallel to the direction from the previous position 311 to the current position 312. In addition, the voxel update range 313 is set so that the previous position 311 and the current position 312 are located inside or on its surface. In the first example, the game system 1 represents the voxel update range 313 by using the SDF described above. The voxel update range 313 may have any shape extending from the previous position to the current position, for example, a quadrangular prism shape as described above, or a cylindrical or capsule shape. Moreover, in the first example, the voxel update range 313 is set so that one of its side surfaces faces vertically upward in the game space. In this case, an upper surface of the path object is formed, which allows the player character 201 to easily move on the path object.

In the first example, the size of the voxel update range (e.g., the size of the bottom surface of the quadrangular prism) is set based on the type of the moving object. For example, the size of the voxel update range may be set according to the material set for the moving object. In other embodiments, the size of the voxel update range may be set independently of the type of the moving object, and for example, may be constant regardless of the type of the moving object. Moreover, for example, the size of the voxel update range may be set according to the size of the moving object.

As described above, the voxel update range is set to include the position through which the moving object passes. However, the voxel update range may not necessarily be set to include the entire area through which the moving object passes, or may be set to include an area through which the moving object does not pass.

The game system 1 updates (specifically, increases) the densities of voxels corresponding to the voxel update range 313 so that the voxel update range 313 set as described above becomes the internal region of the voxel object. For example, the densities of voxels corresponding to the voxel update range 313 are updated to a value (e.g., 255) not less than the reference value. The game system 1 generates a voxel mesh for the path object, based on the voxel data after the density update, according to the method described in the above [2-6. Generation of mesh]. Thus, the path object with the shape according to the voxel update range 313 is generated.

In the first example, the game system 1 sets the material of the voxels corresponding to the voxel update range 313 to a predetermined material. Thus, the material of the path object is set to the predetermined material. The predetermined material may be any material, and may be a material of a path described below.

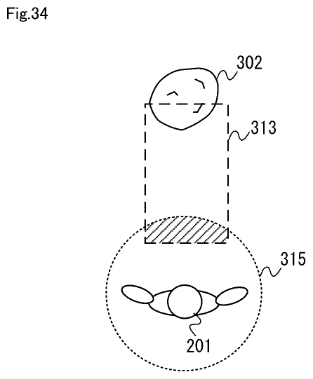

In the first example, the game system 1 sets a prohibited area based on the position of the player character 201. FIG. 34 is a view showing an example in which a part of the voxel update range overlaps with the prohibited area. FIG. 34 is a view of the game space as viewed from above, and shows a state in which a part of the voxel update range 313 overlaps with the prohibited area 315. As shown in FIG. 34, when at least a part of the voxel update range 313 is included in the prohibited area 315, the game system 1 updates the voxel update range so that the part (hatched part shown in FIG. 34), of the voxel update range 313, included in the prohibited area 315 is excluded. In the above case, based on the changed voxel update range, the voxel density is updated, and a voxel mesh for the path object is generated. As a result, a voxel mesh for the path object is not generated in the prohibited area 315. This reduces the risk of the player character 201 coming into contact with the path object. For example, this reduces the risk of unintended movement of the player character 201 that will occur if the player character 201 comes into contact with the generated path object. Moreover, for example, a certain distance is maintained between the player character 201 and the generated path object, which allows the player to easily recognize the positional relationship between the player character 201 and the path object.

In the first example, the prohibited area 315 is a spherical area having a radius of a predetermined length and centered on the position of the player character 201. However, the prohibited area 315 may have any shape including the position of the player character 201. For example, the shape of the prohibited area 315 may be a rectangular parallelepiped or a cylinder.

In the first example, the game system 1 sets a voxel update range when a moving object is located inside the object generation area. For example, when the moving object moves from inside to outside of the object generation area, the voxel update range is set while the position of the moving object is inside the object generation area, and once the position of the moving object becomes outside the object generation area, the voxel update range is no longer set. When the moving object moves from outside to inside of the object generation area, the voxel update range is not set while the position of the moving object remains outside, and the voxel update range is set after the position of the moving object becomes inside the object generation area.

In the first example, during a period from when a placement event occurs to when a termination condition is satisfied, the game system 1 sets a voxel update range for each frame, and updates a voxel mesh of a path object. Thus, in the first frame in which the placement event occurs, a path object is newly generated. In the second and subsequent frames after occurrence of the placement event, a new voxel update range is set at a position extending from the voxel update range set in the previous frame, whereby the path object is deformed to gradually extend along the movement path of the moving object. In the first example, when the moving object moves along a parabolic trajectory, the path object is formed so that it extends in a direction having an upward component in the game space, and then extends in a direction having a downward component.

In the first example, the voxel update range 313 is set so that its upper surface coincides, at least partially, with the edge of the upper surface of the voxel update range that is set one frame earlier (specifically, the edge to be connected to the voxel update range 313). For example, the game system 1 may adjust the position of the voxel update range 313 so that the upper surface of the voxel update range 313 that is set in the current frame is continuous with the upper surface of the voxel update range that was set in the previous frame. In this case, the path object is formed so that its upper surface has no steps (or only minimal steps), which allows the player character 201, etc., to easily move on the path object. In the first example, since the player character 201 rarely (or never) moves along the lower surface of the path object, the lower surface of the path object need not be formed without steps, and may be formed in any shape (the same applies to the second to fourth examples described below).

The specific content of the termination condition is discretionary. The termination condition may be, for example, that the moving object has moved a predetermined distance or more, that a predetermined time has elapsed from the start of movement of the moving object, or that the moving object has come into contact with another object. The termination condition may be a combination of these conditions. When the termination condition has been satisfied, the moving object itself may or may not be deleted from the game space.

Regarding the process of setting a voxel update range and the process of setting a voxel mesh for a path object, based on the current position of the moving object in a certain frame, the game system 1 may not necessarily perform these processes in the certain frame, and may perform these processes in a later frame. In the first example, when setting a path object, regarding the process of setting a voxel update range calculated with the position of the moving object in a certain frame being the current position, and the process of setting a voxel mesh for the path object based on the voxel update range, the game system 1 performs these processes in a frame that occurs after a waiting period from the certain frame. Therefore, the voxel mesh for the path object that is set at a certain position when the moving object passes through the certain position is set after the above waiting period has elapsed from when the moving object passed. This reduces the risk of the moving object coming into contact with the path object. For example, it is possible to minimize the risk of disadvantage such as the moving object behaving unnaturally due to contact. The waiting period may be set fixedly in advance, or may be set variably based on the movement speed of the moving object, or the like. For example, the waiting period may be set to a shorter duration when the movement speed of the moving object is high, and to a longer duration when the movement speed is low.

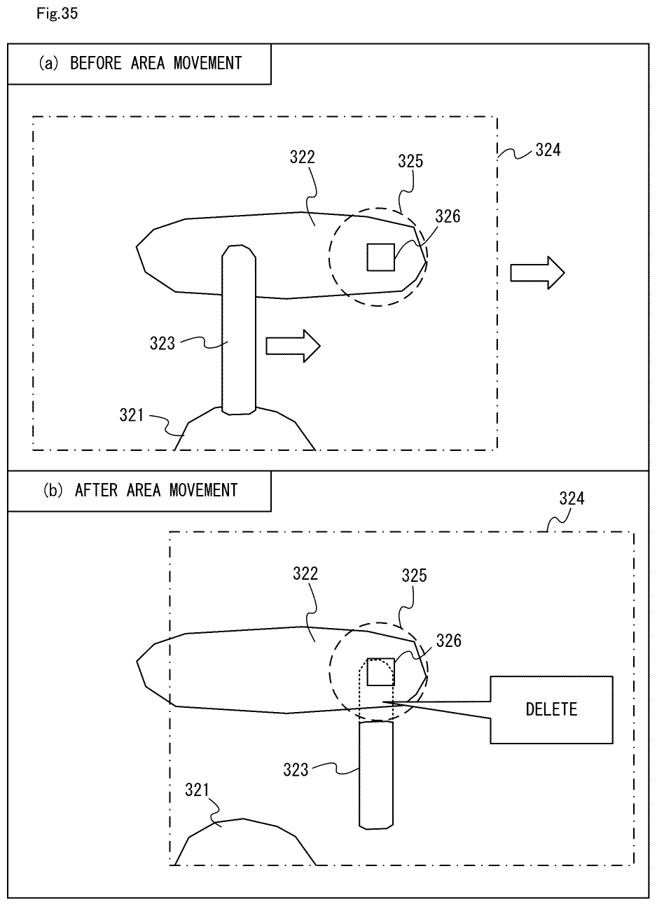

In the first example, the above object generation area moves or rotates in the game space. FIG. 35 is a view showing an example of states before and after movement of an object generation area in a game space. FIG. 35 shows the game space including an object generation area 324 as viewed from above, and shows a state in which a path object 323 is set between a terrain object 321 and a terrain object 322 inside the object generation area 324. In the example shown in FIG. 35, the object generation area 324 moves translationally in the game space. In other embodiments, the object generation area 324 may be controlled to rotate.

In the first example, the game system 1 moves or rotates a voxel space regarding the path object 323 in response to movement or rotation of the object generation area. Thus, the positional relationship between the disposed path object 323 and the object generation area 324 is not changed even when the object generation area 324 moves, and the path object 323 can be moved in conjunction with the movement of the object generation area 324.

In the first example, the voxel space for the terrain objects 321 and 322 is a voxel space different from that for the path object, and is placed fixedly in the game space. Since the terrain objects 321 and 322 do not move even when the object generation area 324 moves, the positional relationship between the path object 323 and the terrain objects 321, 322 changes when the object generation area 324 moves (see FIG. 35). Therefore, when the path object 323 moves in response to the movement of the object generation area 324, there is a possibility that the path object 323 comes into contact with another object.

There is a possibility that game-related disadvantage may occur if the path object 323 comes into contact with another object as a result of its movement. For example, in the example shown in FIG. 35, an object 326 is placed on the terrain object 322 at a position where it may come into contact with the moved path object 323. The object 326 may be an object required for progressing the game (e.g., an item, a non-player character, etc., required for progressing the game). In the state shown in FIG. 35, if the path object 323 comes into contact with the object 326 and, as a result, the object 326 falls from the terrain object 322 and disappears, there is a risk of disadvantage that such a contact adversely affects the progress of the game.

As described above, in the first example, the prohibited area 325 is set in the space. For example, the prohibited area 325 is set to include the position of an object that could cause some kind of disadvantage if it comes into contact with the path object 323. Moreover, for example, the prohibited area 325 may be set when contact between an object in this area and the path object would result in an unnatural appearance. In the first example, if at least a part of the path object 323 is included in the prohibited area 325, the game system 1 deforms the path object 323 to delete the part included in the prohibited area 325 (see (b) of FIG. 35). Specifically, when the voxel space regarding the path object 323 is moved, the game system 1 decreases the densities of voxels corresponding to the prohibited area 325 to a value (e.g., 0) less than the reference value, after the movement. This inhibits the path object 323 from being placed inside the prohibited area 325. Therefore, it is possible to reduce the risk of disadvantage caused by the path object 323 coming into contact with an object inside the prohibited area 325, as well as the risk of disadvantage that an object contacting the path object 323 deforms and appears unnatural.

### 2-8-2. Second Example

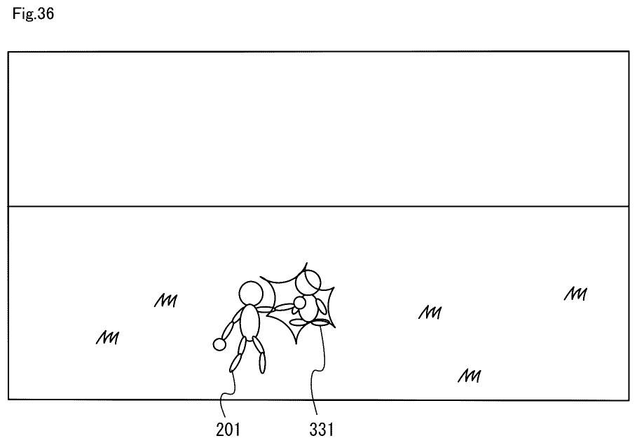

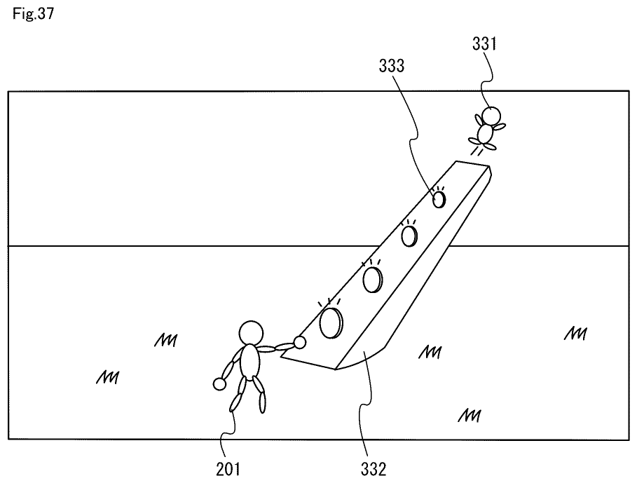

As the second example, an example in which a path object is placed in response to movement of an enemy character that is affected by an attack action performed by a player character, will be described. FIG. 36 is a view showing an example of a game image in a state where the player character is performing a punching action on the enemy character. FIG. 37 is a view showing an example of a game image in which the enemy character that has received the punching action is moving. As shown in FIG. 36 and FIG. 37, when the player character 201 performs a punching action on an enemy character 331, the enemy character 331 that has received the punching action moves as if it is blown away. In this case, in the second example, a path object 332 is placed along a movement path of the enemy character 331 (see FIG. 37). Thus, the second example, like the first example, is an example in which a path object is set in response to movement of an object that is affected by an action of the player character.

In the second example, a placement event is an event in which, in response to the player character 201 performing a predetermined attack action on a predetermined type of character, the character hit by the attack action moves. In the second example, the moving object is the predetermined type of character. The predetermined type of character may be an enemy character, or a character that is an ally for the player character. In other embodiments, an object to be a moving object may be determined independently of the character type. For example, whether or not a character that has received the predetermined attack action becomes a moving object may be determined based on the state of the player character. As an example, when the player character is in a predetermined state (e.g., using a specific item, or being transformed into a specific form) and performs the predetermined attack action, and the attack action causes a character to move, the path object may be set using the character as a moving object.

The predetermined attack action is not limited to the punching action shown in FIG. 36, and may include any attack action. For example, if the player character 201 can perform multiple types of attack actions such as punching and kicking, these attack actions may be set as the above predetermined action. Furthermore, the predetermined attack action may be an action that is executable on the condition that the player character 201 is in a predetermined state. In other embodiments, an action that triggers setting of a path object in the second example is not limited to the attack action, and may be another type of action.

In the second example, the enemy character 331 that has received the punching action of the player character 201 moves in a direction according to the punching action. The movement direction of the enemy character 331 is, for example, a direction obtained by tilting the direction from the player character 201 to the enemy character 331, upward (or in the pitch direction) by a predetermined angle. Thus, in the second example, the movement direction of the enemy character 331 that has received the punching action is the direction having the upward component in the game space, and therefore, the direction in which the path object extends is also the direction having the upward component in the game space (see FIG. 37). In the second example, the enemy character 331 moves a predetermined distance in the above-mentioned direction and then moves downward along a parabolic trajectory. Therefore, in the second example, the path object is formed so as to extend in the direction having the upward component in the game space, and then extend in the direction having the downward component. In the second example, the movement direction and movement amount of the enemy character that has received the punching action are constant regardless of the enemy character. However, in other embodiments, the game system 1 may determine the movement direction and movement amount of the enemy character, based on the type and size of the enemy character, the type of action performed on the enemy character, and/or the positional relationship between the player character and the enemy character.

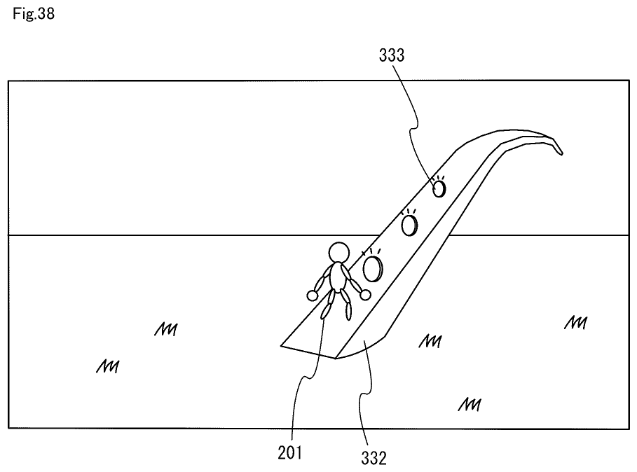

FIG. 38 is a view showing an example of a game image in a state where the player character moves on the path object. As shown in FIG. 38, as in the first example, in the second example, the player character 201 can move on the path object 304. As in the first example, in the second example, the player can place a path object that serves as a new movement route in the game space, thereby improving the strategy and interest of the game can be improved. In the second example, since the path object is generated with a component extending upward, the player character 201 can, for example, use the path object to move across an inaccessible area in the game space (such as valleys).

As shown in FIG. 37 and FIG. 38, in the second example, when the path object 332 is set, an item object (e.g., item object 333 shown in FIG. 37 and FIG. 38) is placed on the path object 332. An item object is, for example, an object representing an item that provides an advantage in the game when the player character 201 obtains it. In the second example, the item object represents an item that serves as currency in the game. The item object being placed on the path object 332 suggests to the player that the player character 201 can move on the path object 332. In addition, the item object motivates the player to perform game operations that move the player character 201 on the path object 332.

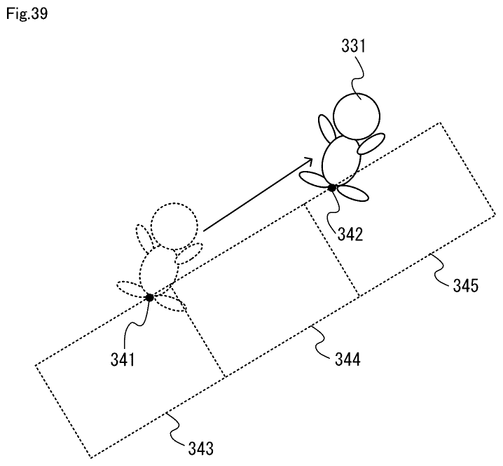

FIG. 39 is a view showing an example of a path object generation method according to the second example. In FIG. 39, a current position 342 is the position of the enemy character 331 as a moving object in the current frame. A previous position 341 is the position of the enemy character 331 one frame before the current frame. In FIG. 39, as an example, the position of the enemy character 331 is defined as the position at its feet when standing on the horizontal ground.

When the enemy character 331 moves in the placement event in the second example, the game system 1 sets a voxel update range extending in the movement direction of the enemy character 331 (specifically, direction from the previous position 341 to the current position 342). The voxel update range 343 shown in FIG. 39 is set one frame before the current frame. As will be described in detail below, in the second example, the voxel update range set at the current time includes the current position of the enemy character. Therefore, in the example shown in FIG. 39, the voxel update range 343 in the previous frame is set to include the position of the enemy character 331 in the previous frame.

In the second example, the game system 1 determines whether or not the distance from the previous position 341 to the current position 342 is equal to or greater than a predetermined distance. If the distance from the previous position 341 to the current position 342 is equal to or greater than the predetermined distance, a voxel update range is set. If the distance from the previous position 341 to the current position 342 is less than the predetermined distance, a voxel update range is not set. In the second example, when a voxel update range was not set in the previous frame, the game system 1 calculates the above distance by using, as the previous position, the position of the enemy character 331 in the frame in which the voxel update range was last set. As described above, in the second example, the voxel update range is not necessarily set for each frame. In other embodiments, the game system 1 may set the voxel update range for each frame as in the first example. In the example shown in FIG. 39, the distance from the previous position 341 to the current position 342 is equal to or greater than the predetermined distance, and the voxel update range is set.

In the second example, a voxel update range is set by using a unit update range. The unit update range is a range having predetermined shape and size, and is represented by an SDF. The unit update range may have any shape. In the second example, the unit update range has a shape with an upper surface, and more specifically, has a columnar shape having a semicircular cross section. In other embodiments, the unit update range may be, for example, a quadrangular prism, or a shape obtained by rounding the edges and corners of a quadrangular prism.

In the second example, in a frame in which a voxel update range is set, the game system 1 places one or more unit update ranges from the end of the voxel update range that was last set in the previous frame (specifically, the end in the movement direction of the enemy character 331) toward the movement direction of the enemy character 331, until reaching the current position 342. In the example shown in FIG. 39, since a unit update range 344 placed adjacent to the last set voxel update range 343 has not reached the current position 342, another unit update range 345 is placed. In the example shown in FIG. 39, the range consisting of the two unit update ranges 344 and 345 set as described above becomes the voxel update range set in the current frame. As described above, in the second example, the game system 1 sets the voxel update range from the end of the voxel update range that was last set in the previous frame, extending toward the current position at least up to the position that reaches the current position 342.

In the second example, the unit update range including the position of the enemy character 331 (e.g., the unit update ranges 343, 345 shown in FIG. 39) is set so that the position at the feet of the enemy character 331 is included in the upper surface of the unit update range. The position at the feet of the enemy character 331 refers to, for example, the position that overlaps with the ground when the enemy character 331 is standing upright and level on the ground (in other words, the position at the lower end of the enemy character 331). As will be described in detail below, the position of the upper surface of the unit update range is the position of the upper surface of the path object. Therefore, when the position at the feet of the enemy character 331 is included in the upper surface of the unit update range, there are no steps (or only minimal steps) between the ground where the enemy character 331 is standing and the upper surface of the path object, in the first frame in which the path object is set. This allows the player character 201 to easily enter the path object.

Furthermore, in the second example, two adjacent unit update ranges are positioned so that the edges of the upper surfaces thereof (specifically, the edges at which the adjacent unit update ranges are connected), at least partially, coincide with each other. For example, the game system 1 adjusts the placement positions of the unit update ranges so that the upper surface of the currently placed unit update range is continuous with the upper surface of the previously placed unit update range. Thus, the path object is formed so that its upper surface has no steps (or only minimal steps), which allows the player character 201, etc., to easily move on the path object.

The game system 1 updates (specifically, increases) the densities of voxels corresponding to the voxel update range so that the voxel update range set as described above becomes the internal region of the voxel object. For example, the densities of voxels corresponding to the voxel update range are updated to a value (e.g., 255) not less than the reference value. The game system 1 generates a voxel mesh for the path object, based on the voxel data after the density update, according to the method described in the above [2-6. Generation of mesh]. Thus, the path object with the shape according to the voxel update range is generated.

In the second example, during a period from when a placement event occurs to when a termination condition is satisfied, the game system 1 performs, for each frame, the process of determining whether or not to set a voxel update range, the process of setting a voxel update range when the result of the above determination process is positive, and the process of updating the voxel mesh of the path object. Thus, in the second example, as in the first example, the path object is set to gradually extend along the movement path of the moving object.

In the second example as well, the specific content of the termination condition is discretionary. The termination condition may be, for example, that the enemy character 331 has moved a predetermined distance or more, that a predetermined time has elapsed from the start of movement of the enemy character 331, or that the enemy character 331 has come into contact with another object. The termination condition may be a combination of these conditions. When the termination condition has been satisfied, the enemy character 331 itself may or may not be deleted from the game space.

Regarding the process of setting a path object based on the current position of the moving object in a certain frame (specifically, the process of determining whether or not a voxel update range is set, the process of setting a voxel update range, and the process of setting a voxel mesh for the path object), the game system 1 may not necessarily perform these processes in the certain frame, and may perform these processes in a later frame. In the second example, when setting a path object, regarding the above processes to be performed with the position of the moving object in a certain frame being the current position, the game system 1 performs each process in a frame that occurs after a waiting period from the certain frame. Therefore, the voxel mesh for the path object to be set at a certain position when the enemy character that has received the punching action of the player character 201 passes through that position, is set after the above waiting period has elapsed since the enemy character passed. This reduces the risk of the enemy character coming into contact with the path object.

In the second example, the game system 1 places the above item object on the placed path object. The specific method for placing an item object is discretionary. In the second example, item objects are placed at regular intervals on the path object. For example, the game system 1 places the first item object at a position a predetermined distance away from the start position of the path object in the movement direction of the enemy character. If the mesh of the path object exists below a position a predetermined distance away from the position of the last placed item object, the game system 1 places a new item object at that position. Thus, even if the length of the path object extending per frame is not constant, item objects can be placed so that the spacing between them remains constant. In other embodiments, the game system 1 may perform, for example, a process of placing item objects at intervals of a predetermined number of frames, during the period from when a placement event occurs to when a termination condition is satisfied.

In the second example, the player character 201 that has performed an action on the enemy character may be adjusted so that it can immediately move onto the set path object. For example, the player character 201 may move the enemy character by performing a dash action. In this case, the game system 1 may set a large collision determination area for the player character 201 performing the dash action, so that the enemy character is moved slightly before the player character 201 actually comes into contact with the enemy character. Moreover, for example, the game system 1 may generate the path object starting from a position on the far side, as viewed from the player character 201, relative to the position of the enemy character at the time of contact with the player character 201. Thus, it is possible to increase the distance between the position of the player character 201 at the time the placement event occurs and the position where the path object is first generated. This allows, for example, the player character 201 performing the dash action to blow away the enemy character and thereafter immediately enter the path object that is set according to the movement of the enemy character.

In the second example, the material of the path object is set to a predetermined material (referred to as “path material”). Specifically, the game system 1 sets the path material of voxels corresponding to the voxel update range. Thus, the material of the voxel mesh that is set based on the voxels becomes the path material. In the second example, the path material is given a property such that, when the player character 201 lifts the object to which the material is set, the player character 201 flies (e.g., ascend into the air while holding the object). Therefore, in the second example, after climbing onto the path object, the player character 201 can ascend to a higher position from the path object by lifting a fragment object (specifically, an object to which the path material is applied) that was generated by a punching action or a pull-out action performed on the path object. The path material may have, in addition to (or instead of) the above property, a property that increases the speed of the player character 201 when moving on the object to which the material is applied. This allows the player character 201 to move on the path object at a higher speed than when moving on the normal ground where the path material is not applied.

### 2-8-3. Third Example

As the third example, an example in which a path object is placed in response to movement of a player object that performs a predetermined action in a game space, will be described. In the third example, a player object is a moving object, and a placement event is an event in which the player object moves due to a predetermined action (generation action described below) of the player object, which is performed based on an operation input performed by the player.

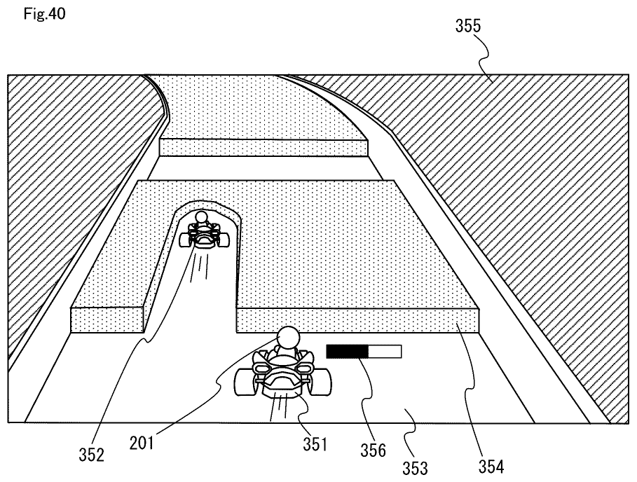

FIG. 40 is a view showing an example of a game image in the third example. As shown in FIG. 40, in the third example, a game image representing a scene in which a player character 201 is riding a vehicle object and participating in a race, is displayed. In the third example, a player object 351 includes a player character 201 and a vehicle object. In other embodiments, the vehicle object that the player character 201 rides may be any object such as a car, an airplane, an animal, or another character. A player object may be composed of a single object (e.g., only the player character 201). Furthermore, in the third example, another race object 352 that races with the player object 351 appears. In other embodiments, such another race object may not necessarily appear.

The player object 351 is controlled based on an operation input performed by the player. In the third example, the movement speed of the player object 351 is determined based on control rules defined in the game program, and the traveling direction of the player object 351 is determined based on an operation input performed by the player. The player object 351 may be controlled by any control method, and its movement speed and traveling direction may be determined based on an operation input performed by the player.

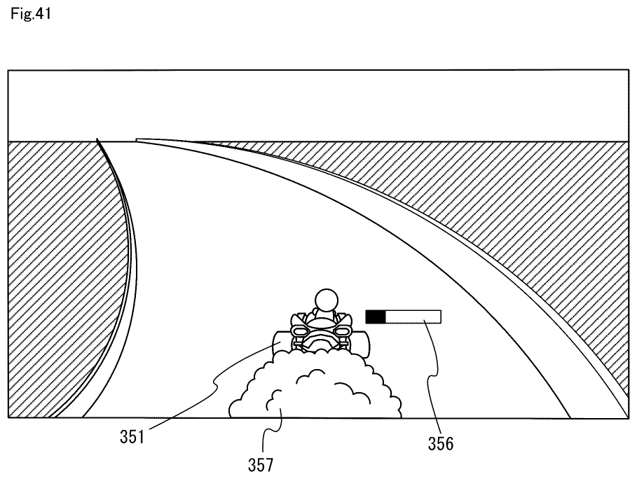

In the third example, the player object 351 can perform a generation action to generate a path object. FIG. 41 is a view showing an example of a game image representing the player object performing a generation action. In the third example, the player object 351 performs a generation action in response to a predetermined operation input (e.g., an input to the ZR-button 61) performed by the player. In the third example, the player object 351 performing the generation action moves forward, or forward and diagonally upward. The movement direction during the generation action is discretionary, and the player object 351 during the generation action may move along the ground object or may move as if jumping into the air.

The movement direction during the generation action may be determined based on an operation input performed by the player. For example, the angle of the movement direction regarding the pitch direction (specifically, the angle of the movement direction with respect to the horizontal direction) may be, within a predetermined angle range, determined to an angle according to the operation input during the generation action. Specifically, the movement direction regarding the pitch direction during the generation action may be determined within a range from the horizontal direction to a predetermined angle upward with respect to the horizontal direction, according to an operation input (e.g., an input by tilting the analog stick 32) during the generation action.

In the third example, the movement speed of the player object 351 during the generation action is set to a speed higher than the movement speed when not performing a generation action. The movement speed during the generation action is discretionary. In other embodiments, the movement speed during the generation action may be the same as or lower than the movement speed when no generation action is performed.

As described above, in the third example, the movement mode of the player object 351 during the generation action is different from the movement mode when not performing a generation action. In other embodiments, the movement mode of the player object 351 may not necessarily change when the generation action is started. That is, the game system 1 may determine the movement speed and the traveling direction of the player object 351 in the same manner, regardless of whether or not the player object 351 performs a generation action.

In the third example, the player object 351 is assigned an action parameter with a value corresponding to the time during which a generation action can be executed. The game system 1 increases the value of the action parameter according to the player object 351 satisfying a predetermined condition. In the third example, the predetermined condition is that a soil object 354 and a mud object 355 placed in the game space (see FIG. 40) are deformed by the player object 351.

In the third example, the soil object 354 and the mud object 355, which are voxel objects, are placed in the game space (see FIG. 40), and the player object 351 can move while deforming the soil object 354 or the mud object 355 in front of as if the object 354 or 355 is deleted. Specifically, when an event in which the player object 351 moves near the soil object 354 or the mud object 355 has occurred, the game system 1 sets a voxel update range in front of the player object 351, and decreases the densities of voxels corresponding to the voxel update range to a value (e.g., 0) less than a reference value. This causes the meshes of the soil object 354 and the mud object 355 to be deformed such that parts thereof within the voxel update range are deleted. Thus, it is possible to represent the player object 351 traveling while destroying or absorbing the soil object 354 or the mud object 355. The specific position, size, and shape of the voxel update range are discretionary. For example, the voxel update range may have a spherical shape on a position a predetermined distance ahead of the player object 351. In the third example, the ground object 353 is an object (e.g., an object that is not a voxel object) that is not deformed even when the soil object 354 and the mud object 355 are deformed.

The game system 1 gradually decreases the value of the action parameter during the period when the player object 351 is performing the generation action. The game system 1 causes the player object 351 to perform a generation action at least on the condition that the value of the action parameter is not 0. When the value of the action parameter is 0, even if an operation input for a generation action regarding the player object is performed, the game system 1 causes the player object 351 to end the generation action.

Thus, by controlling the player object 351 to deform a soil object or a mud object, the player can increase the value of the action parameter and thereby cause the player object 351 to perform a generation action. Thus, by setting the conditions for performing a generation action, the strategy of the game can be improved. In other embodiments, conditions for the player object 351 to perform a generation action are discretionary, and the player object 351 may be able to perform a generation action unconditionally.

As shown in FIG. 40 and FIG. 41, the game system 1 may display a gauge image 356 indicating the current value and an upper limit value of the action parameter. In addition, the game system 1 may display an effect image regarding the player object 351 during the generation action to notify the player that the generation action is in progress. For example, in the example shown in FIG. 41, an effect image 357 representing smoke is displayed behind the player object 351 during the generation action.

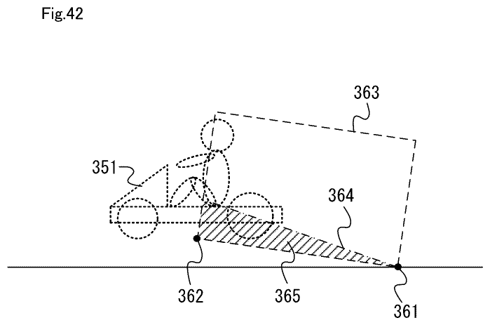

In the third example, when the player object 351 has performed a generation action, a path object is placed along the trajectory that the player object 351 has passed during the generation action, after movement of the player object 351. Hereinafter, a process of setting a path object according to a generation action will be described with reference to FIGS. 42 to 44.

FIG. 42 is a view showing an example of a voxel update range that is set at a point when one frame has elapsed from when a generation action was started. In the example shown in FIG. 42, a start position 361 is the position of the player object 351 when a generation action is started. The current position 362 is the position of the player object 351 at the current time (here, after one frame has elapsed from the start of the generation action). In the third example, the position of the player object 351 is set at a predetermined position on a horizontal plane including a lower end of the player object 351 (see FIG. 42).

In the third example, the game system 1 sets a passage area 363 along a path through which the player object 351 performing the generation action passes. In the third example, the game system 1 sets the passage area 363 by using the aforementioned SDF. In the state shown in FIG. 42, the passage area 363 is set to extend from the start position 361 to the current position 362. For example, the passage area 363 has a rectangular parallelepiped shape having four side surfaces parallel to the direction from the start position 361 to the current position 362, and one of two surfaces other than the side surfaces (hereinafter referred to as a bottom surface) includes the start position 361 while the other surface includes the current position 362. Moreover, one side of the bottom surface of the passage area 363 passes the start position 361 and is parallel to the ground at the start position 361. The passage area may have any shape extending from the start position to the current position. For example, the passage area may have a capsule shape or a shape with rounded vertices and sides of the above-mentioned rectangular parallelepiped. The passage area may also have a shape such that an upper part of a cross section perpendicular to the direction from the start position to the current position forms a straight line. Thus, an upper surface of the path object is formed, allowing the path object to have a shape on which the player object 351 can easily travel.

As described above, the passage area 363 is set to include the position through which the player object 351 performing the generation action passes. However, the passage area 363 may not necessarily be set to include the entire area through which the player object 351 passes, and may be set to include an area through which the player object 351 does not pass.

In the third example, the game system 1 sets a slope 364 in the passage area 363. As shown in FIG. 42, the slope 364 is a plane obtained by rotating the lower side surface (specifically, side surface including the start position 361 and the current position 362) of the passage area 363 upward by a predetermined angle, using an edge passing through the start position 361 as a rotation axis. The predetermined angle is greater than 0° and less than 90°. As will be described in detail below, the upper surface of the road object is generated along the slope 364. Here, if the upper surface of the road object and the ground are connected at the start position 361 such that no large angle difference occurs, the player object 351 can move more easily onto the road object. Therefore, the predetermined angle may be set to an angle equal to or less than 45° (e.g., 10°). In the third example, since the position on the horizontal plane including the lower end of the player object 351 is used as the position of the player object 351, the predetermined angle is set to a value greater than 0°. However, a position other than the horizontal plane including the lower end of the player object 351 may be used as the position of the player object 351, and in this case, the predetermined angle may be set to 0°.

The game system 1 sets, as a voxel update range 365, a part of the passage area 363 excluding a part located above the slope 364 (see a hatched area shown in FIG. 42). Specifically, the game system 1 changes data of SDF representing the passage area 363 to represent the area excluding the area located above the slope 364. The game system 1 updates (specifically, increases) the densities of voxels corresponding to the voxel update range 365 so that the voxel update range 365 as described above becomes the internal region of the voxel object. For example, the densities of voxels corresponding to the voxel update range 365 are updated to a value (e.g., 255) not less than the reference value. The game system 1 generates a voxel mesh of the path object based on the voxel data after the update of densities, according to the method described in the above [2-6. Generation of mesh]. Thus, the path object having the shape corresponding to the voxel update range 365 is generated.

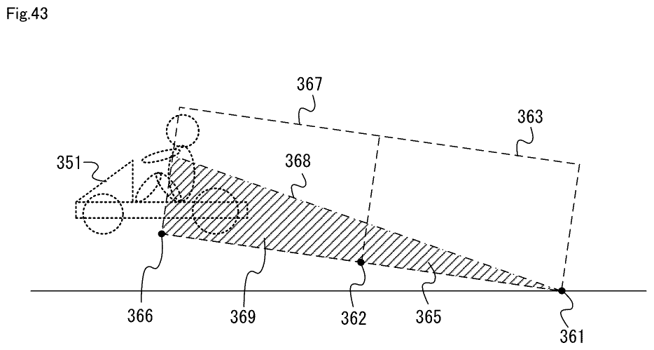

FIG. 43 is a view showing an example of a voxel update range that is set at a point when two frames have elapsed from when a generation action was started. In the third example, during the generation action, the player object 351 moves straight in the direction determined at the start of the action. Therefore, in FIG. 43, a current position 366 is on a straight line passing through a start position 361 and a one-frame previous position 362.

In the second and subsequent frames from the start of the generation action, the game system 1 sets a passage area in the same manner as in the first frame. In the second and subsequent frames, the passage area is set to extend from the position of the player object 351 in the previous frame to the current position. In the second frame, a passage area 367 extending from the one-frame previous position 362 to the current position 366 is set (see FIG. 43). As described above, in the third example, since the player object 351 performing the generation action moves straight, an upper side surface of the 1-frame previous passage area 363 and an upper side surface of the passage area 367 set in the current frame are continuous. The player object 351 performing the generation action may be controlled so as not to move straight (e.g., moving along a parabolic trajectory). In this case, the game system 1 may adjust the position of the passage area 367 so that the edge of the upper side surface of the 1-frame previous passage area 363 coincides, at least partially, with the edge of the upper side surface of the passage area 367 set in the current frame (more specifically, the side surfaces are continuous).

Next, the game system 1 sets a slope 368 within the passage area 367. In the second and subsequent frames, in the same manner as in the first frame, the slope 368 is a plane obtained by rotating the lower side surface of the passage area 367 upward by a predetermined angle, using the edge passing through the start position 361 as a rotation axis. In the third example, since the player object 351 performing the generation action moves straight, the slopes set in the respective frames are located on the same plane. If the player object 351 performing the generation action is controlled so as not to move straight, the game system 1 may adjust and set the position of the slope so that the edge of the 1-frame previous slope coincides, at least partially, with the edge of the slope set in the current frame (more specifically, the slopes are continuous).

In the second and subsequent frames, as in the first frame, the game system 1 sets, as a voxel update range 369, a part of the passage area 367 excluding a part above the slope 368 (see a hatched area shown in FIG. 43). The densities of voxels corresponding to the voxel update range 369 are updated such that a voxel mesh is arranged on the surface of the voxel update range 369, and a voxel mesh of the path object is set based on the voxel data after the update of densities. Thus, in the second and subsequent frames, the path object is deformed to have a shape corresponding to the voxel update ranges (voxel update ranges 365 and 369 in the example shown in FIG. 43) that have been set so far. Thus, in the third example, the path object is deformed to extend along the traveling direction of the player object 351.

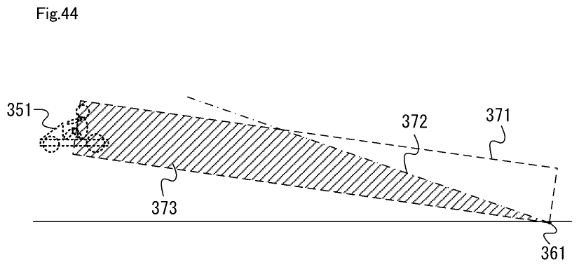

FIG. 44 is a view showing an example of a voxel update range that is set after a certain time has elapsed from when a generation action was started. In FIG. 44, an area 371 is obtained by combining all the passage areas set from the start of the generation action up to the present time. Here, as shown in FIG. 44, the slope 372 is located above the upper side surface of the area 371, at a position a certain distance away from the start position 361. That is, in a frame after a certain time has elapsed from the start of the generation action, the slope 372 is located above the upper side surface of the passage area in the frame. In this case, the passage area is set as a voxel update range as it is. Thus, in the third example, a voxel update range 373 has a shape obtained by excluding an upper part, of the area 371, on the side near the start position 361 (specifically, a part above the slope 372) (see FIG. 44).

In the third example, in the frames from the start of the generation action until an exclusion processing period has elapsed, the game system 1 performs a process of excluding an upper part, of the passage area, above the slope. In a frame after the exclusion processing period has elapsed, the game system 1 sets the passage area as a voxel update range without performing the process. The exclusion processing period is a period before the frame in which the slope comes to be located above the upper side surface of the passage area in the frame. Thus, the path object generated within the exclusion processing period from the start of the generation action has an upper surface along the slope. This makes it possible to reduce (or eliminate) steps between the ground and the path object, allowing the player object 351 to easily enter the path object from the ground. In other embodiments, a voxel update range may be set without using a slope. Specifically, the game system 1 may set a passage area before excluded by the slope, as a voxel update range.

In the third example, the upper side surface of each passage area set for each frame, and each slop for each frame, are set to be continuous. Therefore, the voxel mesh of the path object is generated such that the upper surface generated due to deformation in each frame is continuous with the upper surfaces having been formed up to that point. Thus, the path object can be generated in a shape that allows the player object 351 to easily travel on the path object.

In the third example, the game system 1 sets a voxel update range for each frame, and sets a voxel mesh of a path object for each frame such that its shape corresponds to the voxel update range. Therefore, the voxel update range is continuously set at positions through which the player object 351 has passed due to the generation action, and the path object is deformed to gradually extend along the path through which the player object 351 has passed. This makes it possible to clearly represent how the path object is generated according to the generation action such that it follows the player object 351.

The method for continuously setting the voxel update range is not limited to the method for setting the voxel update range for each frame. For example, in other embodiments, as in the above second example, on the condition that the distance between the current position of the player object 351 and the one-frame previous position is equal to or greater than a predetermined distance, the game system 1 may perform the passage area setting process and the voxel update range setting process, based on these positions. When a voxel update range was not set in the previous frame, the game system 1 calculates the above distance by using, as the previous position, the position of the player object 351 in the frame in which the voxel update range was last set. In this case as well, the voxel update range is continuously set and the path object is continuously deformed according to the generation action being performed over a plurality of frames.

The game system 1 may not necessarily perform the voxel update range setting process and the voxel mesh setting process for the path object, based on the current position of the player object 351 in a certain frame in which the generation action is being performed, in this frame, and may perform these processes in a later frame. In the third example, when the player object 351 during the generation action has reached a certain position in a certain frame, the game system 1 performs a setting process for a voxel update range calculated with the certain position as a current position and a voxel mesh setting process for a path object based on the voxel update range, in a frame after a waiting period from this frame. Therefore, the voxel mesh for the path object, which is set at a certain position in response to the player object 351 passing through the position, is set after the waiting period has elapsed after the passing of the player object 351. Thus, the risk of the player object 351 coming into contact with the path object can be reduced. The waiting period may be fixedly set in advance, or may be variably set based on the movement speed of the player object 351, or the like. For example, the waiting period may be set to a shorter period when the player object 351 moves at a higher speed, and to a longer period when the player object 351 moves at a lower speed.

In the above description, a path object is set according to a generation action performed by the player object 351. In the third example, a race object other than the player object 351 may also be controlled to perform a generation action. In this case, a path object may be generated according to movement of the other race object performing a generation action.

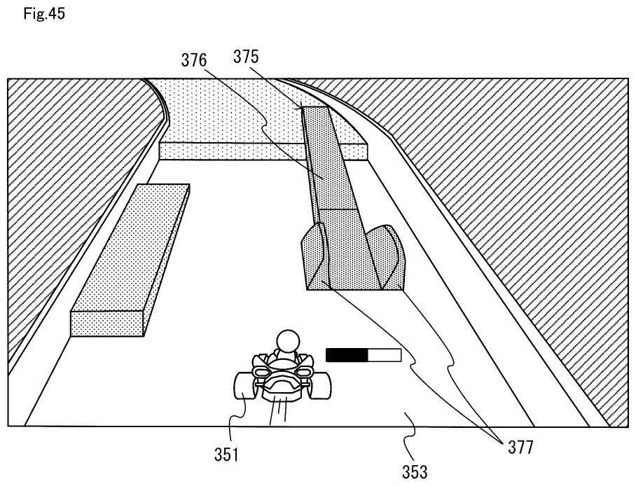

FIG. 45 is a view showing an example of a game image after a path object was generated. In the state shown in FIG. 45, a path object 375 is placed on a ground object 353. In the third example, a race object such as the player object 351 can move on the ground object, and can move on the path object disposed on the ground object. As shown in FIG. 45, since the path object 375 can be disposed to extend diagonally upward from the ground object 353, the route with the path object 375 can be different from the route on the ground object 353, for example. Thus, the position where the path object is generated affects the outcome of the racing game, thereby improving the strategy of the racing game.

In the third example, the racing course is annular, and the racing game follows a rule that requires a plurality of laps around the circular racing course. Therefore, the player object 301 can place the path object through its own generation action, for example, and then travel on the path object in the next and subsequent laps. Thus, the strategy of the racing game can be further improved. The circular course refers to a course of any shape that allows for laps, for example, a course that includes a closed path. The circular course may also refer to a course that forms a track. In other embodiments, the shape of the racing course may be any shape, and need not be circular. In addition, the racing game may adopt a rule that requires only a single lap of a circular course.

In the third example, the path object 375 has, in addition to a traveling surface part 376 based on the voxel update range that is set according to the method shown in FIGS. 42 to 44, guide parts 377 located outside the traveling surface part 376 (specifically, outside in the left-right direction when the direction in which the player object travels due to the generation action is the forward direction). Specifically, in the frame in which the generation action is performed by the race object, the game system 1 sets a voxel update range (e.g., the voxel update range 365 shown in FIG. 42) based on the above passage area, and further sets a voxel update range for the guide part outside the voxel update range. The game system 1 performs update to increase the densities of voxels corresponding to these voxel update ranges. The shape of the guide part and the shape of the voxel update range corresponding to the guide part are discretionary. For example, the voxel update range for the guide part may be set not only in an area outside the traveling surface part but also in an area overlapping with the traveling surface part. The shapes of the guide part and the corresponding voxel update range may be determined in advance. For example, these shapes may extend to the position above the upper side surface of the passage area, or the slope (see FIG. 45). In the third example, the guide parts are generated within a range of a predetermined distance from the start position of the generation action, regarding the direction in which the traveling surface part extends. For example, the game system 1 may perform the process of setting the voxel update range for the guide part, during a period until a predetermined number of frames elapse from the start of the generation action, and may not perform the process after the period has elapsed. In other embodiments, the guide parts may be generated outside the traveling surface part within a range from the start position to the end position of the generation action.

The guide parts 377 make it easier for the race object to enter the path object 375. Also, the guide part 377 makes it easier for the player to recognize the start position of the path object 375.

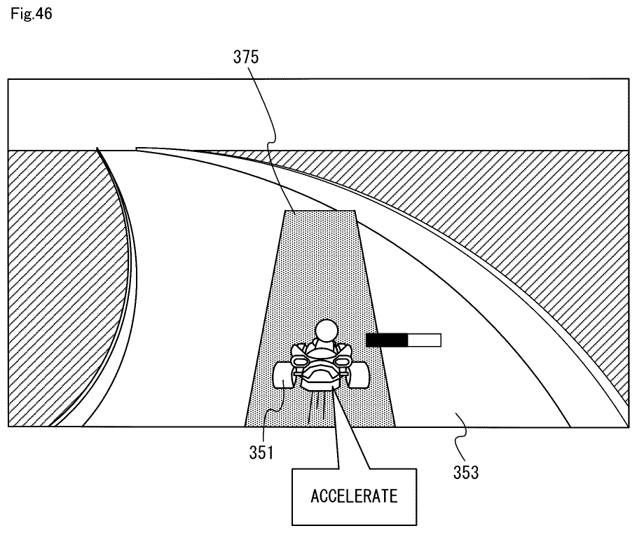

FIG. 46 is a view showing an example of a game image when a player object moves on a path object. In the third example, when moving on the path object 375, the player object 351 is controlled to accelerate. Specifically, when updating the density in the voxel update range corresponding to the path object, the game system 1 sets the material of voxels corresponding to the voxel update range to a path material. Thus, the voxel mesh of the path object is set to the path material. In the third example, the path material has the property that increases the speed of the player character 351 when moving on the object to which the material is applied. In the third example, the game system 1 specifies which object the player object 351 is located on, and if it is located on an object of the above path material, the game system 1 performs a control to accelerate the player object 351. The specific control method for accelerating the player object 351 is discretionary. For example, during a period when acceleration is performed, the game system 1 may increase the movement speed of the player object 351 gradually from the current speed, or may change the movement speed during the period when acceleration is performed to a constant speed higher than the normal speed. Thus, the player can advantageously progress the racing game by making the player object 351 travel on the path object. Thus, the strategy of the racing game in which the path object is placed can be further improved.

In the first to third examples described above, when a placement event has occurred, the game system 1 sets a voxel update range at one or more positions through which a moving object has passed. Thus, a path object extending along the path through which the moving object has moved. In other embodiments, in the first to third examples, the game system 1 may set a path connecting a first position and a second position on the movement path of the moving object, and set a voxel update range extending along the path, as described for the fourth example below. The path may not necessarily coincide with the moving object's movement path from the first position to the second position. For example, in the first to third examples, the path object may be formed so as to extend in a meandering manner from the first position to the second position, or may be formed so that the slope of the upper surface at the first position and the second position is gentler than the slope of the upper surface at the intermediate part, as in the fourth example described below.

### 2-8-4. Fourth Example

As the fourth example, an example in which a path object is placed in response to movement of a moving object due to a throwing action performed by a player character in a game space, will be described. In the fourth example, as in the first example, a path object is placed in response to movement of an object thrown by a player character. In the fourth example, however, a path object is set regardless of an object generation area, and a moving object is an object of a predetermined type (specifically, a nut object). The fourth example is different from the first example in the path object determination method and the path object setting timing. Hereinafter, an operation of setting a path object in the fourth example will be described.

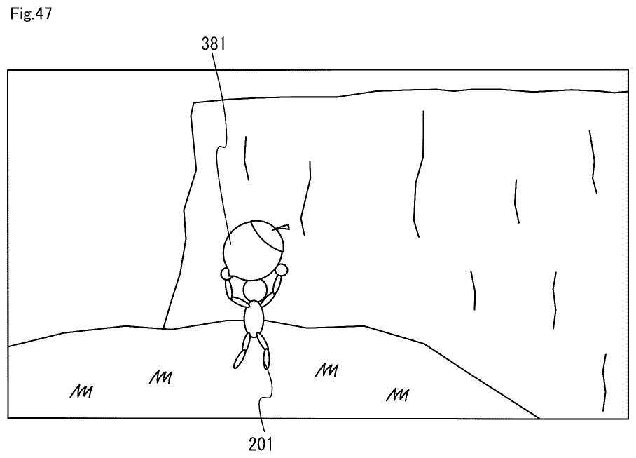

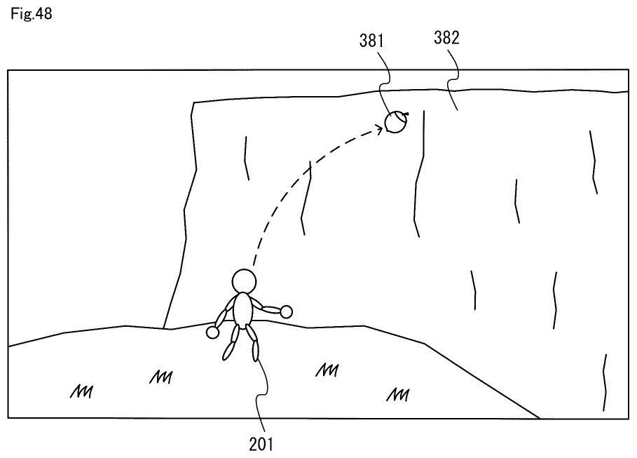

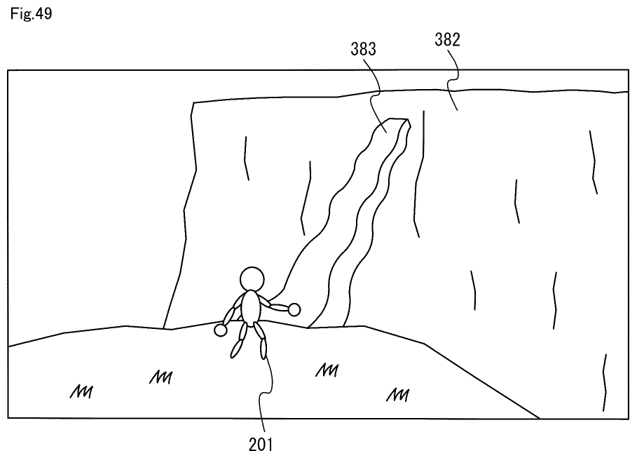

FIG. 47 is a view showing an example of a game image in a state where a player character is lifting a nut object. FIG. 48 is a view showing an example of a game image in a state where the player character has thrown the nut object by a throwing action from the state shown in FIG. 47. FIG. 49 is a view showing an example of a game image in a state where the path object is arranged from the state shown in FIG. 48.

As shown in FIG. 47, a player character 201 can perform a throwing action of throwing a nut object 381. In the fourth example, as described with reference to FIG. 28, the direction in which the nut object 381 is thrown by the player character 201 is controlled based on an operation input performed by the player. As shown in FIG. 48, the nut object 381 thrown by the throwing action moves in the game space. In the fourth example, the nut object 381 moves along a parabolic trajectory (see FIG. 48). In the example shown in FIGS. 47 to 49, the nut object thrown by the throwing action collides against a terrain object 382. In this case, the game system 1 sets a path object 383 along a path connecting the position of the player character 201 that thrown the nut object 381 and the position of the object at the collision (see FIG. 49).

In the fourth example, a placement event is an event in which a predetermined type of object being a moving object is thrown by a throwing action performed by the player character 201 and collides against another object. In the fourth example, the predetermined type of object is a nut object. In other embodiments, the moving object is not limited to the nut object, and a path object may be set in response to a placement event due to movement of another type of object.

In the fourth example, the path object is set when the nut object moves due to the throwing action performed by the player character 201. In other embodiments, a path object may also be set when a nut object moves due to another action performed by the player character 201. For example, a path object may be set when a nut object moves as if it is blown away by a punching action or a gun shooting action performed by the player character 201. In other embodiments, the character that performs an action to set a path object is not limited to the player character 201, and may be another character (e.g., enemy character). In other embodiments, a path object may be set when a character in a predetermined state (e.g., using a specific item) has performed a predetermined action on the nut object.

In the fourth example, setting of a path object is started after the nut object 381 thrown by the throwing action performed by the player character 201 collides against another object (terrain object 382 in FIG. 49). In other embodiments, the game system 1 may start setting of a path object after the thrown nut object 381 has moved a predetermined distance or after a predetermined time has elapsed from when the nut object 381 was thrown.

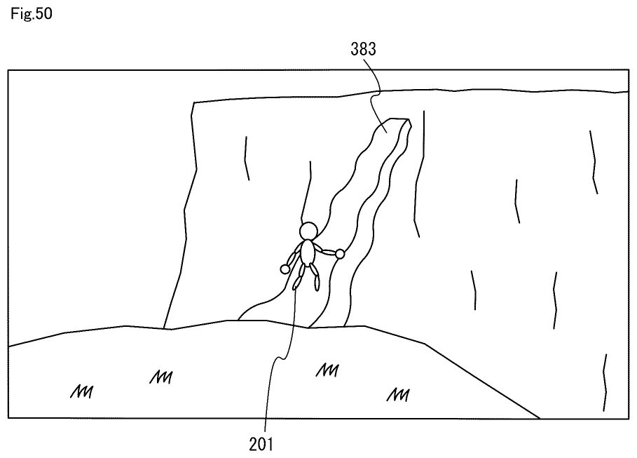

FIG. 50 is a view showing an example of a game image in a state where a player character moves on a path object. As shown in FIG. 50, in the fourth example, as in the first to third examples, the player character 201 can move on the path object 304. As described above, in the fourth example, by throwing the nut object 381, the player can place, in the game space, the path object 383 extending in the throwing direction, thereby setting a new path in the game space. Thus, the strategy and interest of the game can be improved.

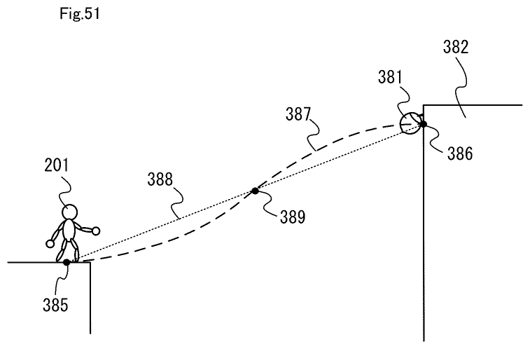

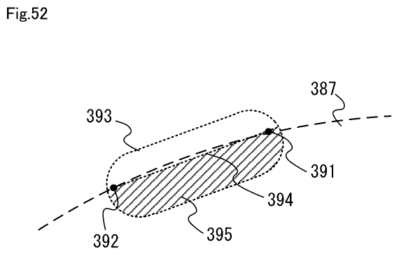

Hereinafter, a path object setting method according to the fourth example will be described with reference to FIG. 51 and FIG. 52. In the fourth example, the game system 1 sets a path connecting a start position and an end position regarding movement of the nut object 381 that is a moving object, and sets a path object extending along the path. FIG. 51 is a view showing an example of a path for setting a path object. In FIG. 51, a path 387 connecting a start position 385 and an end position 386 is set. The start position 385 is the position based on the player character 201 that has thrown the nut object 381. Specifically, the start position 385 is the position at the feet of the player character 201 that has performed a throwing action (e.g., the position at the lower end of the player character 201). The start position 385 is not limited to the position at the feet of the player character 201, and may be any position near the player character 201. The end position 386 is the position based on the nut object 381 thrown by the throwing action. Specifically, the end position 386 is the position at which the thrown nut object 381 has collided against another object (terrain object 382 in FIG. 51). The end position 386 is not limited to the above position, and may be, for example, the position at which the nut object 381 stops moving, the position at which the thrown nut object 381 has moved a predetermined distance, or the position at the point when a predetermined period has elapsed from when the nut object 381 was thrown.

In the fourth example, the path 387 extending from the start position 385 to the end position 386 is set. In the fourth example, the game system 1 sets the path 387 such that the slope at the start position 385 and the end position 386 is gentler than the slope at an intermediate part between the start position 385 and the end position 386. Specifically, the game system 1 sets the path 387 as a polyline or a curve (e.g., Bezier curve) such that, when the path 387 is viewed from a direction parallel to the horizontal direction in the game space and perpendicular to the direction from the start position 385 to the end position 386, the slope angle of the path 387 at the start position 385 and the end position 386 is smaller than the slope angle of a straight line 388 connecting the start position 385 and the end position 386 (see FIG. 51). In this case, in the part of the path 387 from the start position 385 to a certain position 389, the slope angle gradually increases as it approaches the position 389, and in the part from the position 389 to the end position 386, the slope angle gradually decreases as it approaches the end position 386. Setting the path 387 as described above allows the player character 201 to easily move when the player character 201 enters the path object 383 from the start position 385 or descend from the path object 383 at the end position 386.

In the fourth example, the path 387 is generated so as to have a part that deviates from the straight line connecting the start position 385 and the end position 386, in the lateral direction with respect to the direction from the start position 385 to the end position 386 (specifically, a direction that is perpendicular to the direction from the start position 385 to the end position 386 and is perpendicular to the vertical direction in the game space). For example, the game system 1 sets the path 387 so as to form a sine wave when viewed from a direction perpendicular to a plane that is parallel to both the direction of the straight line and the lateral direction. As a result, the path object 383 is formed so that it extends from the start position 385 to the end position 386 in a meandering manner (see FIG. 49). Therefore, when the path object 383 is given an appearance resembling, for example, a plant vine generated from the nut object 381, the path object 383 can have a natural shape as an object imitating such a plant.

In the fourth example, the method for determining a path for setting a path object is discretionary. For example, in other embodiments, a path may be set as a straight line extending from the start position 385 to the end position 386, or a path may be set so as to coincide with the movement path of the nut object 381 from the start position 385 to the end position 386.

In the fourth example, the path object 383 is set so as to extend along the path set as described above. FIG. 52 is a view showing an example of a voxel update range that is set in a certain frame when a path object is set. In FIG. 52, a previous position 391 and a current position 392 are set on the path 387. In the fourth example, in the first frame in which a path object is set, the end position 386 is set as a previous position, and a position that has advanced a predetermined distance from the previous position 391 along the path 387 toward the start position 385 is set as the current position. In the subsequent frames, the current position in the previous frame is set as the previous position, and a position that has advanced a predetermined distance from this previous position along the path 387 toward the start position 385 is set as a new current position. If the position that has advanced a predetermined distance from the previous position along the path 387 toward the start position 385 exceeds the start position 385, the start position 385 is set as a new current position. As described above, in the fourth example, a voxel update range is set so as to gradually extend from the end position 386 to the start position 385. Therefore, as will be described in detail below, the path object generated at the end position 386 deforms so as to gradually extend toward the start position 385. Thus, in the fourth example, the path object can be represented so as to gradually extend from the nut object 381 that collided against another object. In other embodiments, a voxel update range may be set so as to gradually extend from the start position 385 to the end position 386. The predetermined distance may or may not be constant in each frame in which a voxel update range is set.

The game system 1 sets a voxel update range (hatched area shown in FIG. 52) 395 extending from the previous position 391 to the current position 392. In the fourth example, the voxel update range 395 is a part, of a capsule shape 393, below a plane 394. The capsule shape 393 includes the previous position 391 and the current position 392, and is placed to extend along the path 387. The plane 394 is, for example, a plane that is parallel to a straight line passing through the previous position 391 and the current position 392, and is also parallel to a straight line that is perpendicular to the straight line and parallel to the horizontal direction in the game space. In the fourth example, a cross-sectional shape perpendicular to the straight line passing through the previous position 391 and the current position 392 is a shape in which an upper part of a circle is cut off, resulting in a shape with a straight edge on the upper side. As will be described in detail below, the upper surface of the path object is generated along the plane 394. Therefore, the voxel update range 395 having the above shape allows the player character 201 to easily move on the path object. In other embodiments, the voxel update range may have any shape that extends from the previous position to the current position, for example, a quadrangular prism shape, or a shape obtained by rounding the edges and corners of a quadrangular prism.

In the fourth example, the voxel update range 395 is set at a position where the plane 394, at least partially, coincides with the edge of the plane of the voxel update range that is set one frame earlier (specifically, the edge connected to the voxel update range 395). For example, the game system 1 may adjust the position of the voxel update range 395 and/or the plane 394 so that the plane 394 that is set in the current frame is, at least partially, continuous with the plane of the voxel update range that was set in the previous frame. In this case, since the path object is formed so that its upper surface has no steps (or only minimal steps), which allows the player character 201, etc., to easily move on the path object.

In the fourth example, the voxel update range 395 is set so that the plane 394 includes the previous position 391 and the current position 392. In this case, the upper surface of the path object is located at the position at the feet of the player character 201 (e.g., the position at the lower end of the player character 201). This allows the player character 201 to easily enter the path object.

The game system 1 updates (specifically, increases) the densities of voxels corresponding to the voxel update range 395 so that the voxel update range 395 set as described above becomes the internal region of the voxel object. For example, the densities of voxels corresponding to the voxel update range 395 are updated to a value (e.g., 255) not less than the reference value. The game system 1 generates a voxel mesh of the path object, based on the voxel data after the density update, according to the method described in the above [2-6. Generation of mesh]. Thus, the path object with the shape according to the voxel update range 395 is generated.

In the fourth example, the game system 1 sets the material of voxels corresponding to the voxel update range 395 to a predetermined material (e.g., vine material) different from the path material. Therefore, the material of the path object is set to the predetermined material. In other embodiments, in the fourth example, as in the second and third examples, the game system 1 may set the material of voxels corresponding to the voxel update range 395 to the path material.

In the fourth example, during the period from when the path object is set to when the termination condition is satisfied after the path from the start position to the end position has been set, the game system 1 sets the voxel update range for each frame, and updates the voxel mesh of the path object for each frame. Thus, in the first frame in which setting of a path object is started, a path object is newly generated. In the second and subsequent frames after setting of a path object is started, a new voxel update range is set at a position extending from the voxel update range set in the previous frame, whereby the path object is deformed to gradually extend along the path from the end position to the start position. In the fourth example, the termination condition is that a voxel update range including a start position is set. Therefore, deformation of the path object is ended when the path object has been deformed to extend to the start position.

In the fourth example, as in the first to third examples, the process of setting a path object after a placement event has occurred (specifically, the process of setting a voxel update range, and the process of setting a voxel mesh for a path object) is performed. Therefore, in the fourth example, as in the first to third examples, the risk of the moving object coming into contact with the path object can be reduced.

In the fourth example, setting of a path object is started at a timing after a path for setting a path object has been set. However, in other embodiments, setting of a path object may be started at a timing before the path is determined. For example, in the other embodiments, as in the first to third examples, the game system 1 may start the process of setting a path object in a frame that occurs after the above waiting period has elapsed from when movement of the nut object was started. In this case, a voxel update range may be set according to any of the methods of the first to third examples.

In the first to fourth examples described above, the voxel space for the path object is a voxel space different from the voxel spaces for the voxel objects (e.g., the terrain object, and the soil object, mud object, etc., in the third example) of the types different from the path object. These voxel spaces may at least partially overlap with each other in the game space. According to the above method, deformation of the path object and deformation of the other type of voxel objects can be individually controlled. The game system 1 may decrease the densities of voxels included in voxel data of the path object to a value (e.g., 0) less than the reference value, according to a deletion event. Thus, the path object can be easily deleted without deforming the other type of voxel object. The content of the deletion event is discretionary. For example, the deletion event may be an event in which a predetermined time has elapsed from when a path object was placed, or an event in which the player character 201 has satisfied a predetermined condition. In other embodiments, the voxel space for the path object may be the same as the voxel space for the other type of voxel object described above.

### 3. Specific Example of Processing in Game System

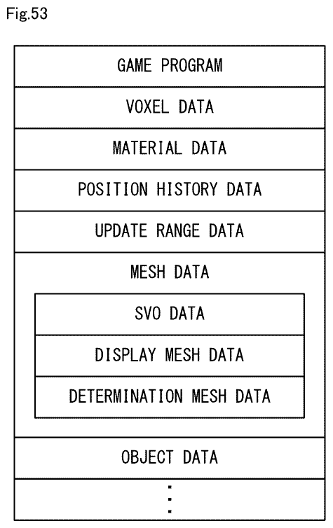

Next, a specific example of information processing in the game system 1 will be described with reference to FIGS. 53 to 58.

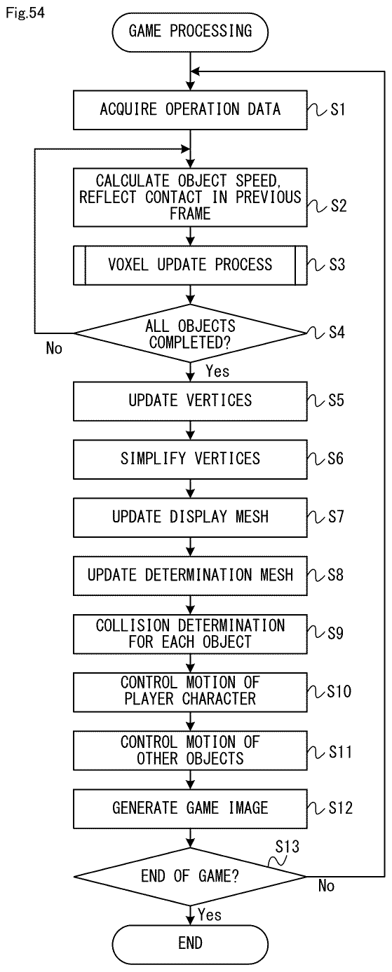

FIG. 53 shows an example of various data used for information processing in the game system 1. The data shown in FIG. 53 are stored in a memory (e.g., the flash memory 84, the DRAM 85, and/or a memory card attached to the slot 23) that is accessible by the main body apparatus 2. As shown in FIG. 53, the game system 1 stores a game program therein. The game program is a program for executing game processing (specifically, game processing shown in FIG. 54) in the exemplary embodiment. The game program includes the aforementioned material data (see FIG. 12). In the memory, the aforementioned voxel data (see FIG. 11), the aforementioned material data (see FIG. 12), position history data, update range data, mesh data, and object data (see FIG. 53).

The position history data is data indicating the history of positions of the movement object. Specifically, the position history data includes: data indicating the current position of the movement object at the time when movement of the movement object is performed; and data capable of specifying an elapsed time from the start of the movement to the current time. The data capable of specifying the elapsed time may be, for example, data indicating the time from the start of the movement, or data indicating the number of frames from the start of the movement.

The update range data is data indicating the above voxel update range. In the exemplary embodiment, the voxel update range is represented by the SDF.

The mesh data includes various data regarding meshes of a voxel object. As shown in FIG. 53, in the exemplary embodiment, the mesh data includes SVO data, display mesh data, and determination mesh data. The SVO data is data in which vertices calculated from the voxel data are held by the aforementioned SVO structure. In the exemplary embodiment, the SVO data includes data indicating materials set for the vertices (e.g., data indicating IDs of the materials) in addition to data indicating the positions of the vertices. The display mesh data includes various data regarding a display mesh. Specifically, the display mesh data includes data indicating vertices of the display mesh, and data indicating materials set for the vertices (e.g., data indicating IDs of the materials). The determination mesh data includes various data regarding a determination mesh. Specifically, the determination mesh data includes data indicating vertices of the determination mesh, and data indicating materials set for the vertices (data indicating IDs of the materials).

The object data includes various data regarding objects (e.g., the player character 201, etc.) other than the voxel object. The object data is stored for each object that appears in the game space. The object data includes data indicating, for example, the position, speed, state, etc., of the object.

FIG. 54 is a flowchart showing an example of a flow of game processing executed by the game system 1. Execution of the game processing is started in response to the game having been started according to an instruction of the player, during execution of the game program, for example. A processing loop composed of a series of processes in steps S1 to S13 is performed in a cycle of once for each frame.

In the exemplary embodiment, the processor 81 of the main body apparatus 2 executes the game program stored in the game system 1 to execute processes in steps shown in FIG. 54. However, in other embodiments, a part of the processes in the steps may be executed by a processor (e.g., a dedicated circuit or the like) other than the processor 81. Further, if the game system 1 is communicable with another information processing apparatus (e.g., a server), a part of the processes in the steps shown in FIG. 54 may be executed by the other information processing apparatus. The processes in the steps shown in FIG. 54 are merely examples, and the processing order of the steps may be changed, or another process may be executed in addition to (or instead of) the processes in the steps as long as similar results can be obtained.

The processor 81 executes the processes in the steps shown in FIG. 54 by using a memory (e.g., the DRAM 85). That is, the processor 81 stores information (in other words, data) obtained in each process step, into the memory, and reads out the information from the memory when using the information for the subsequent process steps.

In step S1 shown in FIG. 54, the processor 81 acquires the operation data indicating an operation input performed by the player. That is, the processor 81 acquires the operation data received from the respective controllers via the controller communication section 83 and/or the terminals 17 and 21. Next to step S1, the process in step S2 is executed.

In step S2, the processor 81 designates one object as a processing target, among the objects in the game space that require processing, which has not been completed in processing, and subjects the designated object to a speed calculation process, and a process of providing (e.g., reflecting) the result of contact of objects in the previous frame. The speed of the object is used for calculating the position of the object in the current frame in the processes in steps S3, S10, and S11 described below. For example, when the designated object is the player character, the speed of the player character is calculated based on the operation data acquired in step S1. When the designated object is an object not operated by the player (e.g., an enemy character, a fragment object, or a nut object), the speed of the object is calculated based on rules defined in advance in the game program. For example, the speed of a fragment object or a nut object is set to 0 when it is placed on the terrain object and not moving. The speed is set to the same speed as the speed of the player character when the object is held by the player character. The speed is set to a speed to move in the above aim direction with a magnitude determined by the above rules when the object is thrown by a throwing action performed by the player character. Specifically, the speed of the object is calculated based on virtual physical operations including interactions between objects. For example, factors such as repulsion caused by collision between objects, friction due to contact, falling under virtual gravity, and deceleration due to virtual air resistance, influence the determination of speed.

The process of providing the result of contact of objects in the previous frame includes a process in which, if collision determination (step S9) in the previous frame determines that objects have come into contact with each other, an effect caused by the contact is applied to the respective objects. This process is any one of the following processes, for example. ·A process of reducing the hit points of the player character or the enemy character when it is determined that another object's attack action has come into contact with the player character or the enemy character.
A process of generating a fragment object when it is determined that the player character has come into contact with the terrain object through a pull-out action or a punching action in the previous frame.
A process of disappearing a fragment object when it is determined that the fragment object has come into contact with another object in the previous frame.

If the state regarding the object has been changed in the process in step S2 described above, the processor 81 updates the object data stored in the memory for the object so that the object data indicates the changed content. Next to step S2, the process in step S3 is executed.

In step S3, the processor 81 executes a voxel update process of updating voxel data for the object designated in step S2. The voxel update process includes the following processes, for example.
A process of, when the object designated in step S2 is a moving object, updating voxel data for a path object in response to movement of the moving object.
A process of, when the object designated in step S2 is a terrain object (including soil object and mud object in the third example), updating voxel data for the terrain object in response to an action performed on the terrain object by the player character 201 or the like.

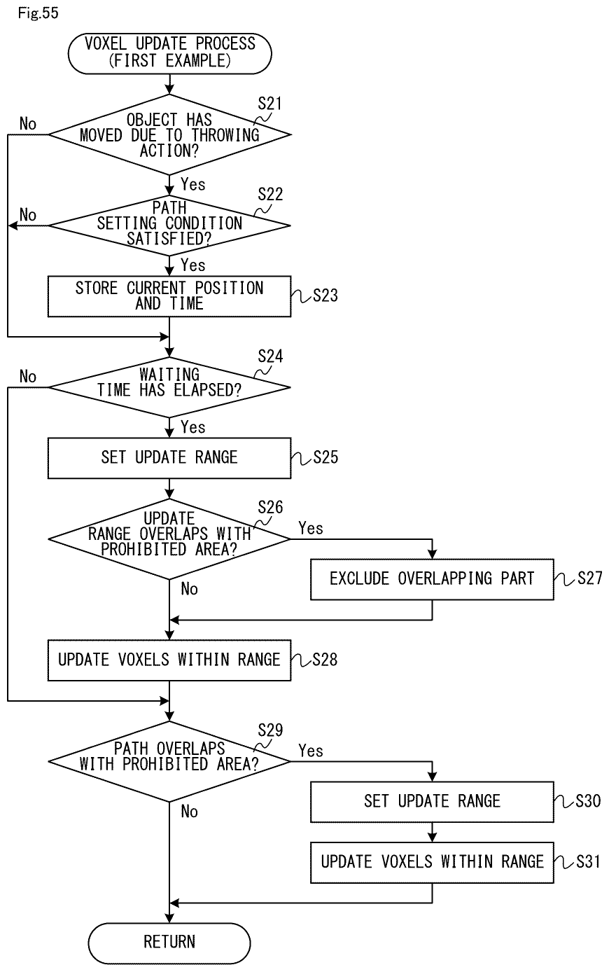

The voxel update process in the above first to fourth examples will be described later in detail (see FIGS. 55 to 58). Next to step S3, the process in step S4 is executed.

In step S4, the processor 81 determines whether or not all the objects to be processed have been subjected to the processes in step S2 to S3. When the determination result in step S4 is positive, the process in step S5 is executed. When the determination result in step S4 is negative, the process in step S2 is again executed.

In step S5, the processor 81 updates the vertices of the voxel object in the game space. That is, when the voxel data has been updated in the voxel update process in step S3, new vertices are calculated based on the updated voxel data. The positions of the new vertices are calculated according to the method described in the above [2-3. Calculation of vertices]. In addition, materials of the new vertices are calculated according to the method described in the above [2-4. Determination of material of vertex]. Next to step S5, the process in step S6 is executed.

In step S6, the processor 81 performs simplification for the vertices. That is, the processor 81 performs simplification for the vertices updated in the process in step S5, according to the method described in the above [2-5. Simplification of vertices]. The SVO data stored in the memory is updated so as to indicate the vertices obtained through the processes in steps S5 and S6. Therefore, update of the SVO data is performed through the processes in steps S5 and S6. The processes in steps S5 and S6 may not necessarily calculate new vertices for the entirety of the voxel data, and may be performed only for the part in which the content of the voxels has been changed in the process in step S5. Next to step S6, the process in step S7 is executed.

In step S7, the processor 81 updates the display mesh of the voxel object, based on the SVO data stored in the memory. The positions of the vertices of the display mesh and the materials of the polygons in the display mesh (e.g., the materials set for the vertices of the polygons) are calculated according to the method described in the above [2-6. Generation of mesh] and [2-6-1. Determination of material of display mesh]. The processor 81 updates the display mesh data stored in the memory so as to indicate the positions and materials of the vertices of the updated display mesh. Next to step S7, the process in step S8 is executed. The processor 81 may start the process in step S8 and subsequent steps without waiting for completion of step S7 to execute these steps in parallel with step S7. In this case, step S7 needs to be completed before start of step S12.

In step S8, the processor 81 updates the determination mesh of the voxel object, based on the SVO data stored in the memory. The positions of the vertices of the determination mesh and the materials of the polygons in the determination mesh (e.g., the materials set for the vertices of the polygons) are calculated according to the method described in the above [2-6.Generation of mesh] and [2-6-2. Determination of material of determination mesh]. The processor 81 updates the determination mesh data stored in the memory so as to indicate the positions and materials of the vertices of the updated determination mesh. Next to step S8, the process in step S9 is executed.

In the example shown in FIG. 54, the determination mesh generation process (step S8) is executed for each frame, but the determination mesh generation process may not necessarily be executed for each frame. For example, in the case where the collision determination process in step S9 is executed only for a frame that satisfies a predetermined condition, the processor 81 may execute the determination mesh generation process in the frame in which the collision determination in step S9 is performed. In addition, the processor 81 may execute the determination mesh generation process for voxels in a region, in the game space, where the collision determination in step S9 is performed. For example, in a state where, in the game space, an object to be subjected to collision determination does not exist around the player character, except for a voxel object (e.g., a state where only collision determination between the player character and the neighboring voxel object needs to be performed), the processor 81 may execute the determination mesh generation process for voxels within a predetermined range based on the player character.

In step S9, the processor 81 performs collision determination for each object in the game space, based on the determination mesh data and the object data stored in the memory. That is, the processor 81 performs collision determination by using a determination mesh for a voxel object, and using, for an object that is not a voxel object, a determination region having a predetermined shape, which is set for the object. In the exemplary embodiment, the collision determination in step S9 is performed in consideration of the speed calculated in step S2. That is, the processor 81 performs the collision determination by using, as the position of each object, the position in the case where the object moves at the above speed.

In the exemplary embodiment, the collision determination in step S9 determines presence/absence of the following contacts, for example.
Contact between the player character performing movement, a punching action, a pull-out action, or the like, and another object (e.g., a terrain object, a path object, an enemy character, or the like).
Contact between a character performing an action of lifting (an object) and the object.
Contact between a straight line extending in the aim direction from the position of the player character, and another object.
Contact between an object thrown by a throwing action of the player character, and another object.

When the result of the collision determination in step S9 is that the objects have come into contact with each other, the process of providing the result of the contact of the objects is performed in the process in step S2 in the next frame, or occurrence of an update event is determined in the voxel update process in step S3 in the next frame. Next to step S9, the process in step S10 is executed.

In step S10, the processor 81 controls the motion of the player character (in the third example, the player object). For example, based on the operation data acquired in step S1, the processor 81 controls the player character to move or perform various actions. When a predetermined action has occurred, an area for collision determination corresponding to the action is generated in the game space. In a single execution of step S10, the processor 81 controls the player character such that, for a motion that spans a plurality of frames (e.g., a throwing action or pull-out action by the player character), the motion is advanced by one frame. The process in step S10 being repeatedly executed over a plurality of frames allows the player character to perform a series of motions regarding movement or various actions. The object data stored in the memory is updated so that the content of the object data indicates the player character after the control in step S10. Next to step S10, the process in step S11 is executed.

In step S11, the processor 81 controls the motion of an object, etc., other than the player character. For example, based on the rules defined in the game program in advance, the processor 81 performs, according to need, a control to cause an enemy character to move and/or perform various actions, and a control to move the above fragment object or nut object. When the operation in the first example is performed, the processor 81 performs a control to move or rotate an object generation area and a voxel space for a path object, according to the rules defined in the game program. This allows the path object to move or rotate in the game space. In a single execution of step S11, the processor 81 controls the object such that, for a motion that spans a plurality of frames, the motion is advanced by one frame. The process in step S11 being repeatedly executed over a plurality of frames allows the object to perform a series of motions regarding movement or various actions. The object data stored in the memory is updated so that the content of the object data indicates the object after the control in step S11. Next to step S11, the process in step S12 is executed.

In steps S10 and S11, the position of the player character or object is basically determined to be a position after the player character or object has moved at the speed calculated in step S2. However, when the collision determination in step S9 determines that the player character or object comes into contact with another object, and the contacted object obstructs movement of the player character or object, the position of the player character or object is determined not to change.

In step S12, the processor 81 generates a game image. That is, the processor 81 generates a game image by performing rendering, based on the virtual camera, for the polygons of the display mesh of the voxel object, and the polygons of objects other than the voxel object. The polygons of the display mesh are rendered by using rendering settings such as textures corresponding to materials set for the polygons, according to the method described in the above [2-6-1. Determination of material of display mesh]. In the exemplary embodiment, if the player character is capable of performing a throwing action, the processor 81 generates a game image to include the aforementioned aim image and object information image (see FIG. 28). The game image generated in step S12 is outputted to the display device and displayed in a cycle of once for each frame.

In step S13, the processor 81 determines whether or not to end the game. For example, the processor 81 determines to end the game when a predetermined operation input to end the game has been performed by the player. When the determination result in step S13 is negative, the process in step S1 is executed again. Thereafter, a series of processes in steps S1 to S13 is repeated until the processor 81 determines to end the game in step S13. When the determination result in step S13 is positive, the processor 81 ends the game processing shown in FIG. 54.

Next, a voxel update process (step S3 in FIG. 54) for executing the operation in the first example described in the above [2-8-1. First example] will be described. FIG. 55 is a sub flowchart showing an example of a specific flow of the voxel update process in the first example. For example, if the object designated in step S2 is an object (e.g., fragment object) for which the player character can perform a throwing action, the voxel update process in the first example is executed.

In the voxel update process in the first example, first, in step S21, the processor 81 determines whether or not the object designated in step S2 is moving due to a throwing action performed by the player character. When the determination result in step S21 is positive, the process in step S22 is executed. When the determination result in step S21 is negative, the process in step S24 is executed.

In step S22, the processor 81 determines whether or not the condition for setting a path object is satisfied for the object designated in step S2. The condition is, for example, that the termination condition is not satisfied and the object is positioned within the object generation area. When the termination condition is not satisfied and the object is positioned within the object generation area, the determination result in step S22 is positive. When the termination condition is satisfied or the object is positioned outside the object generation area, the determination result is negative. When the determination result in step S22 is positive, the process in step S23 is executed. When the determination result in step S21 is negative, the process in step S24 is executed.

In step S23, the processor 81 stores the current position of the object designated in step S2 in association with the current time. In the exemplary embodiment, the current position is a position obtained by shifting the position calculated in the process in the previous frame, according to the speed calculated in step S2. However, in other embodiments, the position calculated in the process in the previous frame may be used as the current position. The processor 81 updates the position history data stored in the memory so that the position history data includes data indicating the current position, and data capable of specifying an elapsed time from the start of the movement. Next to step S23, the process in step S24 is executed.

In step S24, the processor 81 determines whether or not, among the positions of the object indicated by the position history data stored in the memory, there is any position for which the waiting period has elapsed. For example, the determination in step S24 is made based on whether or not the position history data includes data indicating a position associated with an elapsed time that has reached or exceeded the waiting time for the object. When the determination result in step S24 is positive, the process in step S25 is executed. When the determination result in step S24 is negative, the process in step S29 is executed.

In step S25, the processor 81 sets a voxel update range, based on the position of the object for which it has been determined in step S24 that the waiting period was exceeded. The voxel update range is set according to the method described in the above [2-8-1. First example], by using, as the current position, the position of the object for which it has been determined that in step S24 that the waiting period was exceeded. The processor 81 updates the voxel update range data stored in the memory so that the voxel update range data includes data indicating the set voxel update range. In step S25, the processor 81 deletes, from the position history data stored in the memory, data indicating the position of the object used for setting the voxel update range. However, if the data indicating the position of the object is used in the subsequent process (e.g., used as data of the previous position), the processor 81 stores the data in the memory. Next to step S25, the process in step S26 is executed.

In step S26, the processor 81 determines whether or not the voxel update range set in step S25 at least partially overlaps with the prohibited area based on the position of the player character. When the determination result in step S26 is positive, the process in step S27 is executed. When the determination result in step S26 is negative, the process in step S28 is executed.

In step S27, the processor 81 changes the voxel update range set in step S25 so that a part overlapping with the prohibited area is excluded. The processor 81 updates the voxel update range data stored in the memory so that the data indicates the changed range. Next to step S27, the process in step S28 is executed.

In step S28, the processor 81 updates voxels corresponding to the voxel update range set in steps S25 and S27. Specifically, the processor 81 updates (increases) the densities of the voxels to a value not less than the reference value, and updates the material of the voxels to a predetermined material. The processor 81 updates the voxel data stored in the memory so that the voxel data indicates the density and material updated for the corresponding voxel. Thus, through the processes in steps S5 to S8 executed thereafter, the mesh of the path object is deformed so that the path object has a shape that internally includes the voxel update range. Next to step S28, the process in step S29 is executed.

In step S29, the processor 81 determines whether or not the path object at least partially overlaps with the prohibited area set in the game space. When the determination result in step S29 is positive, the process in step S30 is executed. When the determination result in step S29 is negative, the processor 81 ends the voxel update process shown in FIG. 55.

In step S30, the processor 81 sets a voxel update range to be an area where the path object overlaps with the prohibited area. The processor 81 updates the voxel update range data stored in the memory so that the voxel update range data includes data indicating the set voxel update range.

In step S31, the processor 81 updates voxels corresponding to the voxel update range set in step S30. Specifically, the processor 81 updates (decreases) the densities of the voxels to a value less than the reference value, and updates the material of the voxels to a predetermined material. The processor 81 updates the voxel data stored in the memory so that the voxel data indicates the density and material updated for the corresponding voxel. Thus, through the processes in steps S5 to S8 executed thereafter, the mesh of the path object is deformed so that the path object has a shape that does not internally include the prohibited area. Next to step S31, the processor 81 ends the voxel update process shown in FIG. 55.

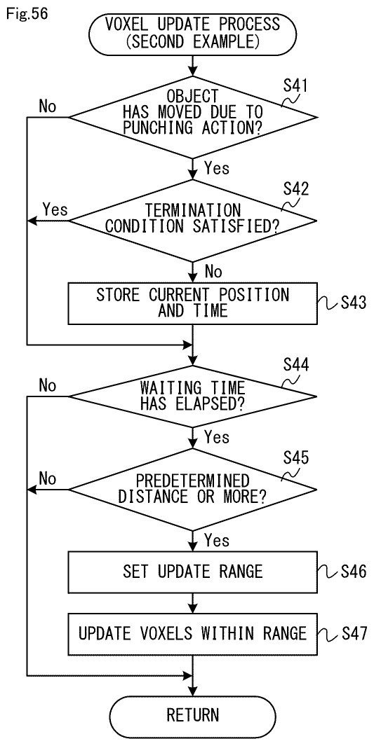

Next, a voxel update process (step S3 in FIG. 54) for executing the operation in the second example described in the above [2-8-2. Second example] will be described. FIG. 56 is a sub flowchart showing an example of a specific flow of the voxel update process in the second example. For example, if the object designated in step S2 is the predetermined type of character for which a path object is generated when the character moves due to a predetermined attack action performed by the player character, the voxel update process in the second example is executed.

In the voxel update process in the second example, first, in step S41, the processor 81 determines whether or not an enemy character as the object designated in step S2 is moving due to the predetermined attack action performed by the player character. When the determination result in step S41 is positive, the process in step S42 is executed. When the determination result in step S41 is negative, the process in step S44 is executed.

In step S42, the processor 81 determines whether or not the aforementioned termination condition is satisfied for the enemy character. When the determination result in step S42 is positive, the process in step S44 is executed. When the determination result in step S42 is negative, the process in step S43 is executed.

In step S43, the processor 81 stores the current position of the enemy character in association with the current time. In the exemplary embodiment, the current position is a position obtained by shifting the position calculated in the process in the previous frame, according to the speed calculated in step S2. However, in other embodiments, the position calculated in the process in the previous frame may be used as the current position. The processor 81 updates the position history data stored in the memory so that the position history data includes data indicating the current position, and data capable of specifying an elapsed time from the start of the movement. Next to step S43, the process in step S44 is executed.

In step S44, the processor 81 determines whether or not, among the positions of the enemy character indicated by the position history data stored in the memory, there is any position for which the waiting period has elapsed. For example, the determination in step S44 is made based on whether or not the position history data includes data indicating a position associated with an elapsed time that has reached or exceeded the waiting time for the enemy character. When the determination result in step S44 is positive, the process in step S45 is executed. When the determination result in step S44 is negative, the processor 81 ends the voxel update process shown in FIG. 56.

In step S45, assuming that the position of the enemy character for which it has been determined in step S44 that the waiting period was exceeded is the current position, the processor 81 determines whether or not the distance from the previous position to the current position is equal to or greater than a predetermined distance. When the determination result in step S45 is positive, the process in step S46 is executed. When the determination result in step S45 is negative, the processor 81 ends the voxel update process shown in FIG. 56.

In step S46, the processor 81 sets a voxel update range, based on the position of the enemy character for which it has been determined in step S44 that the waiting period was exceeded. The voxel update range is set according to the method described in the above [2-8-2. Second example], by using the position of the enemy character as the current position. The processor 81 updates the voxel update range data stored in the memory so that the voxel update range data includes data indicating the set voxel update range. In step S46, the processor 81 deletes, from the position history data stored in the memory, data indicating the position of the enemy character used for setting the voxel update range. However, if the data indicating the position of the enemy character is used in the subsequent process (e.g., used as data of the previous position), the processor 81 stores the data in the memory. Next to step S46, the process in step S47 is executed.

In step S47, the processor 81 updates voxels corresponding to the voxel update range set in step S46. Specifically, the processor 81 updates (increases) the densities of the voxels to a value not less than the reference value, and updates the material of the voxels to the aforementioned path material. The processor 81 updates the voxel data stored in the memory so that the voxel data indicates the density and material updated for the corresponding voxel. Thus, through the processes in steps S5 to S8 executed thereafter, the mesh of the path object is deformed so that the path object has a shape that internally includes the voxel update range. After step S47, the processor 81 ends the voxel update process shown in FIG. 56.

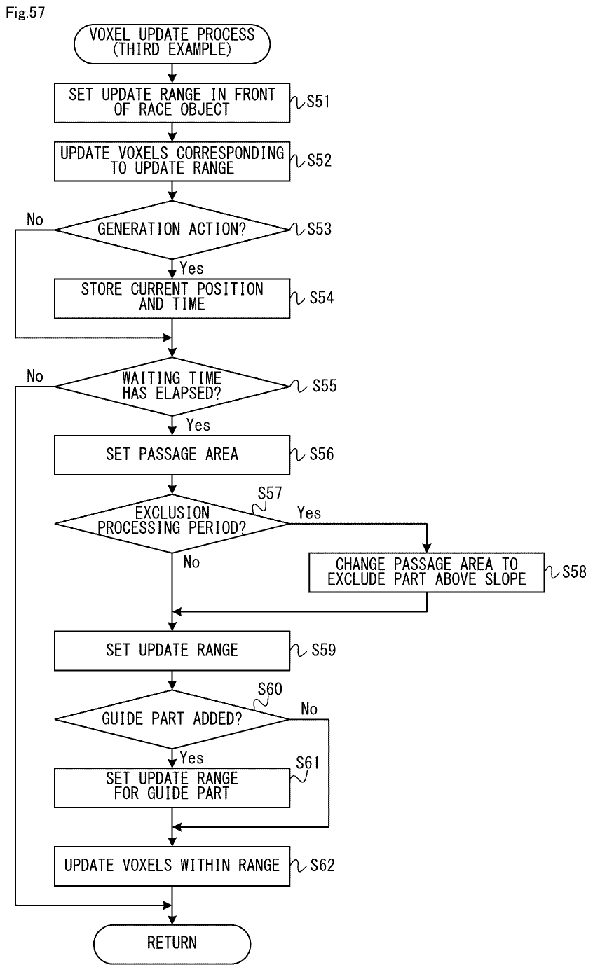

Next, a voxel update process (step S3 in FIG. 54) for executing the operation in the third example described in the above [2-8-3. Third example] will be described. FIG. 57 is a sub flowchart showing an example of a specific flow of the voxel update process in the third example. For example, if the object designated in step S2 is a player object, the voxel update process in the third example is executed.

In the voxel update process in the third example, first, in step S51, the processor 81 sets a voxel update range in front of the player object as the object designated in step S2. For example, the processor 81 updates the voxel update range data stored in the memory so that the voxel update range data includes data indicating a spherical area centered on a position a predetermined distance ahead of the player object. Next to step S51, the process in step S52 is executed.

In step S52, the processor 81 updates the densities of voxels corresponding to the voxel update range set in step S51. Specifically, the processor 81 updates the voxel data stored in the memory to decrease the density of the corresponding voxel to a value less than the reference value. Thus, if the voxel mesh is placed within the voxel update range, the voxel mesh is deformed to a shape such that a part, of the voxel object, within the voxel update range is deleted, through the processes in steps S5 to S8 described below. In the third example, the voxel objects deformed through the process in step S52 are the soil object and the mud object, and the path object is not deformed through the process in step S52. For example, the processor 81 may perform density update when the material set for the voxels corresponding to the voxel update range is the soil or mud material, and may not perform density update when the material is the path material. Furthermore, for example, the voxel space for the path object may be set separately from the voxel space for the soil object and the mud object. Next to step S52, the process in step S53 is executed.

In step S53, the processor 81 determines whether or not the player object is performing a generation action. When the determination result in step S53 is positive, the process in step S54 is executed. When the determination result in step S53 is negative, the process in step S55 is executed.

In step S54, the processor 81 stores the current position of the player object in association with the current time. For example, the current position is a position obtained by shifting the position calculated in the process in the previous frame, in the direction according to an operation input performed by the player, by a distance according to the movement speed set in step S2. However, in other embodiments, the position calculated in the previous frame may be used as the current position. The processor 81 updates the position history data stored in the memory so that the position history data includes data indicating the current position, and data capable of specifying an elapsed time from the start of the generation action. Next to step S54, the process in step S55 is executed.

In step S55, the processor 81 determines whether or not, among the positions of the player object indicated by the position history data stored in the memory, there is any position for which the waiting period has elapsed. For example, the determination in step S55 is made based on whether or not the position history data includes data indicating a position associated with an elapsed time that has reached or exceeded the waiting time for the enemy character. When the determination result in step S55 is positive, the process in step S56 is executed. When the determination result in step S55 is negative, the processor 81 ends the voxel update process shown in FIG. 57.

In step S56, based on the position of the player object for which it has been determined in step S55 that the waiting period was exceeded, the processor 81 sets a passage area extending from a position one frame previous to the position of the player object to the position of the player object. Next to step S56, the process in step S57 is executed.

In step S57, the processor 81 determines whether or not the elapsed time associated with the position of the player object for which it has been determined in step S55 that the waiting period was exceeded, is within the exclusion processing period from the start of the generation action. When the determination result in step S57 is positive, the process in step S56 is executed. When the determination result in step S57 is negative, the process in step S59 is executed.

In step S58, the processor 81 changes the passage area set in step S56 so that a part, of the passage area, located above the slope that is set for the passage area is excluded. The slope is set according to the method described in the above [2-8-3. Third example]. Next to step S58, the process in step S59 is executed.

In step S59, the processor 81 sets a voxel update range, based on the passage area. When the process in step S58 has not been executed, the passage area used for setting the voxel update range is the passage area set in step S56. When the process in step S58 has been executed, the passage area is the passage area changed in step S58. Specifically, the processor 81 updates the voxel update range data stored in the memory so that the voxel update range data includes the passage area. Thus, the voxel update range corresponding to the traveling surface part of the path object is set. In step S59, the processor 81 deletes, from the position history data stored in the memory, data indicating the position of the player object used for setting the voxel update range. However, if the data indicating the position of the player object is used in the subsequent process (e.g., used as data of the previous position), the processor 81 stores the data in the memory. Next to step S59, the process in step S60 is executed.

In step S60, the processor 81 determines whether or not to add a guide part of the path object. The determination in step S60 is made based on, for example, whether or not a predetermined time has not yet elapsed from the start of the generation action, or whether or not the current position of the player object is within a predetermined distance from the start position of the generation action. When the determination result in step S60 is positive, the process in step S61 is executed. When the determination result in step S60 is negative, the process in step S62 is executed.

In step S61, the processor 81 sets a voxel update range corresponding to the guide part. The voxel update range set in step S61 may have, for example, a predetermined shape determined based on the distance from the start part of the generation action to the current position of the player object. The processor 81 updates the voxel update range data stored in the memory so that the voxel update range data includes data indicating the set voxel update range. Next to step S61, the process in step S62 is executed.

In step S62, the processor 81 updates voxels corresponding to the voxel update range set in steps S59 and S61. Specifically, the processor 81 updates (increases) the densities of the voxels to a value not less than the reference value, and updates the material of the voxels to the path material. The processor 81 updates the voxel data stored in the memory so that the voxel data indicates the density and material updated for the corresponding voxel. Thus, through the processes in steps S5 to S8 described below, the mesh of the path object is deformed so that the path object has a shape that internally includes the voxel update range. After step S62, the processor 81 ends the voxel update process shown in FIG. 57.

In the example of the processes shown in FIGS. 55 to 57, in the frame in which the moving object moves, the current position of the moving object at that point in time is stored (steps S23, S43, S54), and in the frame after the waiting period has elapsed, setting of the voxel update range (steps S25, S46, S59) and update of voxels (steps S28, S47, S62) are performed based on the stored position. Here, the process for updating the path object after the lapse of the waiting period is not limited to the above process. For example, in other embodiments, in the frame in which the moving object moves, the voxel update range based on the position of the moving object at that point in time may be set and stored, and in the frame after the waiting period has elapsed, update of voxels may be performed based on the stored voxel update range. In the first example, in the frame in which the moving object moves, the passage area based on the position of the moving object at that point in time may be set and stored, and in the frame after the waiting period has elapsed, setting of the voxel update range and update of voxels may be performed based on the stored passage area.

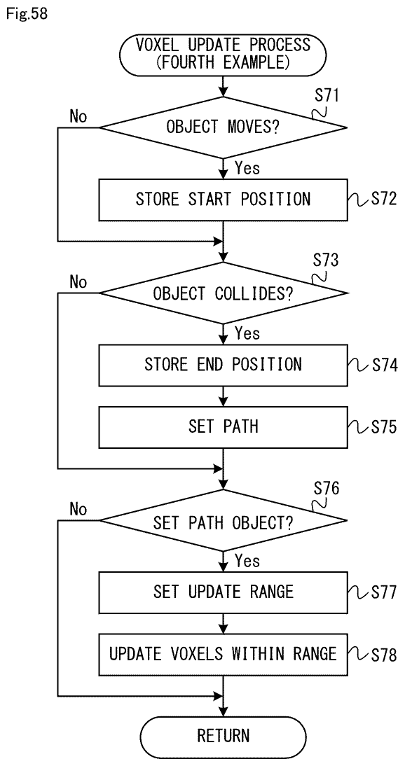

Next, a voxel update process (step S3 in FIG. 54) for executing the operation in the fourth example described in the above [2-8-4. Fourth example] will be described. FIG. 58 is a sub flowchart showing an example of a specific flow of the voxel update process in the fourth example. For example, if the object designated in step S2 is the aforementioned nut object, the voxel update process in the fourth example is executed.

In the voxel update process in the fourth example, first, in step S71, the processor 81 determines whether or not the nut object as the object designated in step S2 is moving due to a throwing action performed by the player character. When the determination result in step S71 is positive, the process in step S72 is executed. When the determination result in step S71 is negative, the process in step S73 is executed.

In step S72, the processor 81 stores the current position of the nut object as the start position in the memory. Next to step S72, the process in step S73 is executed.

In step S73, the processor 81 determines whether or not the nut object has collided against another object. When the determination result in step S73 is positive, the process in step S74 is executed. When the determination result in step S73 is negative, the process in step S76 is executed.

In step S74, the processor 81 stores the current position of the nut object as the end position in the memory. Next to step S74, the process in step S75 is executed.

In step S75, the processor 81 sets a path for a path object, based on the start position stored in step S72 and the end position stored in step S74. The path is determined according to the method described in the above [2-8-4. Fourth example]. Next to step S75, the process in step S76 is executed.

In step S76, the processor 81 determines whether or not to set the path object. The determination in step S76 is made based on, for example, whether or not the path object is set up to the start position of the path set in step S75 (more specifically, whether or not the path object internally includes the start position). When the determination result in step S76 is positive, the process in step S77 is executed. When the determination result in step S76 is negative, the processor 81 ends the voxel update process shown in FIG. 58.

In step S77, the processor 81 sets a voxel update range based on the path set in step S75. Specifically, the processor 81 sets a voxel update range including the previous position and the current position set on the path, according to the method described in the above [2-8-4. Fourth example] (see FIG. 52). The processor 81 updates the voxel update range data stored in the memory so that the voxel update range data includes data indicating the set voxel update range. Next to step S77, the process in step S78 is executed.

In step S78, the processor 81 updates voxels corresponding to the voxel update range set in step S77. Specifically, the processor 81 updates (increases) the densities of the voxels to a value not less than the reference value, and updates the material of the voxels to a predetermined material. The processor 81 updates the voxel data stored in the memory so that the voxel data indicates the density and material updated for the corresponding voxel. Thus, the mesh of the path object is deformed so that the path object has a shape that internally includes the voxel update range, through the processes in steps S5 to S8 described below. After step S78, the processor 81 ends the voxel update process shown in FIG. 58.

### 4. Functions and Effects of Exemplary Embodiment and Modifications

In the above exemplary embodiment (e.g., the first to fourth examples), a voxel update range is continuously set along a path according to a placement event, and the densities of voxels corresponding to the voxel update range are increased to set a path object on which a player character can move. Thus, a novel game in which a path object is dynamically set in a game space can be provided.

Continuously setting the voxel update range is not limited to an approach in which the voxel update range is set for each frame, but also includes an approach (e.g., the second example) in which the voxel update range is set under certain conditions during a period spanning a plurality of frames, and in frames within the period where the conditions are not met, the voxel update range is not set.

As described in the above first to fourth examples, the path object may have a three-dimensional shape with a planar part on at least its upper surface. This allows the player character, etc., to easily move on the path object. In other embodiments, the path object may have any shape, and the path object may not necessarily have the planar part.

In the above exemplary embodiment, the processes described in the above first to fourth examples are executed in one game, as the process for setting a voxel object based on a movement path of an object. In other embodiments, at least one of the processes described in the first to fourth examples may be executed in the game.

In any one of the first to fourth examples, a method described in another example may be used, and a process described in another example may be executed. For example, in any one of the first to fourth examples, a voxel update range setting method described in another example may be used. For example, in any one of the first to fourth examples, the shape of a path object may be the shape of a path object described in another example. For example, in the second to fourth examples, a prohibited area (e.g., prohibited area 315 shown in FIG. 34 or prohibited area 325 shown in FIG. 35) of the first example may be set. For example, in the first example, the third example, and the fourth example, the game system 1 may place an item object of the second example on a path object. For example, in the first to third examples, the game system 1 may determine a path based on the position of a moving object and then start setting of a path object as in the fourth example.

In the above exemplary embodiment, when a process is executed by using data (including a program) in a certain information processing apparatus, a part of the data required for the process may be transmitted from another information processing apparatus different from the certain information processing apparatus. In this case, the certain information processing apparatus may execute the process by using the data received from the other information processing apparatus and the data stored therein.

In other embodiments, the information processing system may not include some of the components in the above embodiment, and may not execute some of the processes executed in the above embodiment. For example, in order to obtain a result of a part of the above embodiment, the information processing system includes a configuration for obtaining the result and executes a process for obtaining the result, and need not include other configurations and need not execute other processes.

The above exemplary embodiment can be used as, for example, a game system or a game program for the purpose of, for example, providing a novel game using voxel data.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

What is claimed is:

1. One or more non-transitory computer-readable storage media having stored therein instructions that, when executed, cause one or more processors to execute information processing comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh, and
when a first event has occurred, continuously setting a first voxel update range in the virtual space along a path according to the first event, and increasing the density of each voxel corresponding to the first voxel update range.

2. The one or more non-transitory computer-readable storage media according to claim 1, wherein
the first event is an event in which a first object moves in the virtual space, and
the information processing comprises, when the first event has occurred, setting the first voxel update range at a plurality of positions through which the first object has passed in the virtual space.

3. The one or more non-transitory computer-readable storage media according to claim 2, wherein
the first object is an enemy object in a game, and
the first event is an event in which the enemy object moves in response to that a first action hits the enemy object, the first action being an attack action performed by the player object based on an operation input.

4. The one or more non-transitory computer-readable storage media according to claim 2, wherein
the first event is an event in which, within a first range in the virtual space, the player object is caused to perform a second action of throwing the first object, based on an operation input, thereby moving the first object.

5. The one or more non-transitory computer-readable storage media according to claim 2, wherein
the first object is the player object, and
the first event is an event in which at least the player object performs a third action to move based on an operation input.

6. The one or more non-transitory computer-readable storage media according to claim 1, wherein
the information processing comprises, when the first event has occurred, setting the first voxel update range along a first path from a first position to a second position in the virtual space.

7. The one or more non-transitory computer-readable storage media according to claim 6, wherein
either the first position or the second position is a position of the player object, and
the first voxel update range is arranged, at the position of the player object, so that an upper surface of the first voxel update range is located at a height of a lower end of the player object.

8. The one or more non-transitory computer-readable storage media according to claim 7, wherein
the first event is an event in which a second object thrown by a fourth action performed by the player object based on an operation input collides with the voxel mesh, and either the first position or the second position is a collision position of the second object.

9. The one or more non-transitory computer-readable storage media according to claim 8, wherein
the path has a shape of a curve or a polyline in which slopes at the first position and the second position are gentler than a slope of a straight line connecting the first position and the second position.

10. The one or more non-transitory computer-readable storage media according to claim 8, wherein
the voxel data includes at least first voxel data and second voxel data respectively defined in a first voxel space and a second voxel space that at least partially overlap each other in the virtual space, and
the information processing comprises:
increasing the density of each voxel corresponding to the first voxel update range in the first voxel data; and
when a second event has occurred, setting a second voxel update range, and increasing or decreasing the density of each voxel corresponding to the second voxel update range in the second voxel data.

11. The one or more non-transitory computer-readable storage media according to claim 10, wherein
the information processing further comprises:
moving or rotating the first voxel space defined in the virtual space; and
updating the voxel mesh corresponding to the first voxel data.

12. The one or more non-transitory computer-readable storage media according to claim 10, wherein
the information processing further comprises, in the game processing, decreasing the density of the voxel included in the first voxel data according to a third event.

13. The one or more non-transitory computer-readable storage media according to claim 1, wherein
the information processing comprises, when the first event has occurred, setting the first voxel update range after a first period has elapsed.

14. The one or more non-transitory computer-readable storage media according to claim 1, wherein
the information processing comprises, when the first event has occurred, setting the first voxel update range in a range obtained by excluding a range including the position of the player object.

15. The one or more non-transitory computer-readable storage media according to claim 1, wherein
the information processing comprises setting the first voxel update range at a position where an edge of an upper surface of the first voxel update range coincides, at least partially, with an edge of an upper surface of the first voxel update range previously generated.

16. An information processing system comprising:
one or more processors, and
one or more memories having stored therein computer-executable instructions to execute information processing comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh, and
when a first event has occurred, continuously setting a first voxel update range in the virtual space along a path according to the first event, and increasing the density of each voxel corresponding to the first voxel update range.

17. The information processing system according to claim 16, wherein
the first event is an event in which a first object moves in the virtual space, and
the information processing comprises, when the first event has occurred, setting the first voxel update range at a plurality of positions through which the first object has passed in the virtual space.

18. The information processing system according to claim 17, wherein
the first object is an enemy object in a game, and
the first event is an event in which the enemy object moves in response to that a first action hits the enemy object, the first action being an attack action performed by the player object based on an operation input.

19. The information processing system according to claim 17, wherein
the first event is an event in which, within a first range in the virtual space, the player object is caused to perform a second action of throwing the first object, based on an operation input, thereby moving the first object.

20. The information processing system according to claim 17, wherein
the first object is the player object, and
the first event is an event in which at least the player object performs a third action to move based on an operation input.

21. The information processing system according to claim 16, wherein
the information processing comprises, when the first event has occurred, setting the first voxel update range along a first path from a first position to a second position in the virtual space.

22. The information processing system according to claim 21, wherein
either the first position or the second position is a position of the player object, and
the first voxel update range is arranged, at the position of the player object, so that an upper surface of the first voxel update range is located at a height of a lower end of the player object.

23. The information processing system according to claim 22, wherein
the first event is an event in which a second object thrown by a fourth action performed by the player object based on an operation input collides with the voxel mesh, and either the first position or the second position is a collision position of the object.

24. The information processing system according to claim 23, wherein
the path has a shape of a curve or a polyline in which slopes at the first position and the second position are gentler than a slope of a straight line connecting the first position and the second position.

25. The information processing system according to claim 23, wherein
the voxel data includes at least first voxel data and second voxel data respectively defined in a first voxel space and a second voxel space that at least partially overlap each other in the virtual space, and
the information processing comprises:
increasing the density of each voxel corresponding to the first voxel update range in the first voxel data; and
when a second event has occurred, setting a second voxel update range, and increasing or decreasing the density of each voxel corresponding to the second voxel update range in the second voxel data.

26. The information processing system according to claim 25, wherein
the information processing further comprises:
moving or rotating the first voxel space defined in the virtual space; and
updating the voxel mesh corresponding to the first voxel data.

27. The information processing system according to claim 25, wherein
the information processing further comprises, in the game processing, decreasing the density of the voxel included in the first voxel data according to a third event.

28. The information processing system according to claim 16, wherein
the information processing comprises, when the first event has occurred, setting the first voxel update range after a first period has elapsed.

29. The information processing system according to claim 16, wherein
the information processing comprises, when the first event has occurred, setting the first voxel update range in a range obtained by excluding a range including the position of the player object.

30. The information processing system according to claim 16, wherein
the information processing comprises setting the first voxel update range at a position where an edge of an upper surface of the first voxel update range coincides, at least partially, with an edge of an upper surface of the first voxel update range previously generated.

31. A computer-implemented method comprising:
updating, based on game processing, voxel data which is defined in a virtual space and in which at least a density is set for each of a plurality of voxels, the density indicating a degree of occupation of a content in a space defined by the voxel;
updating a voxel mesh which is a mesh corresponding to the voxel data, and vertex coordinates of which are determined based on at least the density included in the voxel data; and
in the game processing,
when a player object in the virtual space is on the voxel mesh, controlling movement of the player object based on an operation input at a position on the voxel mesh, and
when a first event has occurred, continuously setting a first voxel update range in the virtual space along a path according to the first event, and increasing the density of each voxel corresponding to the first voxel update range.

32. The computer-implemented method according to claim 31, wherein
the first event is an event in which a first object moves in the virtual space, and
the computer-implemented method comprises, when the first event has occurred, setting the first voxel update range at a plurality of positions through which the first object has passed in the virtual space.

33. The computer-implemented method according to claim 32, wherein
the first object is an enemy object in a game, and
the first event is an event in which the enemy object moves in response to that a first action hits the enemy object, the first action being an attack action performed by the player object based on an operation input.

34. The computer-implemented method according to claim 32, wherein
the first event is an event in which, within a first range in the virtual space, the player object is caused to perform a second action of throwing the first object, based on an operation input, thereby moving the first object.

35. The computer-implemented method according to claim 32, wherein
the first object is the player object, and
the first event is an event in which at least the player object performs a third action to move based on an operation input.

36. The computer-implemented method according to claim 31, comprises,
when the first event has occurred, setting the first voxel update range along a first path from a first position to a second position in the virtual space.

37. The computer-implemented method according to claim 36, wherein
either the first position or the second position is a position of the player object, and
the first voxel update range is arranged, at the position of the player object, so that an upper surface of the first voxel update range is located at a height of a lower end of the player object.

38. The computer-implemented method according to claim 37, wherein
the first event is an event in which a second object thrown by a fourth action performed by the player object based on an operation input collides with the voxel mesh, and either the first position or the second position is a collision position of the object.

39. The computer-implemented method according to claim 38, wherein
the path has a shape of a curve or a polyline in which slopes at the first position and the second position are gentler than a slope of a straight line connecting the first position and the second position.

40. The computer-implemented method according to claim 38, wherein
the voxel data includes at least first voxel data and second voxel data respectively defined in a first voxel space and a second voxel space that at least partially overlap each other in the virtual space, and
the computer-implemented method comprises:
increasing the density of each voxel corresponding to the first voxel update range in the first voxel data; and
when a second event has occurred, setting a second voxel update range, and increasing or decreasing the density of each voxel corresponding to the second voxel update range in the second voxel data.

41. The computer-implemented method according to claim 40, further comprises:
moving or rotating the first voxel space defined in the virtual space; and
updating the voxel mesh corresponding to the first voxel data.

42. The computer-implemented method according to claim 40, further comprises, in the game processing, decreasing the density of the voxel included in the first voxel data according to a third event.

43. The computer-implemented method according to claim 31, comprises, when the first event has occurred, setting the first voxel update range after a first period has elapsed.

44. The computer-implemented method according to claim 31, comprises, when the first event has occurred, setting the first voxel update range in a range obtained by excluding a range including the position of the player object.

45. The computer-implemented method according to claim 31, comprises setting the first voxel update range at a position where an edge of an upper surface of the first voxel update range coincides, at least partially, with an edge of an upper surface of the first voxel update range previously generated.
